(19) United States
(12) Patent Application Publication
(10) Pub. No.: US 2022/0415291 A1
(43) Pub. Date: Dec. 29, 2022

(54) Method and System for Processing Input Data

(71) Applicant: Gilad Zuta, Hod Hasharon (IL)

(72) Inventor: Gilad Zuta, Hod Hasharon (IL)

(21) Appl. No.: 17/357,569

(22) Filed: Jun. 24, 2021

(51) Int. Cl. G10H 1/00

(52) U.S. Cl. CPC G10H 1/0025; G10H 2210/111; G10H 2210/391; G10H 2210/091

(57) ABSTRACT

A method for analyzing one or more notes in a musical composition, comprising for each note: getting a note, a chord and a scale. computing note properties using the note's value and the chord and the scale. A method for transforming one or more input notes into one or more new notes, comprising for each input note: getting an input note and its note properties, getting a new chord and a new scale for the input note, getting a list of notes candidates, computing distances between the input note and every note in the list, using input note's value, input note's note properties, candidate note's value and candidate note's note properties, finding the candidate that has the minimal distance, and setting a new note value using a note value of the candidate with the minimal distance.

### CROSS-REFERENCE TO RELATED APPLICATIONS

None.

### GOVERNMENT CONTRACT

None.

### STATEMENT RE FEDERALLY SPONSORED RESEARCH and DEVELOPMENT

None.

### COPYRIGHT and TRADEMARK NOTICES

Copyright (C) 2021 Gilad Zuta.

The author asserts his Moral Right.

Infisong™ and Infysong™ are claimed as trademarks by Gilad Zuta.

This patent application document contains material which is subject to copyright protection.

The document describes matter which is claimed as trademarks of the present applicant.

The copyright and trademark owner has no objection to the facsimile reproduction by anyone of the patent application or the patent disclosure, as it appears in the Patent and Trademark Office patent files and records, but otherwise reserves all copyrights and trademark rights whatsoever.

### BACKGROUND OF THE INVENTION

### (1) Field of the Invention

The present invention relates to a new method for improving musical creations such as songs, using digital processing. The improvements include adding new musical instruments tracks and/or changing the original musical creation, using music theory together with a user's preferences and configuration, all within a novel approach of analyzing and processing musical creations. New musical instruments tracks may include notes and/or controls.

### (2) Description of Related Art

Aside from its entertainment value, listening to music has a strong positive effect on our brain. Researchers show that music can support the well-being of people. Reports show that music has a positive effect on the emotional well-being of people, by improving mood, decrease anxiety and manage stress. Music elevates people's moods and motivation, it is closely aligned with optimism and positive feelings. Other researchers show that music increases memory retention as well as improves learning capabilities.

Similarly, playing music has great benefits, such as to increase resilience, improve brain activity etc.

Music fans who wish to practice music, will have much higher enjoyment if they had other instruments playing to accompany them. The current options are either to search people or to play in an organ which has programmed styles. Playing in a band is not an option for busy people or people who just wish to play alone. An organ has a limited number of styles, which are played the same way every time, which can lead to a loss of interest over time.

Musicians who want to get a high-quality song, one that sounds compelling for its audience, have to perform a process that is called ‘the music production process’. This process includes: Conception, composition, arrangement, recording and editing, mixing and mastering. Conception is the step of coming up with initial music ideas.

Composition is the step of thinking about melody, rhythm, harmony, chords and lyrics.

Arrangement is the step of assembling together musical ideas for various instruments, and creating the parts of the song, such as intro, verse. chorus, bridge and outro.

Knowledge and skills in music theory, composition, music production and Digital Audio Workstation tools are required in order to perform the above process in a professional and efficient manner. It is a difficult, effort and time-consuming process.

Video creators, from YouTube content creators to advertisement productions have a need to add music to their videos and ads. Games creators have a need to add music to their games. Ordering custom-made music from professional musicians is an expensive and lengthy process, that provides a limited number of songs and may arise licensing and royalties issues. Ordering custom-made music from amateur musicians can be cost-effective, but it is a lengthy process, communicating with the amateur musicians may be challenging and can lead to low quality results because of their lack of experience, purchasing existing songs from stock music sites, such as AudioJungle, is cost effective, however it requires searching through a large catalogue, searching may end in not finding the desired song, and it does not provide any control on the received output. Purchasing musical songs that were created solely based on automatic AI algorithms are also cost effective, but the quality of the songs is less compelling than songs created by humans, and they can not have copyright protection because they were created by machine and not a human, and they also provide a limited control over the output. In addition, the above solutions lack an option for the user to input his own song, or control the process in an automatic and iterative manner.

Music is widely used in entertainment, such as by musician artists, in musical shows and movies. Creating the arrangement of a song, assembling together musical ideas is done manually through Digital Audio Workstation (“DAW”). DAW is a software or hardware for music production, that is typically used for recording, editing, mixing and producing songs. This is a lengthy process that requires both coming up with musical ideas for each instrument and assembling them manually together. Once the creation is finished, musicians may try to improve their output song, however this is done manually, usually by means of DAW software.

In music theory, chord and scales can be related by giving numeric notation to notes. There is a numbering method for notes of the chord and another method of numbering for notes of the scale. ‘Root’ note of a scale or a chord is a note that is used to construct the other notes of the chord or scale using intervallic relationship relating to that root note. All of the other notes in a chord or scale are defined as intervals relating back to the root note. For example: The root note of “C Major” chord is the “C” note. The root note of “A minor” scale is “A” note.

Notes of scales are numbered in relation to the key of the scale. For example, if playing “C Major” scale, then notation of notes is: note ‘C’=‘1’, note ‘D’=‘2’, note ‘E’=3 and so on until note ‘B’=7.

Notes of chords are numbered in relation to the root note of the chord. A chord is formed when 3 or more tones are played together. Notes numbering with the addition of ‘b’ and ‘#’ symbols can be used to describe a formula for constructing chords. This is always done based on the root note of the chord, starting from the root note of the chord. A major chord triad is denoted as notes ‘1’, ‘3’ and ‘5’. For example: ‘C major’ or ‘F major’. A minor chord triad is denoted as notes ‘1’, ‘b3’, ‘5’. For example: ‘D minor’ and ‘E minor’. A diminished chord triad is denoted as notes ‘1’, ‘3’, ‘b5’.

An augmented chord triad is denoted as notes ‘1, 3, #5’, and so on.

The notation of notes in chords is different than the notation of notes in scales.

In music theory, time is defined by the beat, time signature and tempo. Beat is a fundamental measurement unit of time; it is used to describe the duration of notes, time signatures and tempo. Tempo describes the speed at which beats occurs; it is typically measured in beats per minute (BPM). The time signature defines the time length of a bar by specifying the number of beats in the bar. It is written at the beginning of a staff using a ratio of two numbers, a numerator and a denominator. The most common time signature in modern music is ‘4/4’.

MIDI Files and Events

A MIDI File contains a Header, and one or more Tracks. The Header contains information about the MIDI file, Number Of Tracks and Division fields. Each Track is typically assigned to a channel and to an instrument, and contains MIDI Events. Division defines a time resolution for the timestamp field in a MIDI event.

Each track contains MIDI events. Each MIDI Event has a Delta Timestamp, Status and MIDI Data.

Delta Timestamp is the number of ticks measured from the previous MIDI Event. Status is being used to identify the MIDI Event type. MIDI Data is the actual data of the event.

MIDI events include MIDI Note-On/Off events, Control events, Time Signature events and more.

Notes are described using MIDI Note-On and Note-Off Events pair. It has two fields: Note number and velocity. The Note Number specify the pitch of the note. The Velocity generally means the loudness of the note.

Controls are described using Control MIDI Event. Control events are used to describe effects and change the sound of the MIDI device. For example, there are controls for controlling Pan and Modulation.

MIDI is a format widely used at present for representing songs in a digital format. The present disclosure relates to MIDI as representing prior art music file format. However, the present invention may be used with other file format which may be used in future.

It is an objective of the present invention to provide method and system for improving musical creations such as songs, using digital processing, with means for overcoming the above-detailed, as well as other, deficiencies.

### BRIEF SUMMARY OF THE INVENTION

The present invention relates to a new method for improving music creation process, and for automatically creating new versions of a user's song. The method can be used by professional musicians, music creators and music fans, to create new original music, or to adapt existing songs for various purposes and usage, such as business, commercial, entertainment, well-being, etc.

The method includes the steps of: Receiving a song through MIDI notes and controls; converting the song into an analyzed song by computing properties for the notes; Transforming the analyzed song according to new chords and scales using the properties of the notes; Combining analyzed and new musical ideas from transformed songs with the user's song to create new songs; Outputting the new songs to the user; Getting feedback from the user; iteratively repeating the above steps to further improve outputs of the system.

Musical ideas may include new notes, chords and/or scales.

Goals and Benefits of the Current Invention

The following are examples of possible goals and benefits achievable with the present invention. People's interaction with music depends to a great extent on each user's personality and characteristics.

Goals and Benefits re Users of the system who create Music may include, among others:
To enable users who are music creators to automate the music arrangement step of music production, that is to automatically add instrument(s) with notes and controls that will accompany the user's original song or melody. This automation saves time and effort for the users.
To enrich music creativity by suggesting new notes, from analyzed songs and/or suggest new chords and/or new scales.
To entertain and increase well being.
To iteratively improve songs quality, using a subjective measurement by the user.
To diversify songs for better musical experience. To diversify songs means to create new song versions, that have different notes and/or chords and/or scales and/or effects. One benefit of diversifying songs is that the song sounds different each time it is played, making the song more interesting for its listeners, evoke different emotions at the user.
To save time and efforts when creating a new musical composition. This is done by automatically adding instruments and notes. This also saves time and effort in finding an optimal musical composition version, that is the version the creator is most satisfied with.
To provide insights for music analysis, composition and assembly.
Music creators can improve their skills, gain insights and get feedback for the songs created.
To provide a unique musical experience, that increase of user engagement with music and can contribute to the wellbeing of the user. By interacting with the system, users create and/or listen to music.
Engaging with music is one of the most favored activity among many people.

Goals and Benefits re Listening to Music may include, among others:
To improve identity formation at young people.
To affect emotions, improve moods and regulate moods. Listening to music can cause the brain to release dopamine which makes for a happier feeling and Reduces symptoms of depression.
To improve cognitive performance such as ability to study, creativity, memory and attention span. For example, people who listened to Mozart scored higher in an IQ test.
To assist in making physical exercises, such as running or working out in a gym.
To help in preventing dementia.
To help in managing pain. Research showed that listening to music makes patients less needy of pain medications.
To increase productivity and performance, and reduce errors at work.
To Improve motivation.
To reduce stress.
To help people to do meditation.
To help people sleep better.

Goals and Benefits Re Other Uses of the System May Include:
An optional business use of the system may provide music creators to gain financial profits by selling their songs to be transformed by the system.

The invention might offer an additional channel for Music creators to gain financial profits, by allowing their creations to be added to the analyzed database of songs, for a fee.

Users pay for creating new versions of their songs by transforming songs from the analyzed database.
To diversify music creation using both random decisions and control of the user.
To diversify the playback of a given musical composition for music fans. A fan can hear a song he likes in a variety of new ways.
To be used as a musical game for kids or people with no background in music. This can be used as an entertainment tool for kids, and/or to encourage kids to learn music.
To be used for hobbyists that like to play or wish to learn music.
To be used for musicians who wish to practice playing music.
Users who like to play musical instruments, can use the system to add instruments that will accompany them while playing. The number, type and parameters of such additional instruments can be controlled by the users.
To be used as a tool for professional music creators.
To diversify music in video creations, such as for YouTube or advertising, to diversify songs used in their videos. Benefits: Video may be more interesting for its viewers if the song sounds different every time it is played. Different songs can be chosen for evoking each specific emotions, for specific users,
To diversify songs used in games, such as games in mobile phones and tablets and/or online games. This has benefits for the companies that create the games and for the players of these games. Music is an important part of games. Diversifying the music that is used in games is beneficial both for games creators and players of the games. It can assist in changing the player to a desired mood, to make the game stand out from other games, to improve the player's experience with the game and to increase the user's engagement with the game and to increase the number of sells of the game.
Furthermore, users can choose preferred genres or artist to influence their creations, to enhance creativity, break old habits or patterns of thinking.
Users, such as music fans, can listen and/or create new versions of songs they like.
Users can also use the system to try to create new genres by combining songs from various genres together.

Another application of Infisong™ system is to offer stock music, with an improvement: the buyer can influence the product they buy.

Music creators can increase their chances of gaining financial profits by offering selling their songs to be transformed by the system.

Music students can learn on musical arrangements.

Music fans and hobbyists can get a diversified and richer musical experience.

Customized music generation.

Music creation can be improved using iterative songs creation sessions.

A session is iteratively improving a current song by suggesting improved versions and getting feedback from the user.

The above and other objectives are achieved by the method and system provided by the present invention.

### BRIEF DESCRIPTION OF THE SEVERAL VIEWS OF THE DRAWINGS

FIG. 1 illustrates a high-level overview of a transform song system A00.

FIG. 2 is a schematic illustration of Input Module 10.

FIG. 3 illustrates Output Module 11.

FIGS. 4A to 4G illustrate the structure of User Config File 106.

FIG. 4A shows the User Config File 106's structure.

FIG. 4B is an example of the Labels Table.

FIG. 4C: Song Parts Types Table.

FIG. 4F is the Chords Table.

FIG. 4G is the Scales Table.

FIG. 5A illustrates that an input song 100 can be used to create multiple SNT Files.

FIG. 5B illustrates the structure of an SNT file Structure.

FIG. 5C illustrates SNT Event Fields.

FIG. 5D illustrates SNT-Note Event Fields.

FIG. 5E illustrates a SNT-Control SNT Event Fields.

FIG. 5F shows Bars Table.

FIG. 6 is a flow chart of an example method that converts MIDI format To SNT format.

FIG. 7 shows a flow chart of creating bars based on the Time Signature events method.

FIG. 8 shows musical notes on a keyboard, that visualizes all the possible MIDI notes that can be played.

FIG. 9A shows notes on an octave of notes modulo 12 (“Mod-12-Octave”).

FIG. 9B shows a new, enumerated circle of octave notes, which is a modification of the Notes Circle.

FIG. 10A shows a flow chart of a method for analyzing a note.

FIG. 10B shows Note-Type possible values.

FIG. 10C is a flow chart of a method of a first implementation for determining Note-Type values.

FIG. 10D is a flow chart of a method of a second implementation for determining Note-Type values.

FIG. 10E illustrates an example of Note-Types values using method 740, when scale is ‘C major’ and chord is ‘A minor’.

FIG. 10F illustrates an example of Note-Types values using Method 770, when the scale is ‘C major’ and chord is ‘A minor’.

FIG. 11A shows a flow chart of a method for computing a specific note's properties (Note-Type and Note-Chord-Distances).

FIG. 11B is a flow chart of compute Note-Chord-Distances method.

FIG. 11C is a flow chart of a method for computing the distance between an input note and a chord note using scale notes.

FIG. 12A shows notes of ‘A minor’ chord and ‘A minor’ scale on notes circle.

FIG. 12B shows an example of computing Note-Chord-Distances for an input note ‘C’, when the scale is ‘A minor’ and chord is ‘A minor’.

FIG. 12C shows an example of computing Note-Chord-Distances for an input note ‘G’, when the scale is ‘A minor’ and chord is ‘A minor’.

FIG. 13A is a flow chart of a method for analyzing songs.

FIG. 13B is a flow chart of a method for analyzing a track.

FIG. 14 is a high-level overview of a method for analyzing and transforming an input song.

FIG. 15A is a flow chart of a method for transforming an input note to a new note value.

FIG. 15B is a flow chart of a method for transforming an input note that also transforms ongoing notes.

FIG. 16A is a flow chart of a method for computing transform's distance between an input note and a candidate note, using Note-Type and Note-Chord-Distances, version 1.

FIG. 16B is a flow chart of a method for computing transform's distance between an input note and a candidate note, using Note-Type and Note-Chord-Distances, version 2.

FIG. 16C is a flow chart of method for counting scale notes between two input notes.

FIG. 16D is a flow chart of a method for computing transform's distance between an input note and a candidate note, using Note-Type.

FIG. 16E is a flow chart of a method for computing transform's distance between an input note and a candidate note, using Note-Chord-Distances.

FIG. 16F is a flow chart of a method for computing transform's distance between an input note and a candidate note, using Note-Type and Note-Chord-Distances, version 3.

FIG. 17A is a flow chart of a method for transforming songs according to new chord and new scales.

FIG. 17B is a flow chart of method for transforming a track.

FIG. 17C is a flow chart of the transform ongoing notes method.

FIG. 18A is an example of ongoing notes that goes into block 7B1.

FIG. 18B is the continuation of the example of FIG. 18A.

FIG. 19A shows music notation of the notes of an input song.

FIG. 19B shows chords table of the input song.

FIG. 19C shows the scales table of the input song.

FIG. 19D shows the input MIDI events.

FIG. 19E shows calculating absolute times, Bars and Timepoints, as described in converting MIDI to SNT method 700.

FIG. 19F shows associating Note-On Note-Off pairs, as described in block 708 of Method 700.

FIG. 19G shows the resulting SNT File events.

FIG. 19H shows the resulting SNT File Bars Table.

FIG. 19J shows Analyzed SNT File Events.

FIG. 19K shows new chords table for the input song to be transformed to.

FIG. 19M shows new Scales Table.

FIG. 19N shows notes candidates for transforming input note ‘59 B3’, at Bar 1, timepoint 0.

FIG. 19P shows Transforming at Bar 1, timepoint 0, of the remaining two notes in this timepoint.

FIG. 19Q shows Transforming at Bar 1, timepoint 16.

FIG. 19R shows Transforming at Bar 1, timepoint 16, of the remaining two notes in this timepoint.

FIG. 19S shows the resulting transformed SNT Song.

FIG. 20A shows a music notation of the notes of an input song.

FIG. 20B shows chords table of the input song.

FIG. 20C shows the scales table of the input song.

FIG. 20E shows new chords table for the input song to be transformed to.

FIG. 20F shows new Scales Table.

FIG. 20G shows the resulting transformed song.

FIG. 21A illustrates Bars-Structure of a song.

FIG. 21B is a flow chart of a method for aligning a musical composition to a new Bars-Structure.

FIG. 22 is a high-level overview of a method for analyzing, aligning and transforming an input song.

FIG. 23A is a flow chart of a method for aligning input song's Bars-Structure.

FIG. 23B is a flow chart of the method for aligning InBar into AliBar

FIG. 24A shows an example of an input song with 4 bars, and a desired Bars-Structure with 6 bars.

FIG. 24B shows an example of an input song with 4 bars, and a desired Bars-Structure with 6 bars.

FIG. 24C shows an example of an input song with 6 bars, and a desired Bars-Structure with 4 bars.

FIG. 25A shows the input song.

FIG. 25B shows the aligned song.

FIG. 26A is an example an input bar with ¾ time signature.

FIG. 26B is an example of an output, aligned bar with a 4/4 time signature, by extending the last quarter notes option.

FIG. 26C is an example of an output, aligned bar with 4/4 time signature by duplicating the last quarter notes option.

FIG. 26D is an example of an output, aligned bar with 4/4 time signature by duplicating first quarter notes option.

FIG. 27 shows the Create new songs system overview (System A01).

FIG. 28A is a flow chart of a method for creating new musical composition.

FIG. 28B is a flow chart of another method for creating new musical composition.

FIG. 29A shows Command-Sequence performed on an input song to create a new song.

FIG. 29B is an example of Command-Sequence performed on an input song.

FIGS. 30A-30B are a flow chart of a method for creating a new song.

FIG. 31 is a flow chart of a method for performing a command on new song.

FIG. 32A shows input song's notes.

FIG. 32B shows input song's Chords Table.

FIG. 32C shows input song's Scales Table.

FIG. 32D shows an analyzed song's notes.

FIG. 32E shows an analyzed song's Chords Table.

FIG. 32F shows an analyzed song's Scales Table.

FIG. 32G shows a new song's notes.

FIG. 32H shows a new song's Chords Table.

FIG. 32J shows a new song's Scales Table.

FIG. 33 shows iterative song creation system overview (System A02).

FIG. 34A is a flow chart of a method for iteratively generating a plurality of new musical compositions and selecting a preferred musical composition method.

FIG. 34B is a flow chart of a method for iteratively creating new musical composition using the input musical composition.

FIG. 34C is a flow chart of a method for creating multiple new musical compositions using the input musical composition.

FIG. 35A shows a Session-States Table.

FIG. 35B visualizes Session-States transitions and commands.

FIG. 35C shows an example of a Session-States table.

FIG. 35D shows another example of a Session-States table.

FIG. 35E is an example of a customized Session-States Table.

FIG. 35F is another example of a customized Session-States Table.

FIG. 35G is an example of a User-Score Scale

FIG. 36A is a flow chart of method for iterative song creation.

FIG. 36B is a flow chart of a method for preparing for next iteration.

FIG. 37 shows an example of user interface screen.

FIG. 38A shows a high-level overview of the iterative song creation session example.

FIG. 38B shows notes notation of the input song (X281).

FIG. 38C shows an example of the notes of the analyzed song (X282).

FIG. 38D shows new song X283 created at Iteration 1.

FIG. 38E shows new song X284 created at Iteration 1.

FIG. 38G shows new song X288 created at Iteration 2.

FIG. 38H shows new song X289 created at Iteration 2.

FIG. 38J shows new song X28C created at Iteration 3.

FIG. 38K shows new Song 134 created at Iteration 3.

FIG. 39 shows another embodiment using multiple input songs.

### DETAILED DESCRIPTION

A preferred embodiment of the present invention will now be described by way of example and with reference to the accompanying drawings.

### Glossary of Terms

Music

| Term | Description |
|---|---|
| Bar | Also called a ‘measure’, is one complete cycles of the beats. Length of |
| | the bar is defined by the time signature. |
| | Bars organizes the musical composition. |
| Beat | A fundamental measurement unit of time, it is used to describe duration of |
| | notes, time signatures and tempo. |
| Beats per minute | Number of beats per minute. |
| (BPM) | |
| Chord | A musical unit consisting of three or more distinct notes. |
| Digital Audio | Software or hardware for music production. DAW is typically used for |
| Workstation | recording, editing, mixing and producing songs. |
| (“DAW”) | |
| Digital format | A communication protocol, or digital interface, that describes how computers |
| | and/or digital musical instruments communicate musical data, typically notes |
| | and control events, |
| Drums Track | A track that contains notes and control events of drums. In MIDI it is a track |
| | whose channel is set to 10 or 255, or a track that is set to an instrument |
| | number larger or equal to 126. Instrument above 126 is a special instrument, |
| | such as a ‘Helicopter’ instrument (numbered 126). |
| Event of a track | Describes notes, controls, time signatures and other song related information. |
| Octave notes | There are 12 possible notes in an octave: A, A# or Bb, B, C, C# or Db, D, |
| | D# or Eb, E, F, F# or Gb, G, G# or Ab. |
| Octave-Number | A number for a set of consecutive notes that resides in the range of an |
| | octave, starting from note ‘C’ in ascending order. |
| Ongoing notes | In a given timepoint, ongoing notes are notes that started before the given |
| | timepoint, but have not been stopped yet. In MIDI, this means that Note-Off |
| | event is received after the timepoint occurs when Note On event is received |
| | before the given timepoint. |
| Pitch | The frequency of a tone. It determines the harmonic value of a note. |
| | Each note has a different pitch value. |
| Scale | A collection of notes that typically characterizes the notes being played in a |
| | musical section. |
| Song | Musical composition in digital format |
| Song Part | A musical section that contains one or more bars, that comprises a song. The |
| | musical section repeats one or more times, typically with some notes or |
| | instruments changes, and creates the song's structure. |
| Song Part Type | A text string or label to describe the type of a song part. For example: |
| | ‘Intro’, ‘Chorus’, ‘Verse’ etc. |
| Tempo | Describes the speed at which beats occurs. Typically measured in beats per |
| | minute (BPM). |
| Time Signature | Defines the time length of a bar by specifying the number of beats in the bar. |
| | It is written at the beginning of a staff using a ratio of two numbers, a |
| | numerator, and a denominator. Numerator is the number of beats in a |
| | measure. Denominator indicates the beat value, the division of a whole note. |
| | The most common time signature in modern music is ‘4/4’ |
| Track | Container for one or more events |
| Root note | Root note of a scale or a chord is the note that defines the intervallic |
| | relationships in the rest of the scale or chord. Using intervals, of the chord or |
| | scale, it defines all of the other notes. |

MIDI

| Term | Description |
|---|---|
| Channel | Allow to send MIDI messages to different devices or instruments. |
| Division | Part of MIDI header, defines time resolution for timestamp field in MIDI |
| | event. |
| MIDI | Musical Instrumental Digital Interface. A widely used industry-standard |
| | protocol for communicating musical information among musical instruments |
| | and computers and for storing, playing and sharing MIDI recordings using |
| | SMF format files. |
| MIDI control event | A MIDI message that is sent when a controller value changes. Control event |
| | describes effects and change the sound of the MIDI device. |
| MIDI Note-Off | A MIDI message that is sent when a note is released (stops). |
| event | |
| MIDI Note-On | A MIDI message that is sent when a note is pressed (starts). |
| event | |
| Timestamp | Value that gives indication to the time that the MIDI event occurs. |

SNT File

| Term | Description |
|---|---|
| Arrangement Tracks | The tracks of a song, typically excluding the melody track. |
| BarTime | The duration of the bar, in clock ticks |
| Channel | Allow to send MIDI messages to different devices or instruments. |
| Division | Part of MIDI header, defines time resolution for timestamp field in MIDI |
| | event. |
| dTimepoint | Number of clock ticks per timepoint |
| Melody | Contains notes and controls of the melody that leads the song, typically |
| | performed by a human singer. |
| Melody-Track- | The number of the track that contains the melody notes. |
| Number | |

Analyze and Transform Song

| Term | Description |
|---|---|
| ‘Harmonic’ Note- | Indicates that the note is one of the notes of the chord |
| Type (“H”) | |
| ‘Harmonic-0’ Note- | Indicates that the note is the first note of the chord, or the root chord note. |
| Type (“H0”) | |
| ‘Harmonic-1’ Note- | Indicates that the note is the second note of the chord |
| Type (“H1”) | |
| ‘Harmonic-2’ Note- | Indicates that the note is the third note of the chord |
| Type (“H2”) | |
| ‘Non-scale’ Note- | Indicates that the note is neither chord note nor scale note. |
| Type | |
| ‘Scale’ Note-Type | Indicates that the note is one of the notes of the scale, but not one of |
| (“S”) | the notes of the chord |
| ‘Scale-0, 1, 2, 3, | Indicates that the note is a specific scale note, denoted by its Note-Type |
| 4, 5, 6’ Note-Type | value. |
| (“S0, 1, 2, 3, | |
| 4, 5, 6”) | |
| Analyzing a | Adding notes properties for the notes |
| song/track/notes | |
| Note properties | Note properties are a new type of data, presented in this disclosure. They |
| | contain new values that are calculated for notes: Note-Type, Note-Chord |
| | Distance 0, Note-Chord-Distance 1 and Note-Chord-Distance 2. |
| Note-Chord- | Measures distance between a specific note and one of the notes of a chord |
| Distance (“NCD”) | |
| Note-Chord- | Measures distance between a specific note and the first note of a chord |
| Distance-0 | |
| (“NCD-0”) | |
| Note-Chord- | Measures distance between a specific note and the second note of a chord |
| Distance-1 (“NCD- | |
| 1”) | |
| Note-Chord- | Measures distance between a specific note and the third note of a chord |
| Distance-2 (“NCD- | |
| 2”) | |
| Note-Chord- | Set of computed note chord distances between a specific note and the |
| Distances (“NCDs”) | notes of the chord. The set typically contain NCD-0, NCD-1 and NCD-2. |
| Note-Type | A way to denotes notes using the current chord and scale. This gives |
| | indication whether this note belongs to chord notes, scale notes that are not |
| | chord notes, or neithr of them. Indicates the type of the note. Note-Type |
| | possible values are ‘Harmonic’, ‘Scale’ ‘Non-scale’. ‘Harmonic-0, 1, 2’, |
| | ‘Scale-0, 1, 2, 3, 4, 5, 6, 7’. |
| Transforming a | Changing notes to be harmonic with a new sequence of chords and scales. |
| song/track/notes | |

Align Song

| Term | Description |
|---|---|
| Bars-Structure | Describes the number of bars, and the number of beats in each bar, of |
| | a song. Bars-Structure is comprised of number of bars and bar’s length array. |
| | Number of bars indicates the number of bars in the song. Bar’s length array |
| | contains the length of each bar in the song. In this embodiment, the |
| | length of a bar is measured by the number of timepoints in that bar. |
| Timepoint | A unit of fixed length time. A bar is comprised of timepoints, that are |
| | organized one after the other in a non-overlapping manner. Each note resides |
| | in a timepoint. For example: If a quarter note length is represented by 8 |
| | timepoints, then a 4/4 bar is represented by 32 timepoints, a 32nd note is |
| | found in one of these 32 timepoints. |

Create New Song

| Term | Description |
|---|---|
| Add/Replace-T rack | Command that is used when creating a new song. Chooses between Add- |
| | Track command and Replace-Track command, and then performs the chosen |
| | command on the new song. |
| Add-Arrangement | Command that is used when creating a new song. Add all tracks (typically |
| | excluding melody), from another song to the new song. |
| Add-Track | Command that is used when creating a new song. Adds a track from another |
| | song to the new song |
| Command-Sequence | a sequence of commands that are being performed on an input song to |
| | create a new song. Example of commands are: Add-Track, Remove-Track, |
| | Replace-Track, Add-Arrangement and Add/Replace-Track. |
| Replace-Track | Command that is used when creating a new song. Removes an existing track |
| | from the new song, then adds a new track from another song to the new song. |

Part 3: Iteratively Create New Songs

| Term | Description |
|---|---|
| Highest-Scored- | The new created song that has the highest User-Score of all new |
| Song | songs created in the iteration. |
| Next-Iteration | Request from the user to move to next iteration |
| Output-Song | Request from the user to output a specific new song to the user, such as |
| | playing it to speakers |
| Score-Threshold | A number that determines the threshold that User-Score of the Highest- |
| | Scored-Song must be above, in order to move to the next Session-State in |
| | the next iteration. If User-Score of the Highest-Scored-Song is below the |
| | threshold, then system remains in the same Session-State in the |
| | next iteration. |
| Session-State | A number that represents the state of the system when performing an |
| | iteration. Each Session-State is connected to a Command-Sequence to be |
| | performed in that iteration. Through the Session-States Table. |
| Session-States Table | Table that describes the possible Session-States and their Command- |
| | Sequences. |
| Set-Feedback | Request from the user to provide User-Score feedback for a specific |
| | new song. |
| User-Score | Subjective score feedback from the user. A number, received |
| | from a user, indicative of the user's satisfaction with a new |
| | musical composition. |

Analyze and Transform a Song

A method for analyzing and transforming a song in digital format is described. The terms “song” and “musical composition” are equivalent and are used interchangeably throughout the present disclosure. “Digital format” can refer to a communication protocol, or a digital interface, that describes how computers and/or digital musical instruments communicate musical data, typically notes and control events, such as Musical Instrumental Digital Interface (“MIDI”) standard. Digital format can also refer to any file format that describes musical data, typically notes and controls, such as Standard MIDI File (“SMF”) and MusicXML.

The implementation shown in this disclosure uses MIDI for the input digital format because MIDI is widely used and have become the industry-standard protocol for communicating musical information among musical instruments and computers and for storing, playing and sharing MIDI recordings using SMF format files.

However, MIDI is used just as an example of one embodiment of the present invention.

Persons skilled in the art will appreciate that the present invention can be applied to other formats for representing songs, both present and future formats; this without departing from the scope and spirit of the present invention.

A song typically comprises one or more tracks. A track is a container for one or more events.

Events describe notes, controls, time signatures and other song related information. to be played, typically by a specific instrument.

A song may have a melody track in it. A “melody track” contains notes and controls of the melody that leads the song, typically performed by a human singer.

Analyzing a song means adding notes properties for notes.

Transforming a song means changing notes of the song to be harmonic with a new sequence of chords and scales.

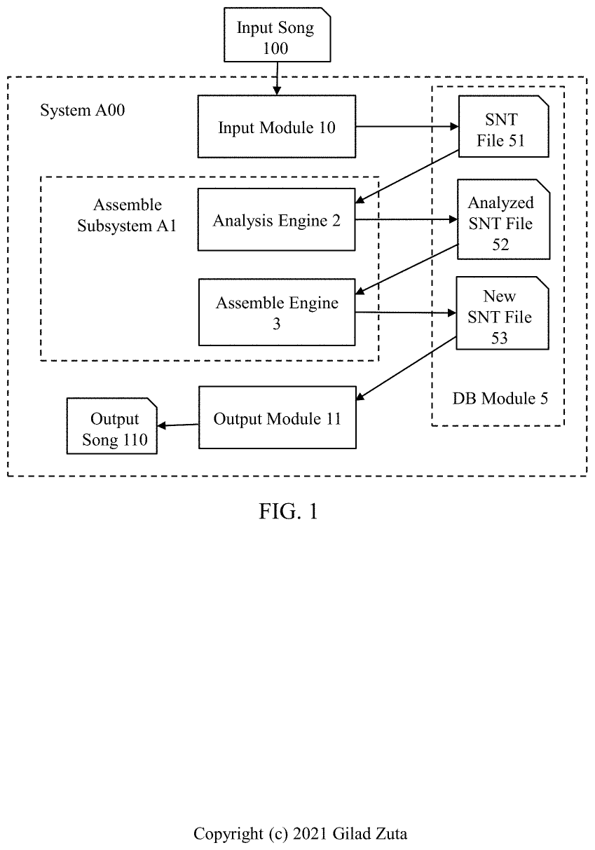

FIG. 1 illustrates a high-level overview of a transform song system A00. This system receives a user input song 100, and creates a transformed version thereof, the output song 110. The input song 100 and output song 110 are preferably MIDI files.

MIDI is the format presently preferred in the musical field; if and when other standards emerge, the present invention can be adapted to use such standards; this, without departing from the spirit and scope of the present invention.

The input song 100 goes into input module 10. Input module 10 converts the input song into a digital format. In the embodiment shown in this disclosure, an “SNT” file format is used. SNT file is a new format disclosed in this invention, which has various advantages, for example: it includes additional information per note—note properties. It includes additional song information, such as chords and scales, it organizes all MIDI events on a common timescale of bar and timepoint, which is convenient for processing, and it holds one SNT Note-On Event instead of MIDI events pair—Note-On and Note-Off.

Input Module 10 typically creates a new SNT file 51 out of the Input Song 100.

The DB Module 5 performs saving and loading files that are generated in the system. Typically, the files are stored on a file system. Alternatively, some of the files can be stored in memory, or in a database, or in a cloud storage, or in any other known storage system.

Analysis Engine 2 receives the SNT File 51, and analyzes the song. Analyzing the song means to add new types of data, as herein disclosed. The analyzed data contains notes properties for each Note-On event, the note properties include ‘Note-Type’ and/or ‘Note-Chord-Distances’, which are further detailed elsewhere in the present disclosure.

The Analysis Engine 2 creates a new Analyzed SNT File 52, and writes the song data as well as the additional analyzed data to that file.

Assemble Engine 3 receives new chords and/or new scales for the song. Assemble Engine 3 reads the Analyzed SNT File 52 and performs a new type of transform, that is disclosed in this invention, that transforms the notes of the song to the new chords and/or new scales. After finishing, the Assemble Engine 3 writes the new song into New SNT File 53.

Output Module 11 reads the song from New SNT File 53, and can convey it to the user in various ways, such as playing it to the speakers, displaying its notes on the screen, converting it to MIDI, MP3 or WAV files and allowing users to download it, sending its notes to DAW, etc. The Analysis Engine 2 and Assemble Engine 3 are part of the Assemble Subsystem A1.

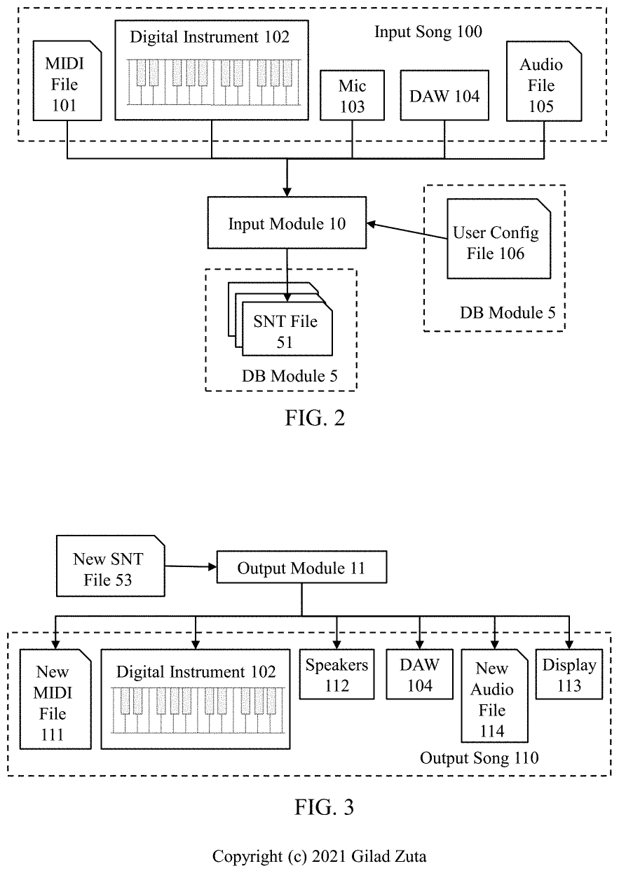

FIG. 2 is a schematic illustration of Input Module 10. The Input Module 10 gets an Input Song 100. Input Song 100 represents a song's input data, comprising notes and controls, typically MIDI notes and MIDI controls. Input Song 100 can be created from various input sources.

A First input source option is a MIDI File 101. A MIDI file can be created in various ways, such as using a Digital Keyboard or DAW software. The MIDI file can contain MIDI notes and control events. The MIDI file is uploaded by the user. MIDI is suggested because it is a standard that is now commonly used, however any digital file or protocol format that describe a musical composition using notes can be used, such as ABC Notation, MusicXML, Notation Interchange File Format (NIFF), Music Macro Language (MML), Open Sound Control (OSC) and so on.

A Second input source option is a Digital Instrument 102. Digital Instrument 102 is any type of hardware that is capable is sending MIDI data, or any protocol of sending notes, such as: Digital Keyboards, Synthesizers, MIDI Controllers keyboards, MIDI Instruments. Digital Keyboard examples are Casio CT-X700 and Yamaha PSR-5975. MIDI Controller Keyboard example is Arturia KeyLab 25. MIDI Instrument examples are AKAI Professional MPD218 and Alesis Vortex Wireless 2. Synthesizer example is Roland JD-Xi.

A Third input source option is a microphone. There are existing tools that can convert voice into MIDI instrument, for example Vochlea provides Dubler Studio Kit that converts voice to MIDI.

A Fourth input source option is a Digital Audio Workstation plug-in, or DAW 104. A DAW is a software used for music creation and production. Commonly used DAW software for example are Abelton Live, Cubase, FL Studio, GarageBand and Logic Pro and Pro Tools. DAWs typically include software plugins, created by third parties, to expand their overall functionality. The DAW dynamically loads these plug-ins. There are various architectures that are being used for integrating the plugins. For example, Virtual Studio Technology (VST) is an architecture developed by Steinberg, to provide interface for integrating software synthesizes and effects developed by third parties into Cubase's DAW. For example, JUCE is an open-source framework that can be used for creating plug-ins for many DAWs, including Cubase, Logic and Pro Tools. Therefore, a DAW plug-in can be used to interface between DAW 104 and the Input Module 10.

A Fifth input source option is Audio File 105, such as WAV, MP3 or AIFF format. This input source also includes multimedia formats that contains audio and video, such as Audio Video Interleave (AVI), MP4 and OGG. There are known tools that can extract MIDI data from audio files. For example, AVS Audio Converter and Zamzar are tools that can convert MP3 to MIDI format.

Other embodiments can further include other input sources that provide an input song, such as AI composing engines, software other than DAW, and so on.

Input Module 10 creates a new file, SNT file 51, out of the Input Song 100. In one embodiment, Input Module 10 uses Song Parts Types Table of User Config File 106, to create the SNT file 51 for each song part type of the Input Song 100, as discussed elsewhere in the present disclosure.

In another embodiment, SNT file 51 is created in real-time.

Input Song 100 is typically a MIDI File, so we will mostly use MIDI File 101 to represent the user input song. DB (Database) Module 5 performs saving and loading of the files.

The input song (100) may either be written to a digital file such as a SNT file (51) and then processed by the system, or it may be received in real-time, to be processed by the system as it is received.

FIG. 3 illustrates Output Module 11. The Output Module 11 conveys a song, such as New SNT File 53, to the user in various ways. The Output Module 11 conveys the song to the user for the purpose of being reviewed by the user. Typically, the song is played to the speakers 112. Additionally, song notes and other song information can be displayed to a display or screen, or passed to a DAW software.

A first option to output the song is to convert the song to MIDI File 111 format. MIDI is suggested because it is a standard that is very commonly used, however any digital file or protocol format that describe a musical composition using notes as described in MIDI File 101, in FIG. 2.

A second option is to output the song into a Digital Instrument 102. For example, a Digital Keyboard can be controlled by a software running on a computer and play the song.

A third option, which is the most common, is to play the song on the Speakers 107, or on headphones (not shown).

Another option is to send the song into a DAW, such as by using a plugin in the DAW, or to send it to any other software that can receive notes, or that can read musical file formats such as MIDI files.

Another option is displaying song information on a Display 113. For example, notes notation can be displayed on screen in a musical score. Another example is to display notes in a string representation (such as ‘A3’ to specific note ‘A’ on octave ‘3’). Additional information that can be displayed on screen includes values calculated by the system (such as note properties, learned values, predicted values using AI), a song number (in iterative song creation), a creation date & time, changes in chords and scales that were done, added/changed notes/chords/scales, and other various statistics. Statistics can include the number of notes, the number of harmony notes, the number of scale notes etc.

Another option for output is to convert the file into audio format, such as MP3 or WAV. There are various desktop tools and online converters that can be used for this conversion, such as MixPad, Desktop Metronome, Zamzar, Online-Convert etc.

Other embodiments can further include other output options such as AI tools, software other than DAW, and so on.

In another embodiment, Output Module 11 may add additional processing to the audio or MIDI notes before outputting the song for the user, as common in music production. Examples of such processing are replacing MIDI notes with virtual instruments that play the notes, and adding effects to the audio.

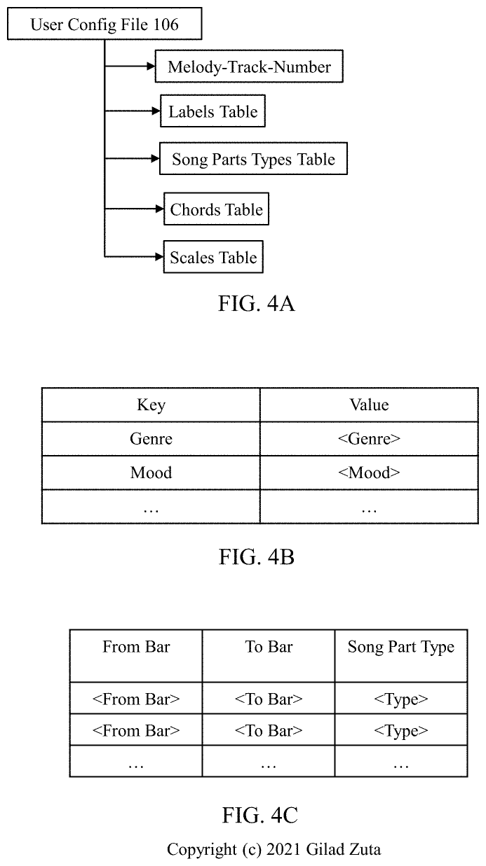

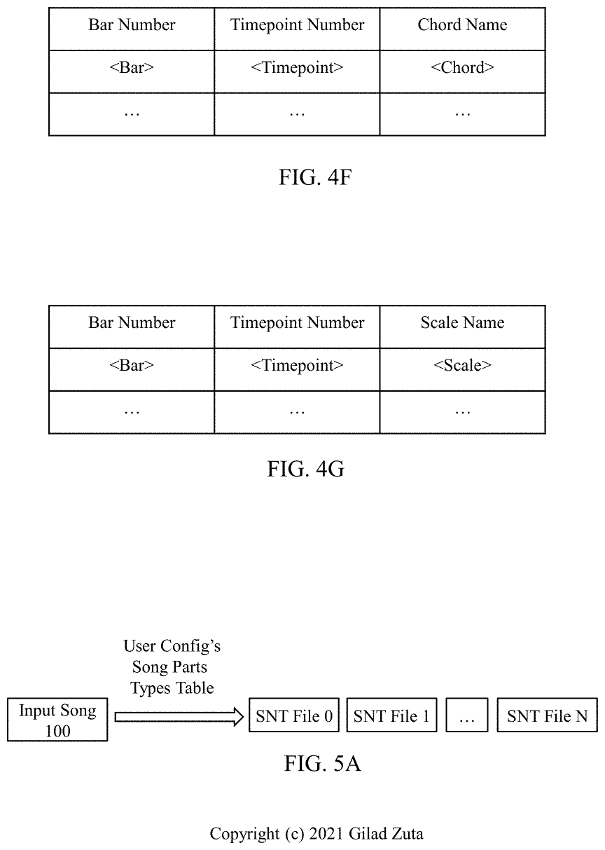

FIGS. 4A to 4G illustrate the structure of User Config File 106. The use of this file is optional. FIG. 4A shows the User Config File 106's structure. The User Config File 106 contains information that the user may provide for the system to help the system analyze and transform the song. User Config File 106 contains the following information: Melody-Track-Number, Labels Table, Song Parts Types Table, Chords Table and Scales Table. “Melody-Track-Number” is the number of the track that contains the melody notes. Melody-Track-Number helps the system to distinguish between melody track and the other tracks, that are called ‘arrangement tracks’. The other tables of User Config File 106 will be discussed in the next figures. Melody-Track-Number value of −1, for example, can be used to indicate that the song does not have a melody track.

FIG. 4B is an example of the Labels Table. Each entry of the table contains key-value pairs. This table is optional. It provides additional information regarding the user song. The table can have a variety of labels that may be requested by the system or originated from the user. Typically, it will contain an entry for the Genre, such as ‘pop’, ‘rock’, ‘80s’ etc., and an entry for ‘Mood’, such as ‘happy’, ‘sad’, etc.

The Labels Table can be used by the system when creating new songs. This allows the system to choose the same Genre, a different Genre, or a combination tracks of same and different Genre, as discussed elsewhere in the present disclosure.

FIG. 4C: Song Parts Types Table. This table is optional.

‘Song part’ is a musical section that contains one or more bars, that comprises a song. The musical section repeats one or more times, typically with some notes or instruments changes, and creates the song's structure.

“Bar”, also called a ‘measure’, is one complete cycle of the beats. Length of the bar is defined by the time signature. Bars are used to organizes the musical composition. ‘Song Part Type’ is a text string or label to describe the type of a song part. For example: ‘Intro’, ‘Chorus’, ‘Verse’ etc.

As shown in FIG. 1, Input Module 10 creates a new SNT file 51 out of the Input Song 100. In one embodiment, Input Module 10 uses Song Parts Table to create an SNT file for each part of the Input Song 100.

<From Bar> is the starting bar number of the part. <To Bar> is the ending bar number of the part. <Type> is the song part's type, such as ‘Intro’, ‘Chorus’, ‘Verse’ etc.

FIG. 4F is the Chords Table. This table describes the chords being used in a song. Every chord used in the song is described by an entry in the table. <Bar> is the bar number of the chord. <Timepoint> is the timepoint number in <Bar> of the chord. <Chord> is the chord's name. “Timepoint” is a unit of fixed length time. A bar comprises timepoints, that are organized one after the other in a non-overlapping manner. Each note resides in a timepoint. For example: If a quarter note length is represented by 8 timepoints, then a 4/4 bar is represented by 32 timepoints, a 32nd note is found in one of these 32 timepoints.

In one embodiment, the Chords Table describes the chords of the all the tracks and bars of the song. Using a chords table for the entire song is simple to understand and maintain by the user. It gives coherent results because all tracks are transformed according to the same chords.

In another embodiment, there can be a specific Chords Table for different tracks in the song. This enables more complicated songs to be created. For example, in a given timepoint, a user can use “C Major” chord for one track, and “A minor” chord for a second track. The transformed tracks can still maintain harmonic notes because the chords have overlap in notes, both chords contain notes “C” and “E”.

FIG. 4G is the Scales Table. This table describes the scales being used in a song. Every scale used in the song is described by an entry in the table. <Bar> is the bar number of the scale. <Timepoint> is the timepoint number in <Bar> of the scale. <scale > is the scale's name.

In one embodiment the Scales Table describes the chords of all the tracks and bars of the song. Using a scales table for the entire song is simple to understand and maintain by the user. It gives coherent results because all tracks are transformed according to the same scales.

In another embodiment there can be specific Scales Table for different tracks in the song. This enables more complicated songs to be created.

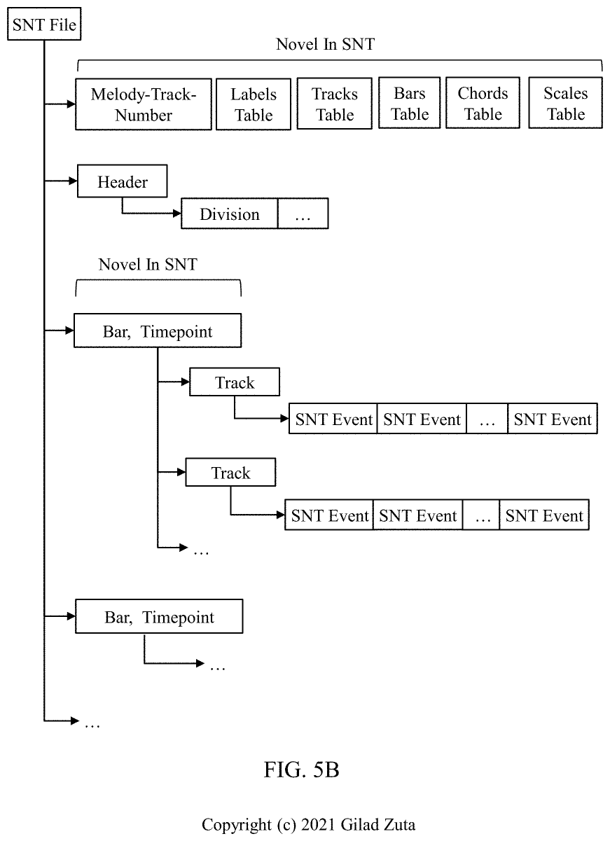

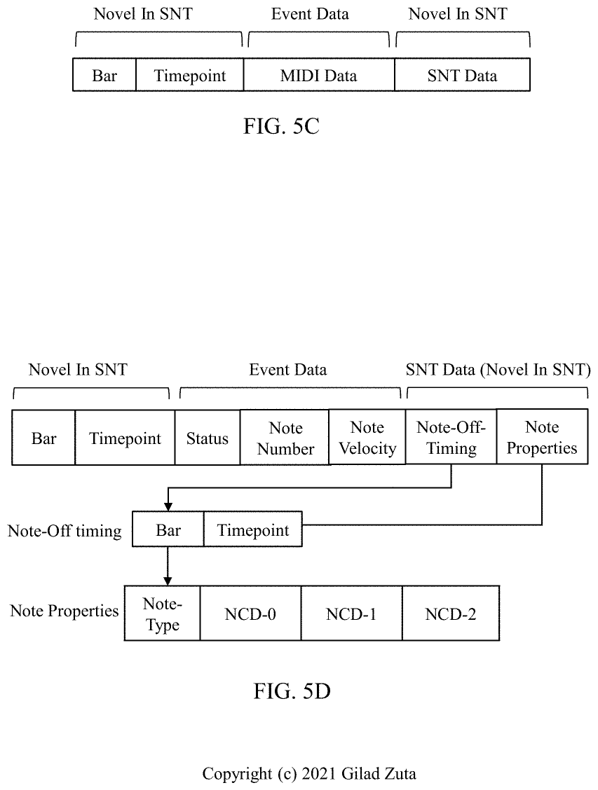

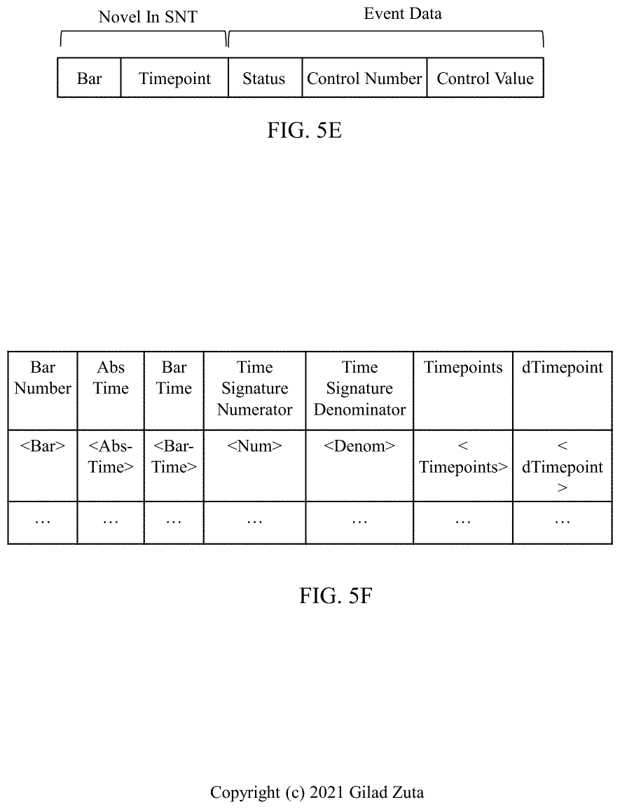

FIGS. 5A to 5F illustrate the structure of an SNT file format. The SNT file is a new format disclosed in this invention. The use of this file is optional. The SNT file is shown as an example of an implementation of the disclosed invention.

FIG. 5A illustrates that an input song 100 can be used to create multiple SNT Files. This is optional. Input song 100 may be a MIDI file. As mentioned in FIG. 2, Input Module 10 creates a new SNT file 51 out of the Input Song 100. Optionally, Input Module 10 uses Song Parts Types Table of User Config File 106, to create an SNT file for each song part of the Input Song 100. So if for example, Song Parts Types Table of User Config File 106 has four entries, then four SNT File 51 files will be created.

For each created song, the song part type of that song, such as ‘chorus’, is added to the Labels List (FIG. 4B).

In another preferred embodiment, a MIDI File can be used to create just one SNT File.

FIG. 5B illustrates the structure of an SNT file.

An SNT file contains information taken from User Config File 106, such as: Melody-Track-Number, Labels Table, Chords Table and Scales Table.

The Header contains information about the SNT file. Typically, it contains a Division field.

Division field defines time resolution for timestamp field in MIDI event.

Notes and controls are described in SNT events. SNT events are part of a track. Tracks and their SNT events are grouped by the bar number and timepoint number in that bar, of the events.

Information novel in the SNT format vs. MIDI includes, for example:

a. A main difference from MIDI format is that the events are grouped into Bar and Timepoint in that bar. It organizes all MIDI events on a timescale of bar and timepoint,

Benefit—it eases the processing, by placing all the events, chords and scales on a shared, common timeline. It is convenient for creating notes score notation and for processing notes as disclosed in this invention.

b. SNT format includes additional song information, such as labels, chords and scales that are used in the song.

Benefits: The system can analyze notes of the song using chords and scales, and the system can categorize similar songs using the labels.

c. In SNT format, one ‘Note-On’ SNT event replaces two MIDI events—Note-On and its corresponding Note-Off.

Benefits: Less events to process and store, and the system knows the length of the note by processing one event.

FIG. 5C illustrates SNT Event Fields. An SNT event can describe a control or a note. If describing a control, the Event Data contains control information such as changing qualities of sound. If describing a note, Event Data contains note information, such as note number and note pressure. In case that SNT is created from MIDI, Event Data is MIDI data taken from the MIDI event.

If describing a note, and another field of SNT Data is used to describe note properties.

Bar number and Timepoint number are novel in SNT. Bar is the bar number that this event occurs in. Timepoint is the timepoint number in the bar that the event occurs in.

For each control or note event, Bar and Timepoint are computed to represent its time, events are grouped by Bar and Timepoint in addition to grouping by tracks. SNT Data is another novelty in SNT, as described in FIG. 5D.

FIG. 5D illustrates SNT-Note Event Fields. SNT-Note event describes a note occurring in the song. When an SNT file is created from a MIDI file, SNT-Note events are created from MIDI Note-On and Note-Off events pairs. Event Data contains Note Number and Note Velocity, that are copied from MIDI Note-On event.

New fields that are added in SNT Event are: Bar, Timepoint and SNT Data.

SNT Data contains note properties and Note-Off-Timing. Note properties includes ‘Note-Type’ and ‘Note-Chord-Distances’.

An SNT-Note event replaces two MIDI Events—Note-On and its corresponding Note-Off.

MIDI Note-On event data, which is Note Number and Velocity, are copied into SNT MIDI Data.

MIDI Note-Off bar and timepoint are calculated, and copied into Note-Off-Timing field.

Note properties are a new type of data, presented in this disclosure. They contain new values that are computed for note events: Note-Type, Note-Chord-Distance-0 (“NCD-0”), Note-Chord-Distance-1 (“NCD-1”) and Note-Chord-Distance-2 (“NCD-2”). Note-Chord-Distances (“NCDs”) is the set of computed note chord distances, it typically contains NCD-0, NCD-1 and NCD-2.

Note-Type indicates the type of the note, which can be ‘Harmonic’ if it is one of the chord's notes, ‘Scale’ if it is not a chord's note but part of the scale, ‘Non-scale’ otherwise.

Note chord distances (NCD-0, NCD-1 and NCD-2) are a new metric that measures distance between a specific note and the notes of the current chord. This distance is the basis for doing song transforms, as discussed elsewhere in the present disclosure.

FIG. 5E illustrates a SNT-Control Event Fields. SNT-Control event describes a control change occurring in the song. When created from MIDI control event, Control Number and Control Value are copied from MIDI Control event.

FIG. 5F shows Bars Table.

Each entry (row) in the table describes a bar, or measure, of the song.

The table can start from any bar number, as long as each consecutive entry's bar number ascends by 1.

<Bar> is bar number.

<AbsTime> represents the absolute time where the bar starts.

<BarTime> is the time length of the bar.

<Num> number that represents Time Signature Numerator value, <Denom> number that represents Time Signature Denominator value.

<Timepoints> is number of timepoints in bar.

<dTimepoint> is the time duration of a single timepoint.

Time in <AbsTime>, <BarTime > and <dTimepoint> is measured using the same time units as Delta Timestamp of MIDI events. If Delta Timestamp of MIDI events is measured in clock ticks, which is commonly the case, then <AbsTime>, <BarTime > and <dTimepoint> are also measured in clock ticks.

In other embodiments, any other units of time may be used for the variables involved.

For example:

In a bar with a 4/4 time signature, that has 32 timepoint:

BarTime—is the time length of the bar.

$$Bar . BarTime = 4 ⋆ Header . Division ⋆ ( \frac{Bar . Key\_Signature \_Numerator}{Bar . Key\_Signature \_Denominator} ) \qquad ( 1 )$$

BarTimepoints—Number of timepoints in a bar. This is determined by the bar's key signature.

Each key signature contains numerator and denominator, for example: 4/4, 2/4.

BarTimepoints is calculated by the following equation:

$$Bar . Timepoints = 32 ⋆ ( \frac{Bar . Key\_Signature \_Numerator}{Bar . Key\_Signature \_Denominator} ) \qquad ( 2 )$$

For example, in 32 time points per bar with 4/4 key, this will be:

$$Bar . Timepoints = 32 ⋆ ( \frac{4}{4} ) = 32$$

dTimepoint—Clock ticks of a single timepoint. This is based on Division field from MIDI header. Typically, a 4/4 bar and 32 timepoints are being used, in this case dTimepoint is calculated using:

$$Bar . dTimepoint = \frac{4 ⋆ Header . Division}{32} = \frac{Header . Division}{8} \qquad ( 3 )$$

For example: If Division is 120 ticks, in a 4/4 bar, with 32 timepoints of that bar, then:

$$Bar . dTimepoint = \frac{120}{8} = 15$$

Converting MIDI to SNT

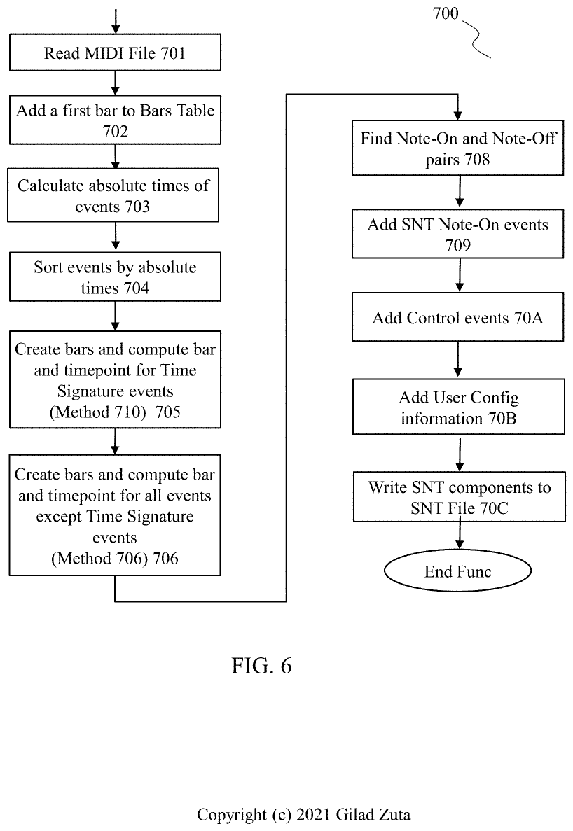

FIGS. 6 to 8 show an embodiment for converting a file from MIDI format to SNT format.

FIG. 6 is a flow chart of an example method that converts MIDI format To SNT format. This method converts from MIDI notes and controls, of MIDI File 101, to SNT format, SNT File 51 (see for example FIGS. 1 and 2).

As shown in FIG. 5A, a MIDI File can be used to create multiple SNT Files. As mentioned in FIG. 2, Input Module 10 creates a new SNT file 51 out of the Input Song 100. Input Module uses Song Parts Types Table of User Config File 106, to create a SNT file for each song part of the Input Song 100. So if for example, Song Parts Types Table of User Config File 106 has four entries, then the method shown in this figure will run four times, once for each song part, to create four SNT File 51 files.

Alternatively, a MIDI file can be converted to one file in SNT format.

The Division of MIDI header is used to translate timing values to SNT file format. Notes on, notes off and control are processed by the system, as discussed elsewhere in the present disclosure.

Method 700: Convert MIDI To SNT

The method includes, see FIG. 6:

In block 701, read the MIDI file.

In block 702, add a first bar to Bars Table. Bars Table is the table of bars of SNT File 51, the song file that is being created. Every song is expected to have at least one bar in it, therefore the system adds a default 4/4 Time Signature and creates a first bar. For this first bar the system sets:

Bar.AbsTime=0

Bar.TS_Num=4

Bar.TS_Denom=4

Bar.BarTime=4*Header.Division*Bar.TS_Num/Bar.TS_Denom

Bar.Timepoints=32*Bar.Num/Bar.TS_Denom

Bar.dTimepoint=Header.Division/8

Where:
‘Bar.AbsTime’ is the absolute time that the bar starts, in clock ticks.
‘Bar.TS_Num’ is the numerator of the time signature of the bar.
‘Bar.TS_Denom’ is the denominator of the time signature of the bar.
‘Bar.BarTime’ is the duration of the bar, in clock ticks.
‘Bar.Timepoints’ is the number of timepoints in the bar.
‘Bar.dTimepoint’ is number of clock ticks per timepoint.

In block 703, calculate events absolute times. This is done for every track in the MIDI file. For a specific track, an AbsTime variable is first initialized to 0. Then, a loop is iterating over all events in the track. Each event contains a Delta Timestamp field, as shown in FIG. 4b: MIDI Event Fields.

For every event, absolute time variable (“AbsTime”) accumulates Delta Timestamps:

AbsTime=AbsTime+Event.DeltaTimestamp

And then AbsTime variable is stored in Event.AbsTime field:

Event.AbsTime=AbsTime

So after adding Event.DeltaTimestamp, AbsTime is stored in memory for each event.

In block 704, create a list with events sorted by their absolute times. The list contains events from all tracks in the song, sorted by the absolute times, that is calculated in block 703.

In block 705, create bars and compute bar and timepoint for Time Signature events. This is done by running Method 710 on every Time Signature event in the sorted events list.

In block 706, create bars and compute bar and timepoint for all events except Time Signature events. This is done by running Method 710 on every event that is not Time Signature event, in the sorted events list.

In block 708, find Note-On and Note-Off pairs. For each track, iterate over all events of the track. If reached a Note-On event, then store its Note Number in an ‘Ongoing Notes’ list in memory. Ongoing notes in a given timepoint are notes that started before the given timepoint, but have not been stopped yet. In MIDI, this means that Note-Off event is received after the timepoint occurs when Note-On event is received before the given timepoint.

If reached a Note-Off event, then search for the Note-Off's Note Number in the Ongoing Notes list. Associate the Note-Off with the Note-On in the Ongoing Notes list whose Note Number matches the Note-Off. Then, remove the Note Number from the Ongoing Notes list, because the Note-Off indicates that the note is no longer pressed.

In block 709, add SNT-Note events. For every Note-On in the MIDI file, create an SNT-Note event. Copy MIDI Data, Note Number and Velocity fields, to Event Data fields, Note Number and Velocity, as shown in FIG. 5D.

Get the associated Note-Off of that Note-On, that was found in block 708. Copy the associated Note-Off's Bar and Timepoint into Bar and Timepoint fields of Note-Off-Timing of the SNT-Note Event, as shown in FIG. 5D. Set Note Properties pointer to null.

Add the SNT Note-On event to SNT File according to its Bar and Timepoint, as illustrated in FIG. 5B.

In block 70A, add Control events. For every Control event in the MIDI file, create an SNT-Control Event. Control Number and Control Value are copied from the MIDI Control event to Control Number and Control Value of the SNT-Control event, as shown in FIG. 5E.

In block 70B, add user config information. Copy user config information from: Melody-Track-Number, Labels Table, Chords Table and Scales Table, from User Config File 106, which is described, in FIG. 4A. Copy this information to: Melody-Track-Number, Labels Table, Chords Table and Scales Table of SNT File, as shown in FIG. 5B.

Chords Table and Scales Table are copied only with the relevant bars for this song part that was configured in the User Config File 106. Chords Table and Scales Table must have values for the first bar and timepoint of the song; if they do not have that, then an entry is created at table's start with the last value before the song part is copied.

For example, if the chords table contains 2 entries: [bar 0 timepoint 0 chord C], [bar 4 timepoint 0 chord Am].

Song part of type ‘Verse’ is found on bars 2 to 6, then new chords table will contain 2 entries: [bar 2 timepoint 0 chord C], [bar 4 timepoint 0 chord Am].

In block 70C, write SNT file to storage means. Tables provided in User Config File 106 are copied to the SNT file.

**End of Method**

Method 710: Create Bars and Compute Bar and Timepoint for Time Signature Events

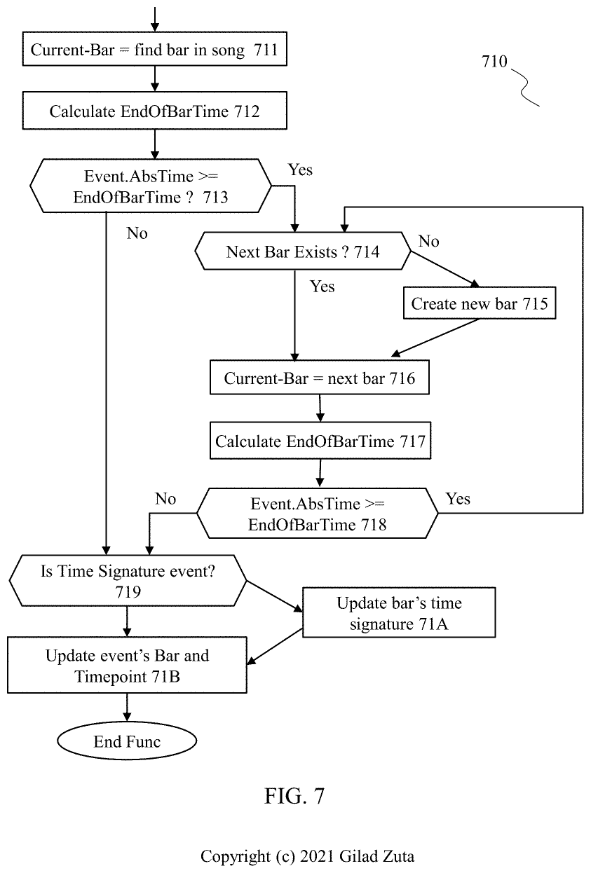

FIG. 7 shows a flow chart of creating bars based on the Time Signature events method. This method details the blocks 705 and 706 shown in FIG. 6.

This method receives an event, that contains absolute time field (Event.AbsTime), and computes Bar and Timepoint of the event using that absolute time field. If the event is a Time Signature event, then the method also updates time signature of the bar, in Bars Table.

The method adds bars to Bars Table until the event has a matching bar in the table, then computes the timepoint number for the event, and sets the bar and timepoint fields of the event. Event has a matching bar means that the value of event's absolute time (Event.AbsTime) is between the bar's start time (Bar.AbsTime) and bar's end time (Bar.AbsTime+Bar.BarTime), this condition can be shown as the following equation:

Bar.AbsTime<=Event.AbsTime<(Bar.AbsTime+Bar.BarTime)

In block 711, set Current-Bar variable to the first bar in the Bars Table that matches the event. This is done by searching for a bar that satisfies the following condition: (Event.AbsTime>=Bar. AbsTime) and (Event.AbsTime<(Bar. AbsTime+Bar.BarTime)).

If not found such a bar, then Current-Bar is set to last bar in Bars Table.

‘Current-Bar’ variable is used to find a bar that matches the current event being checked.

In block 712, Calculate EndOfBarTime. ‘EndOfBarTime’ is a variable that represents the absolute time of the end of the bar. It is calculated in the current embodiment using this formula:

EndOfBarTime=Bar.AbsTime+Bar.BarTime

In block 713, check if event's absolute time is greater or equal to the value of EndOfBarTime variable (minus dTimqepoint for rounding to next bar). If true, then goto block 714. Otherwise, goto block 719.

In block 714, check if next bar exists in current Bars Table of the song. If true then goto block 716, otherwise goto block 715.

In block 715, create a new bar and compute for the new bar, denoted by ‘NewBar’, the following values:

NewBar.AbsTime=Event.AbsTime

NewBar.TS_Num=Current-Bar.TS_Num

NewBar.TS_Denom=Current-Bar.TS_Denom

NewBar.BarTime=4*Header.Division*NewBar.TS_Num/NewBar.TS_Denom

NewBar.Timepoints=32*NewBar.TS_Num/NewBar.TS_Denom

NewBar.dTimepoint=Header.Division/8

Where:
‘NewBar.TS_Num’ is the numerator of the time signature of the bar.
‘NewBar.TS_Denom’ is the denominator of the time signature of the bar
‘NewBar.BarTime’ is the duration of the bar, in clock ticks.
‘NewBar.Timepoints’ is the number of timepoints in the bar.
‘NewBar.dTimepoint’ is number of clock ticks per timepoint.

Add NewBar to current Bars Table of the song.

In block 716, set Current-Bar variable to next bar in Bars Table.

In block 717, calculate updated value for EndOfBarTime variable, in current embodiment this is done using the formula:

EndOfBarTime=Bar.AbsTime+Bar.BarTime

In block 718, check if Event.AbsTime is larger than EndOfBarTime. If yes, then goto block 714. Otherwise goto block 719.

In block 719, check if the event is a time signature event. The event is the input parameter to the function. If yes, goto block 71A, otherwise goto block 71B

In block 71A, update the current bar with the Time Signature event event's data:

Current-Bar.TS_Num=Event.TimeSig.Num

Current-Bar.TS_Denom=Event.TimeSig.Denom

Current-Bar.BarTime=4*Header.Division*Current-Bar.TS_Num/Current-Bar.TS_Denom

Current-Bar.Timepoints=32*Current-Bar.TS_Num/Current-Bar.TS_Denom

Current-Bar.dTimepoint=Header.Division/8

Where:
Event.TimeSig.Num is the numerator value of the time signature event.
Event.TimeSig.Denum is the denominator value of the time signature event.

In block 71B, Input Module 10 updates event's bar number and timepoint using:

Event.BarNum=CurrentBarNum

Event.RelTime=Event.AbsTime−Bar.AbsTime

Event.Timepoint=(U16)(Event.RelTime/Bar.dTimepoint)

‘CurrentBarNum’ is the index of current Bar variable in Bars Table (that the system advanced in step 716). RelTime′ is the relative time of the event inside the bar. ‘Timepoint’ is relative time divided by time per timepoint.

**End of Method**

The above equations are one embodiment for converting MIDI to SNT, other similar calculations are possible.

Part 1: Analyzing Songs

Benefits of Analyzing Songs

Analyzing songs means computing note properties for notes. Notes properties contain Note-Type and Note-Chord-Distances.

Benefits of analyzing songs include, among others:
It provides additional information on notes. This can help composers to understand and to gain new insights about composed songs.

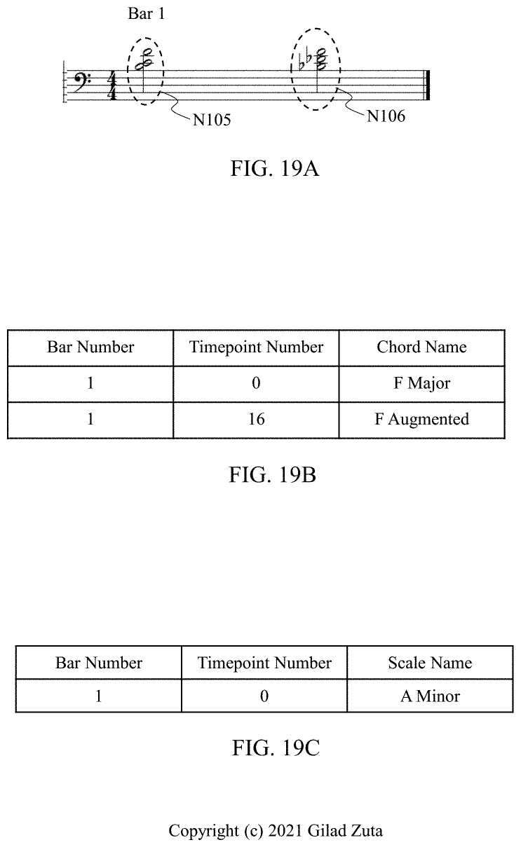

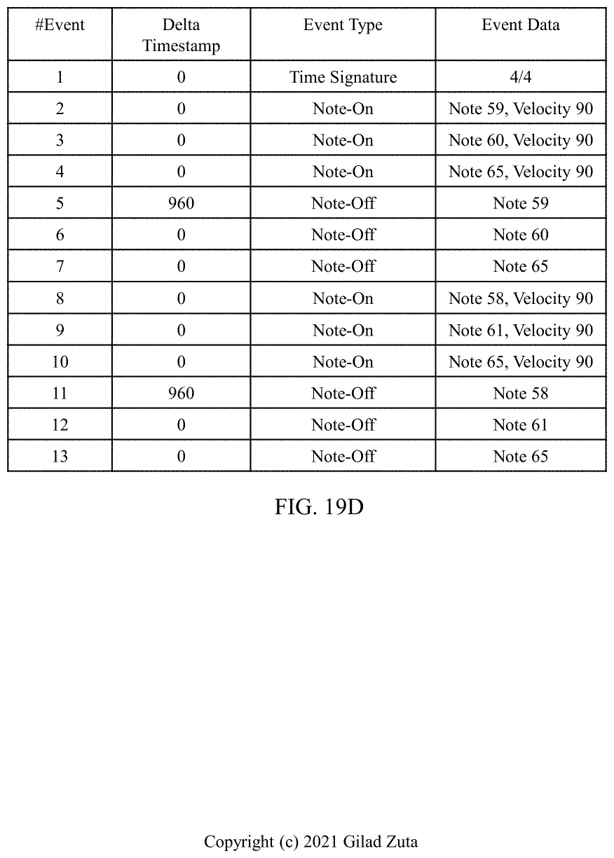

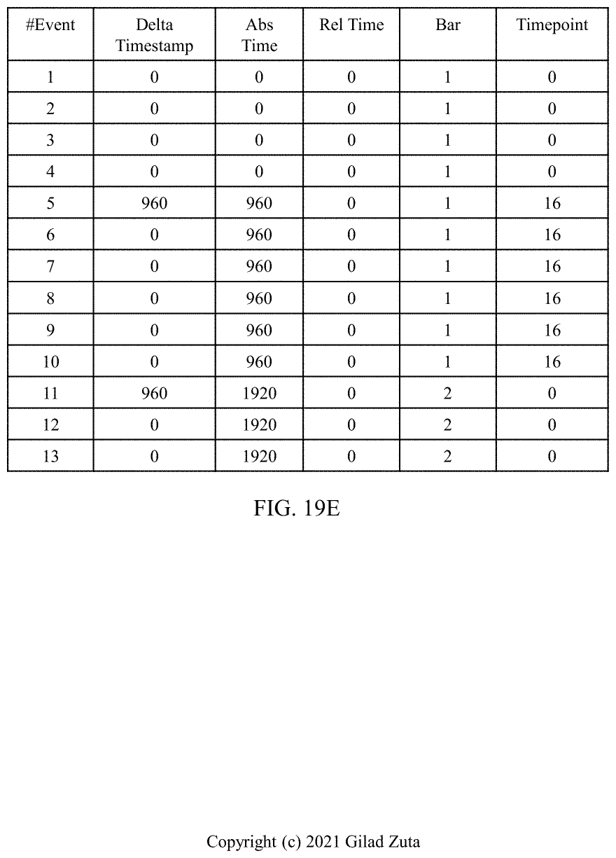

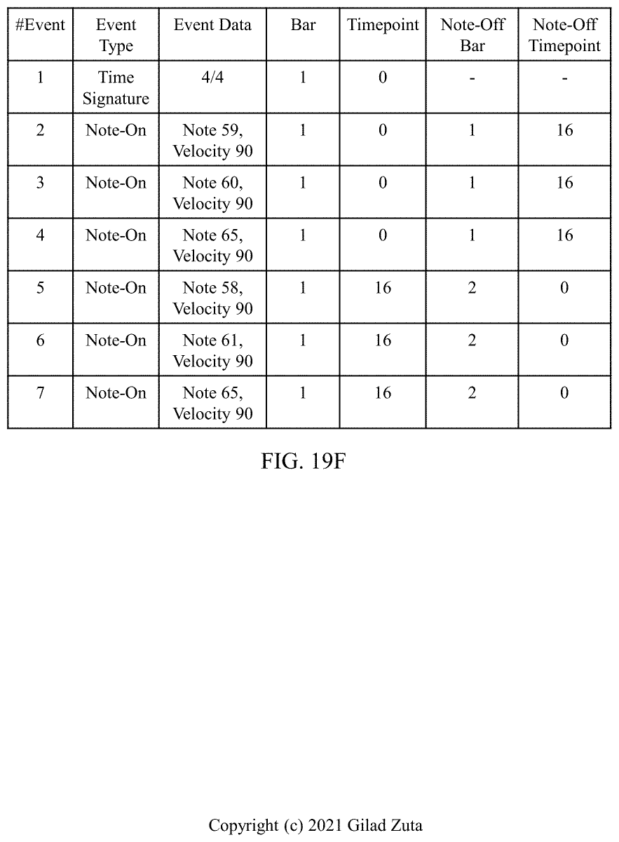

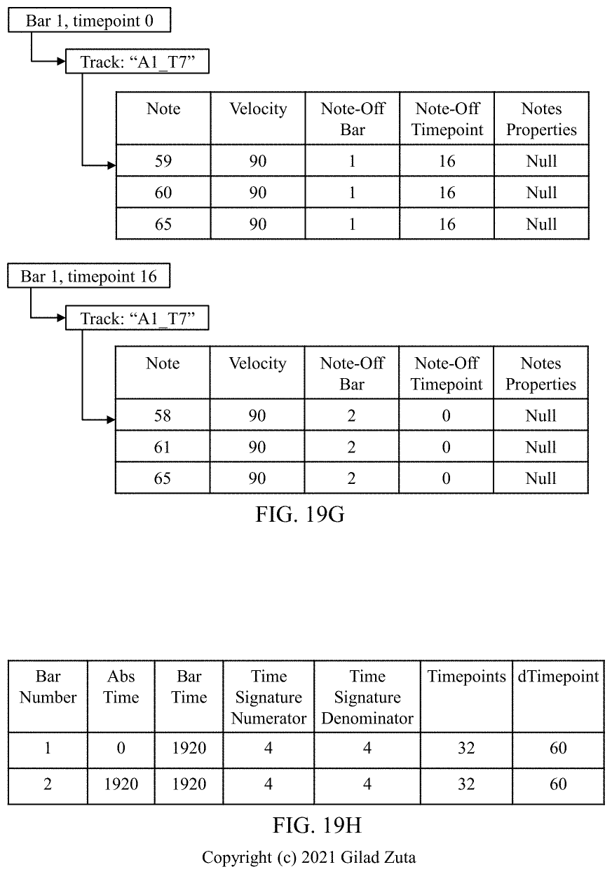

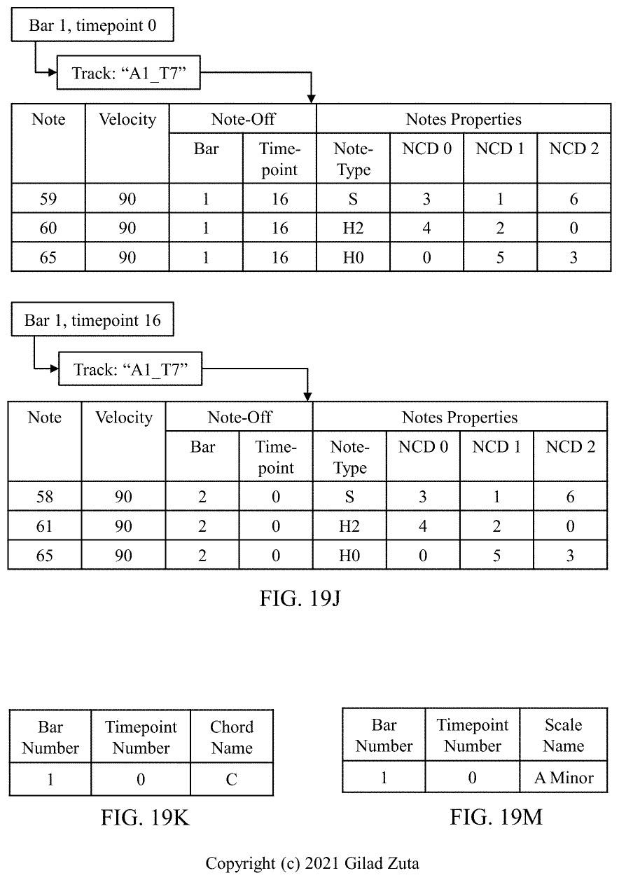

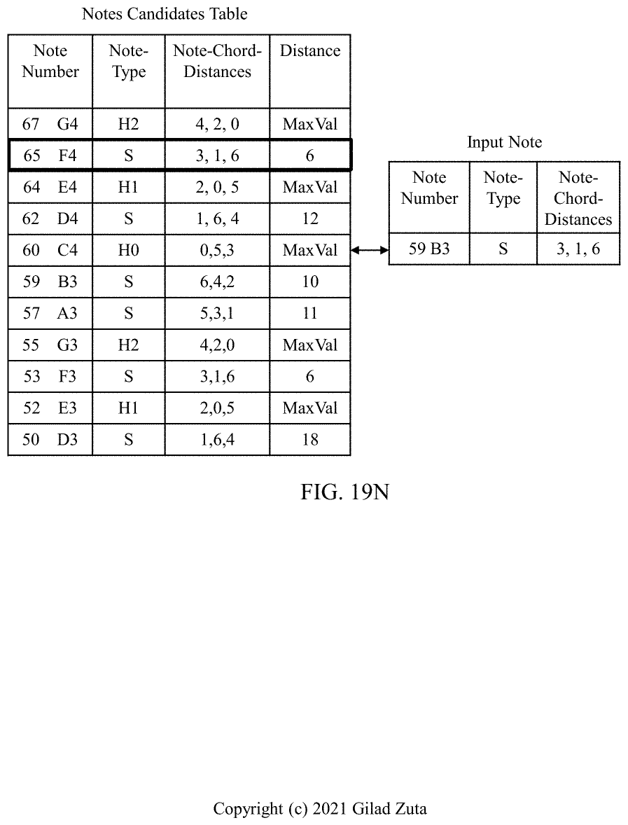

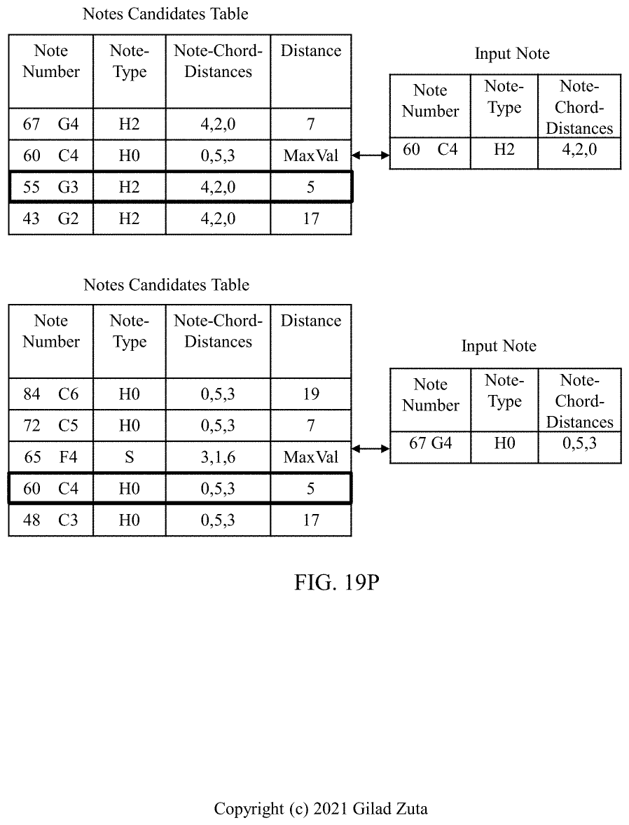

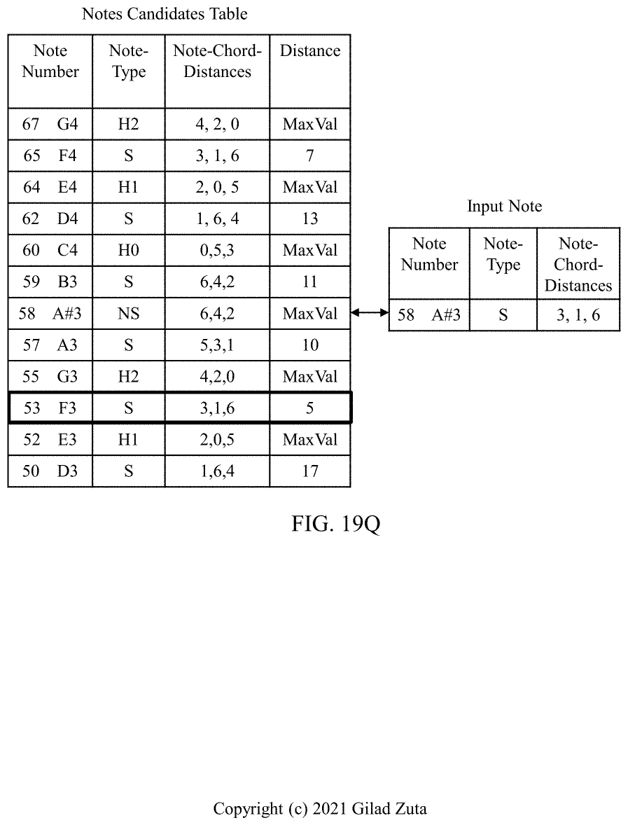

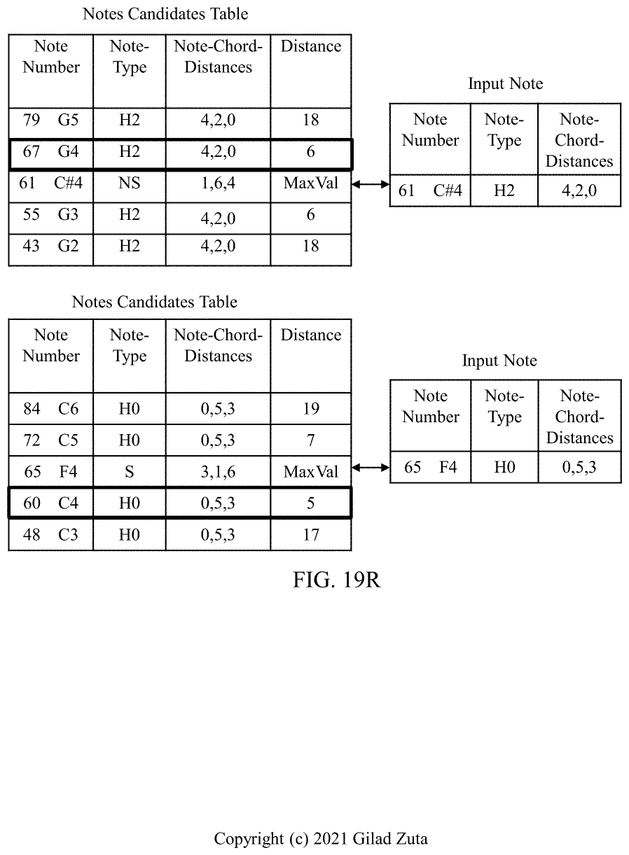

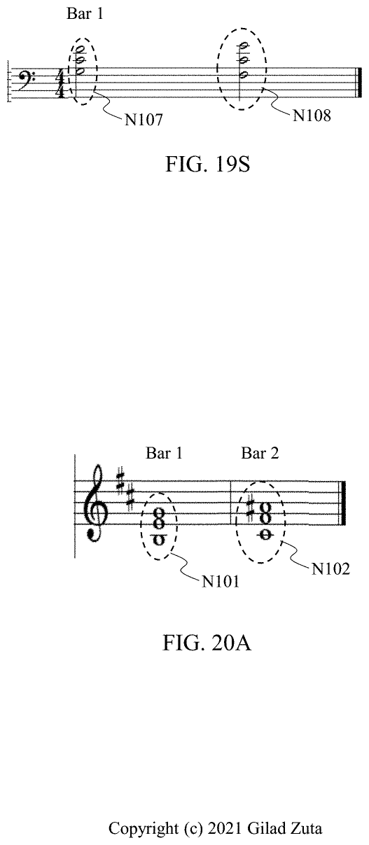

For example, given a song that contain notes numbered 59, 60, 65 in timepoint 0, and 58, 61, 6 in timepoint 16, as shown in FIG. 19D. The notes numbers in their absolute value do not provide any meaningful information for understanding the song. By computing note properties, as shown in FIG. 19J, one can find a pattern in the song: Note 59 has ‘Scale’ Note-Type, notes 65 has ‘Harmonic-0’ Note-Type, and note 60 has ‘Harmonic-2’ Note-Type. Notes 58, 61, 65 in timepoint 16 have the same Note-Types: ‘Scale’, ‘Harmonic-0’ and ‘Harmonic-2’. This gives indication for a possible repeating pattern in the track.
It provides additional information on note, that can be used to transform songs to new chords and/or new scales. Note properties are used for transforming songs (Method 210) and creating new songs (Method 230).
By using notes properties to transform a song, the transform can be customized and controlled for each note being transformed.
Note properties can provide a better visualization when displaying notes, for a better understanding of the song.

For example, a musical composition is typically visualized using notes notation using one color, black, for drawing the notes, as shown in FIG. 19A. Using Note-Type property, notes notation can use multiple colors (not shown), such as red for notes with ‘Harmonic’ Note-Type, blue for notes with ‘Scale’ Note-Type, and purple for notes with ‘Non-Scale’ Note-Type.

Novel Properties Assigned to Notes in the New Method

A novel approach in analyzing notes (Method 200) includes computing notes properties. The information that MIDI files provide about notes is each note's number and velocity. Notes properties disclosed in this invention provides new information about the notes, such as: Note-Type and Note-Chord-Distances.

Novelty in note properties (Note-Type and Note-Chord-Distances) includes, among others:

a. Notes properties provide a novel way to relate chords and scales that differs from prior art methods. The novel way is consistent in any chord and scale combination.

b. They provides new information about notes from a few viewpoints. Note-Type indicates if the note belongs to chord notes, scale notes, or non-scale notes. Note-Chord-Distances provide numerical information regarding a relation between the note, the chord and the scale.

c. Note-Type and/or Note-Chord-Distances are the basis for transforming songs according to new chords and scales. They support transforming songs for every chord and scale combination.

Novelty in Note-Type includes, among others:

a. It provides a novel way to denote notes, using the notes of chord and scale.

b. It supports values that are unique per note and values that are shared among several notes.

c. It assigns an indication whether this note belongs to chord notes, scale notes, or non-scale notes. It can further indicate to which chord note, scale note it belongs to.

d. It supports any chord and scale combination.

Novelty in Note-Chord-Distances includes, among others:

a. It provides a numerical metric that measures distance of notes from chord notes, using scale notes.

For each note, distances are computed using the note's chord and scale.

b. Distances to the chord can be single-dimensional or multi-dimensional. Single-dimensional is achieved by computing a distance for one note of the chord. Multi-dimensional is achieved by computing a distance for multiple notes of the chord.

c. Distances count only scales notes as part of the distance.

d. Distances are computed in a circular way, using modulo 12 math operation.

Further novelty features will become apparent to persons skilled in the art, upon reading the present disclosure and the related drawings.

Notes Properties—a Novel Way to Relate Between Notes, Chords and Scales

The new method provides a novel way to relate between notes, chords and scales. This is done using Note-Type and Note-Chord-Distances.
Note-Type:

In the new method, Note-Type provides a way to denotes notes, using the current chord and scale. Chord notes are denoted as ‘Harmonic-0’, ‘Harmonic-1’ and ‘Harmonic-2’, or ‘Harmonic’. Scale notes, that are not chord notes, are denoted as ‘Scale-0’, ‘Scale-1’, ‘Scale-2’ and so on, or ‘Scale-’.
Note-Chord-Distances:

In the new method, Note-Chord-Distances provides a numerical metric that measures distance of notes from chord notes, using scale notes. Note-Chord-Distances are used as a metric for the relation between the note, the chord and the scale.

Note-Type and/or Note-Chord-Distances are used as the basis for transforming notes of a musical composition according to a new set of chords and scales.

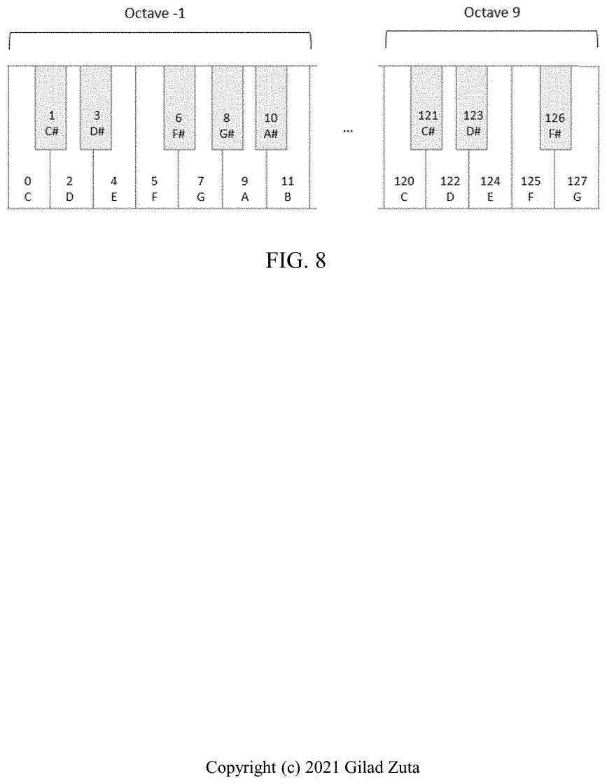

FIG. 8 shows musical notes on a keyboard, that visualizes all the possible MIDI notes that can be played. There are 128 possible notes in MIDI. These notes are numbered from 0 to 127, on 11 octave sets, numbered from −1 to 9, and denoted as “Octave-Number”. Octave-Number is a number for a set of consecutive notes that reside in the range of an octave, starting from note ‘C’ in ascending order, ascending referring to the note number and the tone of the note. The notes of any track, instrument and channel can be represented on this keyboard.

For example: Notes “0 C” and “7 G”, are part of the notes of Octave-Number −1.

Referring to FIG. 8, terms that are being used throughout the present disclosure:

a. Notes are denoted using note number and note name. Specifying the Octave-Number is optional and can be added to note's name. For example, note ‘B’ on Octave-Number 3, its number is 59, the note can be denoted as note ‘59 B’. An equivalent notation, by adding Octave-Number, is note ‘59 B3’.

b. The terms “note's number” and “note's value” are equivalent and are used interchangeably throughout the present disclosure. They represent the number of the note as visualized on the keyboard in this figure. For example, note “7 G” (note ‘G’ on Octave-Number −1), its note number, or its note value, is 7.

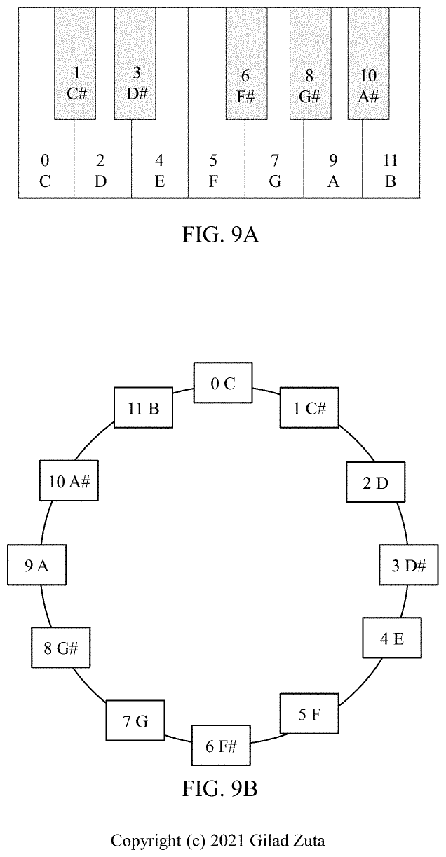

FIG. 9A shows notes on an octave of notes modulo 12 (“Mod-12-Octave”). By taking the notes as visualized on the keyboard of FIG. 8 and doing a modulo 12 math operation, we map all the possible notes onto a single octave of 12 possible notes. For example, this method maps all ‘C’ notes, such as note 0 (‘C’ of Octave-Number-1), and note 120 (‘C’ of Octave-Number 9) into the same note 0 (‘C’ of the Mod-12-Octave).

FIG. 9B shows a new, enumerated circle of octave notes, which is a modification of the Notes Circle. By taking the notes of the mod 12 octave shown in FIG. 9A and arranging them in a circular way, we create the circular octave notes.

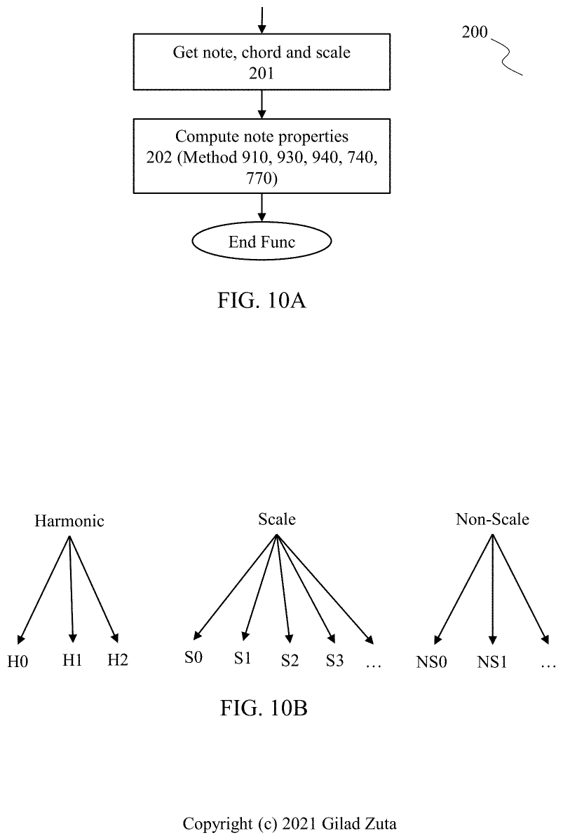

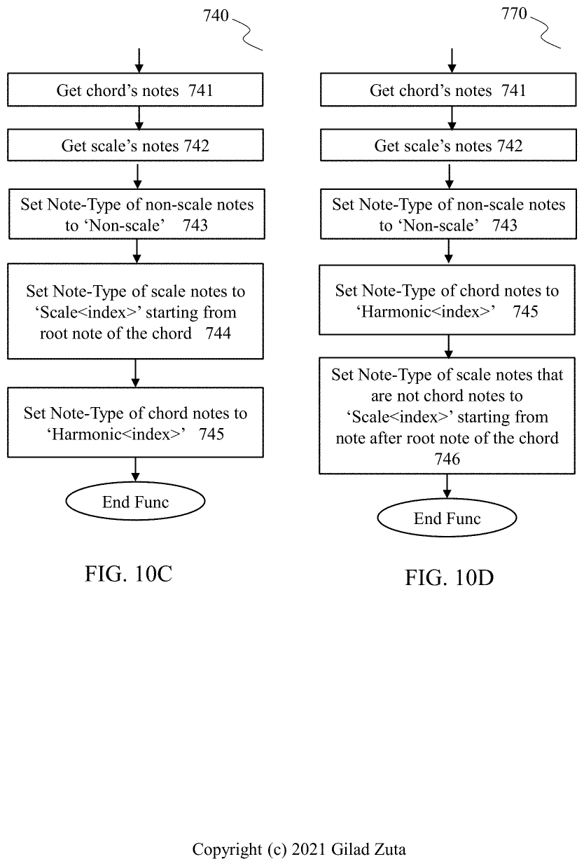

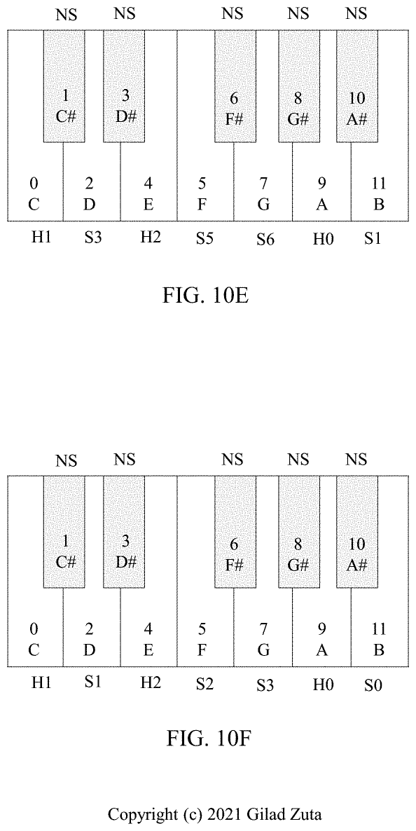

FIG. 10A shows a flow chart of a method for analyzing a note. Analyzing a note is done by getting a note, chord and scale, and computing note properties for the note using the chord and scale. Note properties include one or more of the following:
1) One or more Note-Chord-Distances.
2) Note-Type.

Note-Chord-Distance-0 (“NCD-0”), Note-Chord-Distance-1 (“NCD-1”), Note-Chord-Distance-2 (“NCD-2”), are a new metric that measures the numerical distance between a specific note and the notes of the current chord. This distance is the basis for doing song transforms, as discussed elsewhere in the present disclosure.

Method for Analyzing Notes in a Musical Composition

A method for analyzing one or more notes in a musical composition, comprises, for each note:
a. getting a note's value, chord and scale; and
b. computing note properties using the note's value, chord and scale.

The note properties may include one or more of the following:
1) one or more note-chord distances, comprising a distance to the root note of the chord and optionally distances to the other notes of the chord;
2) note type, wherein the note type can be either shared with other notes or unique for the note, wherein the shared note type can be either harmonic, scale or non-scale, and wherein the unique note type can be either harmonic-0, harmonic-1, harmonic-2 or scale-0, scale-1, scale-2, scale-3, scale-4, scale-5, scale-6, scale-7, scale-8 or scale-9.

**End of method**

Method 200: Analyze Note

The method includes, see FIG. 10A:

In block 201, get note, chord and scale. Note is the note to which notes properties are to be computed. Chord is the chord to be used to analyze the notes. Scale is the scale to be used to analyze the note.

In block 202, compute note properties. Note properties are computed using the note, chord and scale. Note properties include Note-Type and/or one or more Note-Chord-Distances. Note-Type gives an indication whether the note belongs to chord notes, scale notes, or neither of them. There are various options for denoting notes using Note-Type, as illustrated in FIG. 10B. Note-Chord-Distances are the numerical distances between the note to one or more of the notes of the chord,

**End of Method**

In one embodiment which uses SNT files, SNT-Note event contains Bar and Timepoint for each note, as shown in FIG. 5D. Chords and scales of the note can be found using by searching the Bar and Timepoint in Chords and Scales tables, that are shown in FIGS. 4F and 4G.

Regarding computing note properties in block 202:

One embodiment of computing Note-Type is Method 740, that is detailed in FIG. 10C. This method shows a first implementation of determining Note-Type.

Another embodiment of computing Note-Type is Method 770, that is detailed in FIG. 10D. This method shows a second implementation of determining Note-Type.

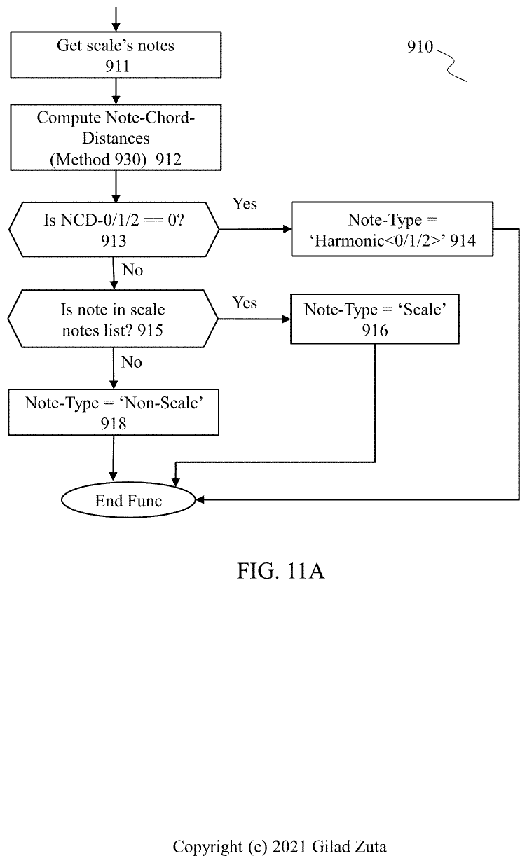

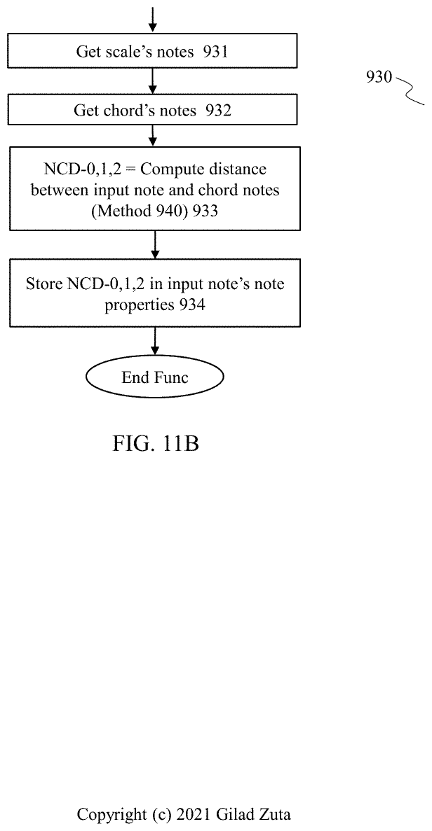

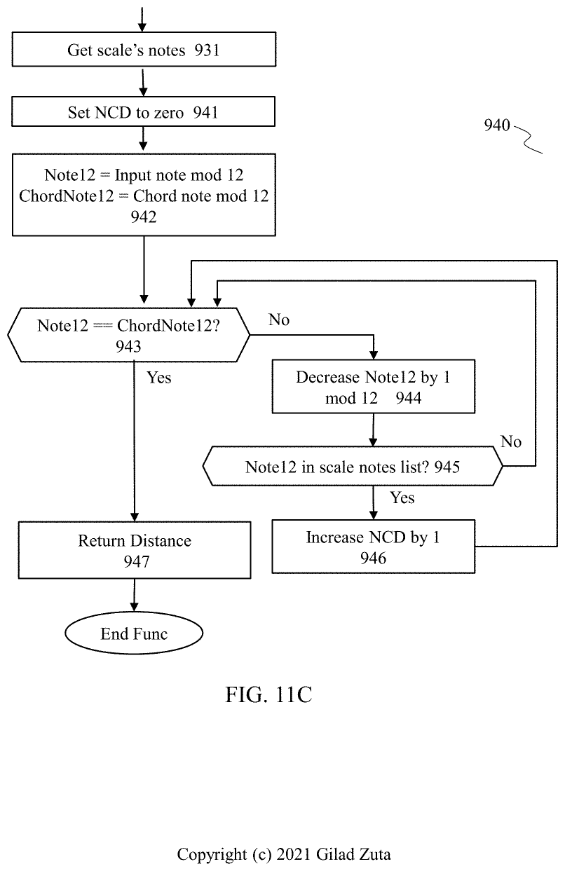

Another embodiment of computing one Note-Chord-Distance is Method 940, that is detailed in FIG. 11C.

Another embodiment of computing all Note-Chord-Distances, without Note-Type, is Method 930, see FIG. 11B. This method uses Method 940 for computing three Note-Chord-Distances.

Another embodiment of computing Note-Type and Note-Chord-Distances is Method 910, that is detailed in FIG. 11A. This method shows a third implementation of determining Note-Type, and also computes Note-Chord-Distances. This method uses Method 930 and Method 940.

In Another embodiment, when computing Note-Type find Note-Type for scales that have a different set of notes when a notes sequence is ascending as opposed to when the sequence descending. In this embodiment, finding Note-Type is done using the following steps:
1) Comparing previous note type to the current note type to find the direction of a notes sequence.
2) If the notes sequence is ascending, then check if note is part of the scale's set of notes for ascending sequence. If yes then it is ‘Scale’ Note-Type, otherwise s it ‘Non-Scale’ Note-Type.
3) Otherwise, check if note is part of the scale's set of notes for descending sequence. If yes, then it is ‘Scale’ Note-Type; otherwise, it is ‘Non-Scale’ Note-Type.

FIG. 10B shows Note-Type possible values.

Note-Type possible values are ‘Harmonic’, ‘Scale’ ‘Non-scale’. ‘harmonic-0, harmonic-1, harmonic-2’, ‘scale-0, scale-1, scale-2, scale-3, scale-4, scale-5, scale-6, Scale-7, Scale-8 or scale-9’.
Typically, ‘Scale-8’ and ‘Scale-9’ values are not being used. If the scale is the chromatic scale, where all notes are being used for the scale, then ‘Scale-8’ and ‘Scale-9’ values are also possible.
‘Harmonic’, ‘Scale’ or ‘Non-scale’: Are values that are shared among several notes.
‘harmonic-0, harmonic-1, harmonic-2’, ‘scale-0, scale-1, scale-2, scale-3, scale-4, scale-5, scale-6 or scale-7’: Are values that are unique per note.

Notes:
The terms harmonic-0, harmonic-1, harmonic-2 may be referred to as “Harmonic-0, 1, 2”.
The terms scale-0, scale-1, scale-2, scale-3, scale-4, scale-5, scale-6, scale-7, scale-8 or scale-9 may be referred to as “Scale-0, 1, 2, 3, 4, 5, 6, 7, 8, 9”.
Note-Type values can be unique per note by using: ‘Harmonic-0, 1, 2’ or ‘Scale-0, 1, 2, 3, 4, 5, 6, 7, 8, 9’ values.

‘Harmonic-0’ (“H0”) is the first note of the chord, or the root note. ‘Harmonic-1’ (“H1”) is the second note of the chord. ‘Harmonic-2’ (“H2”) is the third note of the chord.

If the note is not a chord note, but is a scale note, then it gets “Scale<index>” value (“S<index>”), as in “S0”, “S1”, “S2” and so on. Any numbering for the index is possible, typically it starts from chord's root note. For example, one embodiment is to number them in increasing index every scale note, starting from chord root note. Another embodiment is to increase index every scale or root note, starting from root note.

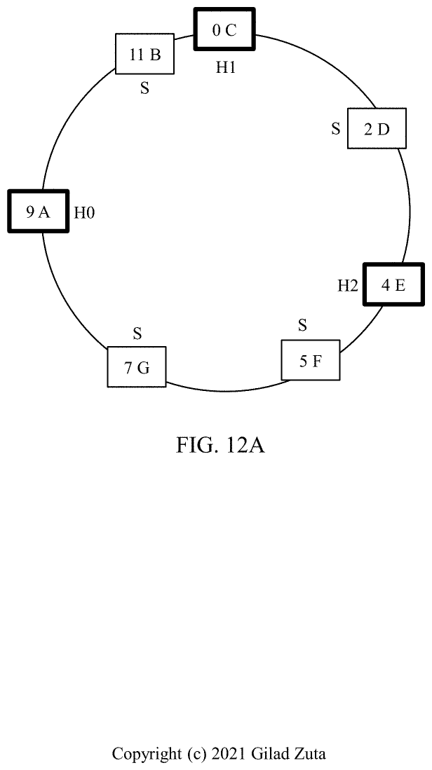

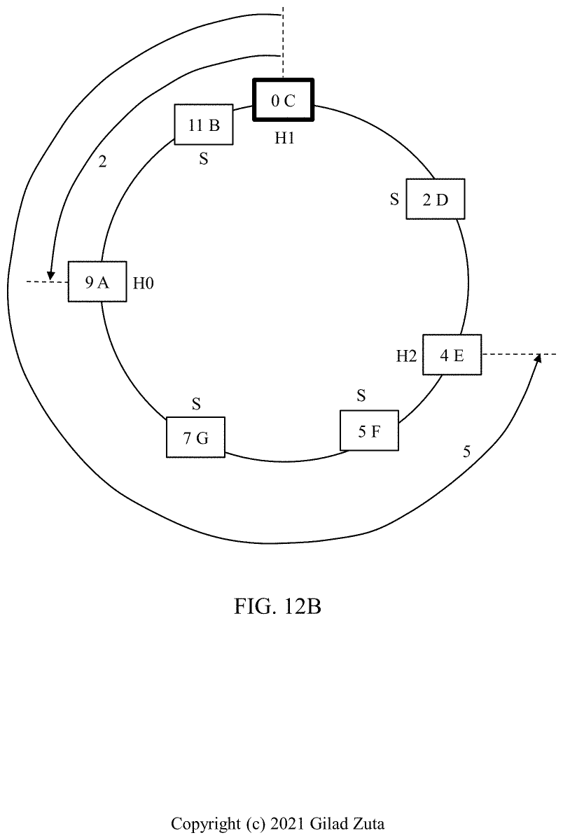

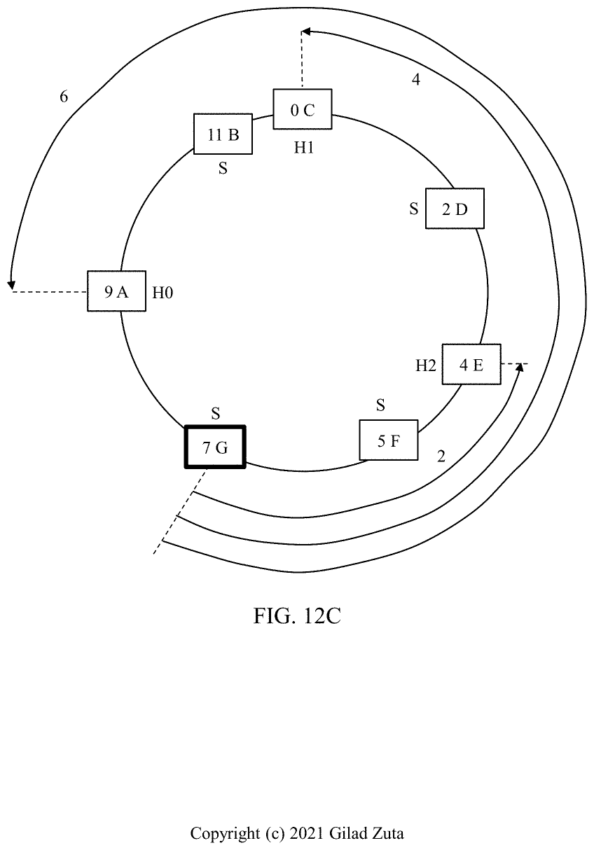

This is illustrated in FIGS. 12C-12D.

In another embodiment, ‘Non-scale’ notes can also be denoted using index, as “Non-scale<index>” value (“NS<index>”).
Note-Type values can be shared among several notes by using: ‘Harmonic’, ‘Scale’ or ‘Non-scale’ values.

‘Harmonic’ represents any note of the chord. ‘Harmonic’ means that the note equals to one of the notes of the chord. It does not matter if the notes are part of the scale or not.

‘Scale’ represents any note of the scale that is not chord note. ‘Scale’ means the note equals to one of the notes of the scale, but not to one of notes of the chord.

‘Non-scale’ represents any note that is not part of the scale notes nor of the chord notes. ‘Non-scale’ means it is neither note of the chord nor of the scale.

The system supports both unique and shared Note-Type values. They can be used together and interchangeably depending on user preferences, implementation and desired result.

For example, methods 740 and 770 are implementations that determine Note-Type using the unique note values. Method 910 determines Note-Type using both unique note values for chord notes and shared values for scale notes that are not part of the chord.

Note-Type values influence on transforming of songs, as detailed elsewhere in the present disclosure.

In another embodiment, users are allowed to edit and choose between interchangeable notes properties, such as choosing between “Harmonic-0, 1, 2” and “Harmonic”, to influence the transforming of songs.

Method 740: Determining Note-Type Values—Version 1

FIG. 10C is a flow chart of a method of a first implementation for determining Note-Type values.

Input parameters for the method are: Input note, chord and scale.

In block 741, get chord's notes. For example, if current chord is ‘A minor’ then its notes are ‘A’, ‘C’ and ‘E’. Typically, this gets the first three chord notes. If the chord has more than three notes, such as G7 that has four notes, then only the first three notes are taken for calculating distances.

In block 742, get scale's notes. For example, if scale is ‘A minor’ then its notes are: ‘A’, ‘B’, ‘C’, ‘D’, ‘E’, ‘F’, ‘G’, or in their numbered representation: 9, 11, 0, 2, 4, 5, 7.

In block 743, set Note-Type of non-scale notes to ‘Non-scale’.

In block 744, Set Note-Type of scale notes to ‘Scale<index>’ starting from root note of the chord. ‘index’ is an increasing index starting from 0. Scale notes are set to values: ‘Scale-0’, ‘Scale-1’ and so on.

In block 745, Set Note-Type of chord notes to ‘Harmonic<index>’. ‘index’ is an increasing index starting from 0. Chord notes are set to values ‘Harmonic-0’, ‘Harmonic-1’, ‘Harmonic-2’. If a note was set to other Note-Type, then it is overridden.

**End of Method**

When a chord is a major or minor triad and all notes of the chord are part of the scale, then the Note-Type values starting from root note of the chord are: ‘H0’, ‘S1’, ‘H1’, ‘S3’, ‘H2’, ‘S5’, ‘S6’.

This is illustrated in FIG. 10E.

Method 770: Determining Note-Type Values—Version 2

FIG. 10D is a flow chart of a method of a second implementation for determining Note-Type values. Blocks 741-745 are the same as in method 740, described with reference to FIG. 10C. Parameters for the method are: Input note, chord and scale.

In block 746, set Note-Type of scale notes that are not chord notes to ‘Scale<index>’ starting from note after root note of the chord. ‘index’ is an increasing index starting from 0. Scale notes are set to values: ‘Scale-0’, ‘Scale-1’ and so on.

**End of Method**

When a chord is a major or minor triad and all notes of the chord are part of the scale, then the Note-Type values starting from root note of the chord are: ‘H0’, ‘S0’, ‘H1’, ‘S1’, ‘H2’, ‘S2’, ‘S3’. This is illustrated in FIG. 10F.

FIG. 10E illustrates an example of Note-Types values using method 740, when scale is ‘C major’ and chord is ‘A minor’. Scale notes are ‘C’, ‘D’, ‘E’, ‘F’, ‘G’, ‘A’, ‘B’. Chord notes are ‘A’, ‘C’, ‘E’, root note of the chord is ‘A’.
Note-Type of non-scale notes, such as notes ‘1 C #’ and ‘3 D #’, is set to ‘Non-scale’ (‘NS’).
Starting from chord's root note, giving numbers to scale notes: Note-Type of note ‘9 A’ is ‘Scale-0’ (‘S0’), Note-Type of note ‘11 B’ is ‘Scale-1’ (‘S1’), Note-Type of note ‘0 C’ is ‘Scale-2’ (‘S2’) and so on until Note-Type of ‘7 G’ that is ‘Scale-6’.
Chord notes override the Note-Type, therefore Note-Type of ‘9 A’ is ‘Harmonic-0’ (‘H0’), Note-Type of ‘0 C’ is ‘H1’, Note-Type of ‘4 E’ is ‘H2’.

The resulting Note-Type for every note is shown in the figure.

FIG. 10F illustrates an example of Note-Types values using Method 770, when the scale is ‘C major’ and chord is ‘A minor’. Scale notes are ‘C’, ‘D’, ‘E’, ‘F’, ‘G’, ‘A’, ‘B’. Chord notes are ‘A’, ‘C’, ‘E’, root note is ‘A’.
Note-Type of non-scale notes, such as notes ‘1 C #’ and ‘3 D #’, is set to ‘Non-scale’ (‘NS’).
Chord notes override previous Note-Type values, setting Note-Type of note ‘9 A’ is ‘Harmonic-0’ (‘H0’), Note-Type of note ‘0 C’ is ‘H1’, Note-Type of note ‘4 E’ is ‘H2’.
Starting from the note after root note, giving numbers for scale notes that are not chord notes: Note-Type of note ‘11 B’ is ‘S0’, Note-Type of note ‘2 D’ is ‘S1’, Note-Type of note ‘5 F’ is ‘S2’ and Note-Type of ‘7 G’ is ‘S3’.

The resulting Note-Type for every note is shown in the figure.

Method 910: Compute Note's Properties

FIG. 11A shows a flow chart of a method for computing a specific note's properties (Note-Type and Note-Chord-Distances). Note-Chord-Distances include NCD-0, NCD-1 and NCD-2.

Parameters for the method are: Input note, chord and scale.

In block 911, get scale's notes. This can be getting scale's notes from scale's name. For example, if name of the scale is ‘A minor’ then its notes are: ‘A’, ‘B’, C′, ‘D’, ‘E’, ‘F’, ‘G’.

In block 912, compute Note-Chord-Distances, as detailed in Method 930. For example, Note-Chord-Distances of a note can be {4, 2, 0},

In block 913, check if one of note's chord distances, that were computed in block 912, equals zero. In one of note's chord distances, NCD-0, NCD-1 or NCD-2 equals zero then goto block 914, otherwise goto block 915.

In block 914, set Note-Type to ‘Harmonic-0/1/2’. If NCD-0 equals zero, then set Note-Type to ‘Harmonic-0’. If NCD-1 equals zero, then set Note-Type to ‘Harmonic-1’. If NCD-2 equals zero, then set Note-Type to ‘Harmonic-2’. For example, if Note-Chord-Distances of a note are {4, 2, 0}, the third Note-Chord-Distance (NCD-2) is 0 therefore Note-Type will be ‘Harmonic-2’.

In another embodiment, Note-Type is set to ‘Harmonic’ value regardless of which of the Note-Chord-Distance equals zero. ‘Harmonic’ is a shared Note-Type value of the chord notes.

In block 915, check is the note is one of notes of the scale. Scale's notes were received in block 911 If the note if part of the scale's notes, goto block 916, otherwise goto block 918.

In block 916, set Note-Type to ‘Scale’. This indicates that the note is part of the scale's notes, but not of the chord notes.

In another embodiment, Note-Type is set to a unique note value, such as ‘Scale-0, 1, 2, 3, 4, 5, 6, 7’. This can be done, for example, using Method 740 or Method 770.

In block 918, set Note-Type to ‘Non-Scale’.

**End of Method**

In another embodiment, one Note-Chord-Distance is computed instead of three. For example, if NCD-0 is computed, then Method 930 computes only NCD-0 and block 913 checks only value of NCD-0.

In another embodiment, two Note-Chord-Distances are computed instead of three. For example, if NCD-0 and NCD-2 are computed, then Method 930 computes NCD-0 and NCD-2 and block 913 checks only value of NCD-0 and NCD-2.

Method 930: Compute Note-Chord-Distances

FIG. 11B is a flow chart of compute Note-Chord-Distances method.

Parameters for the method are: Input note, chord and scale.

In block 931, get scale's notes. For example, if scale is ‘A minor’ then its notes are: ‘A’, ‘B’, ‘C’, ‘D’, ‘E’, ‘F’, ‘G’, or in their numbered representation: 9, 11, 0, 2, 4, 5, 7.

In block 932, get chord's notes. For example, if chord is ‘A minor’ then its notes are ‘A’, ‘C’ and ‘E’. Typically, the system computes distances to the first three chord notes. If the chord has more than three notes, such as G7 that has four notes, then only the first three notes are taken for calculating distances.

In block 933, compute Note-Chord-Distances (NCD-0, NCD-1 and NCD-2) between input note and chord notes, using Method 940 that is detailed in FIG. 11C. NCD-0, NCD-1 and NCD-2 are computed using method 940 with input note, scale, and first, second and third chord note respectively, as parameters.

In block 934 store Note-Chord-Distances (NCD-0, NCD-1 and NCD-2) values in note properties of the input note.

**End of Method**

Method 940: Compute Distance Between a Note and a Chord Note

FIG. 11C is a flow chart of a method for computing the distance between an input note and a chord note using scale notes.

Parameters for the method are: Input note, chord note and scale.

Input note is the note for which Note-Chord-Distance is to be computed. Chord note is one of the notes of the chord, to which the current Note-Chord-Distance is computed. Input note is the starting point from which the distance measurement begins. Chord note is the end point where the distance measurement ends.

Block 931 is the same as detailed in Method 930.

In block 941, set ‘NCD’ variable to zero. ‘NCD variable will store the computed distance variable, Note-Chord-Distance result.

In block 942, set ‘Note12’ variable to the value of the input note modulo 12.

Set ‘ChordNote12’ variable to the value of the chord note modulo 12.

In block 943, check if value of Note12 variable equals to value of ChordNote12 variable. If yes, goto block 947. Otherwise goto block 944.

In block 944, decrease value of Note12 variable by 1 modulo 12: This can be described using equation:

Note12=(Note12−1)modulo12

In another embodiment, distance can be measured in the opposite direction. This is done by increasing the value of Note12 variable by 1 modulo 12, or as described using equation:

Note12=(Note12+1)modulo12

In block 945, check if Note12 is one of scale's notes. If yes, then goto block 946. Otherwise goto block 943.

In another embodiment, the distance is computed by counting all notes between input note and chord note, instead of counting only scale notes. This can be done by using the chromatic scale, that is adding all notes modulo 12 to scale's notes. This makes the result of checking if Note12 in scale notes list to always be true, therefore always goto block 946 which increases NCD.

In block 946, increase the value of NCD variable by 1, as described in equation:

NCD=NCD+1

In block 947, return the value NCD variable.

**End of Method**

### Example: Computing Note-Chord-Distances

FIGS. 12A to 12D illustrate an example of computing Note-Chord-Distances as detailed in methods 930 and 940.

FIG. 12A shows notes of ‘A minor’ chord and ‘A minor’ scale on notes circle. ‘A minor’ chord's notes are: ‘A’, ‘C’ and ‘E’. The first chord note is ‘9 A’, its Note-Type is ‘H0’ (‘Harmonic-0’). Second chord note is ‘0 C’ its Note-Type is ‘H1’ (‘Harmonic-1’). Third chord note is ‘4 E’, its Note-Type is ‘H2’ (‘Harmonic-2’).

Scale is ‘A minor’. Scale notes that are not chord notes are ‘2 D’, ‘5 F’, ‘7 G’ and ‘11 B’. Their Note-Type is set to ‘S’ (‘Scale’).

FIG. 12B shows an example of computing Note-Chord-Distances for an input note ‘C’, when the scale is ‘A minor’ and chord is ‘A minor’. Input note ‘C’ can be on any Octave-Number, such as note numbered 0, 12, 24 etc., as visualized in FIG. 8. Doing modulo 12 we get note number 0, as shown in FIG. 9A. Note 0, shown in bold in the figure, is the note to which Note-Chord-Distances are to be computed.

The figure illustrates computing Note-Chord-Distances for each chord note by counting scale notes in a counterclockwise direction from the input note to the chord note. NCD-0 is computed between input note ‘0 C’ and the first chord note ‘9 A’ (‘H0’). There are two scale notes in the path (including the chord note): ‘11 B’ and ‘9 A’, therefore NCD-0 distance is 2. NCD-1 is computed between input note ‘0 C’ and the second chord note ‘0 C’ (‘H1’). The notes have the same number, therefore NCD-1 distance is 0.

NCD-2 is computed between input note ‘0 C’ and the third chord note ‘4 E’ (‘H2’). There are five scale notes in the path (including the chord note): ‘11 B’, ‘9 A’, ‘7 G’, ‘5 F’ and ‘4 E’, therefore NCD-2 distance is 5.

While computing the above distances, in the present invention, the notes not belonging to the present scale are ignored. For example, when computing NCD-0 the note ‘10 A #’ is ignore, therefore, the distance is 2 rather than 3 (3 is the result, were one to include all the notes). In another embodiment, all notes are counted which gives the result of NCD-0 equals 3.

In another embodiment, the distances are computed in a clockwise direction.

The resulting Note-Chord-Distances of any input note ‘C’ for this scale and chord are [2, 0, 5]. Since NCD-1 is 0, is the input note will be ‘Harmonic-1’ or ‘Harmonic’ Note-Type.

FIG. 12C shows an example of computing Note-Chord-Distances for an input note ‘G’, when the scale is ‘A minor’ and chord is ‘A minor’. Input note ‘G’ can be on any Octave-Number, such as note numbered 7, 19, 33 etc, as visualized in FIG. 8. Doing modulo 12 we get note number 7, as shown in FIG. 9A. Note 7, shown in bold in the figure, is the note to which Note-Chord-Distances are to be computed.

The figure illustrates computing Note-Chord-Distances for each chord note by counting scale notes in a counterclockwise direction from the note to the chord note. NCD-0 is computed between input note ‘7 G’ and the first chord note ‘9 A’ (‘H0’). There are six scale notes in the path: ‘5 F’, ‘4 E’, ‘2 D’, ‘0 C, ‘11 B’ and ‘9 A’, therefore NCD-0 distance is 6.

NCD-1 is computed between input note ‘7 G’ and the second chord note ‘0 C’ (‘H1’). There are four scale notes in the path: ‘5 F’, ‘4 E’, ‘2 D’ and ‘0 C, therefore NCD-1 distance is 4.

NCD-2 is computed between input note ‘7 G’ and the third chord note ‘4 E’ (‘H2’). There are two scale notes in the path: ‘5 F’ and ‘4 E’, therefore NCD-2 distance is 2.

The resulting Note-Chord-Distances of any input note ‘G’ for this scale and chord are [6, 4, 2]. All Note-Chord-Distances are nonzero, therefore Note-Type is either ‘Scale’ or ‘Scale<index>’ (index is set according to some numbering scheme, such as described in method 740 or 770).

Method 720: Analyze Song

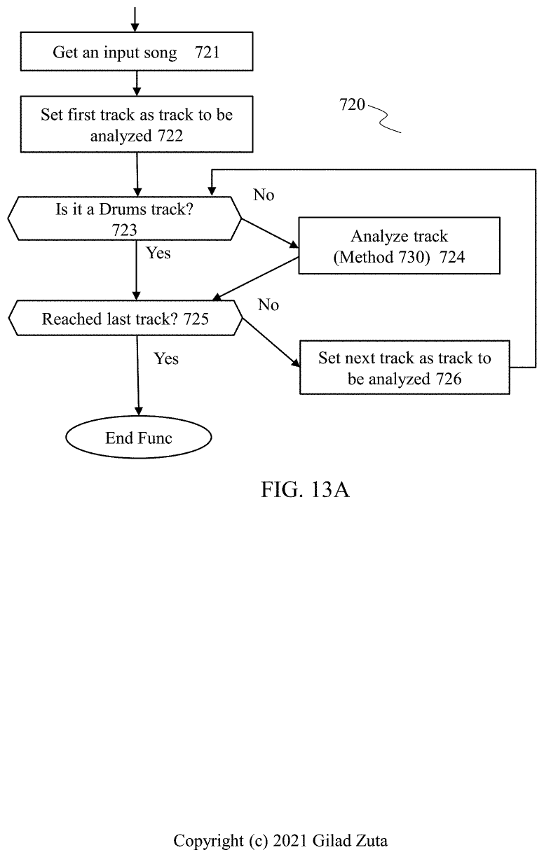

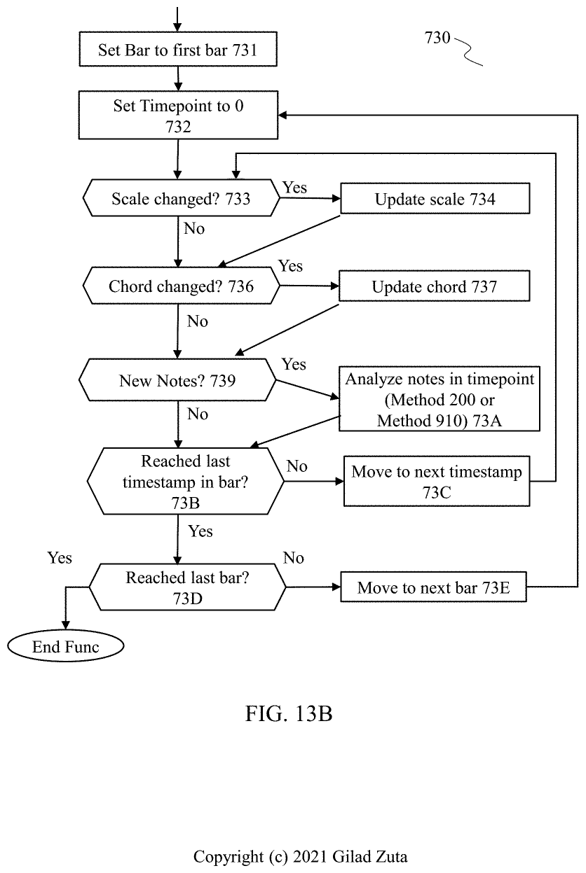

FIG. 13A is a flow chart of a method for analyzing songs. This method gets an input song, such as an SNT File 51, and outputs an analyzed song, such analyzed SNT file 52. Analyzing a song is the process of computing and adding note properties to every note in the song, as shown in FIG. 5D. In MIDI, computing note properties is done for Note-On events.

Input: Input song, chords and scales.

Output: Analyzed song using chords and scales.

In block 721, get an input song, such as an SNT File 51, that contains chords and scales.

In block 722, set first track of song as the track to be analyzed.

In block 723, check if the track is a drums track. If this is a drums track, then do not analyze the track, goto block 725. Otherwise, goto block 724. A drums track is a track that contains notes and controls events of drums. In MIDI it is a track whose channel is set to 10 or 255, or a track that is set to an instrument number larger or equal to 126. Instrument above 126 is a special instrument, such as a ‘Helicopter’ instrument, (numbered 126).

In block 724, analyze the track, as detailed in Method 730.

In block 725, check if reached last track of song. If true method ends, otherwise goto block 726.

In block 726, set next track of song as the track to be analyzed.

**End of Method**

Method 730: Analyze Track

FIG. 13B is a flow chart of a method for analyzing a track. The system keeps track of the current scale and chord. Updating current scale is done using Scales Table, as shown in blocks 733 and 734. Updating the current chord is done using the Chords Table, as shown in blocks 736 and 737.

In block 731, set Bar variable to first bar of Bars Table.

In block 732, set Timepoint variable to 0, this is the first timepoint in a bar. Bar and Timepoint variables represent the current bar and timepoint that is being analyzed.

In block 733, check if scale changed in current Bar and Timepoint. This is done by searching Bar and Timepoint in Scales Table of the song, shown in FIG. 4G. If the scale changed, goto block 734, otherwise goto block 736.

In block 734, update the current scale in a variable in memory.

In block 736, check if chord changed in current Bar and Timepoint. This is done by searching Bar and Timepoint in Chords Table of the song, shown in FIG. 4F. If chord changed, move to block 737, otherwise goto block 739.

In block 737, update current chord in a variable in memory.

In block 739, check if there are new note events that start in current Bar and Timepoint. If true then goto block 73A, otherwise goto block 73B.

In block 73A, analyze the notes in current Bar and Timepoint.

This is done by performing Method 200, or Method 910, for every note in the timepoint that is defined by Bar and Timepoint. In a typical embodiment, this is implemented using Method 910.

In block 73B, check if reached last timepoint of Bar. This is done by comparing the value of Timepoint variable with number of timepoints in Bar. If true then goto block 73D, otherwise goto block 73C.

In block 73C, goto next timepoint of bar. This is done by setting:

Timepoint=Timepoint+1

In block 73D, check if reached last bar of song. This is done checking if Bar variable is the last entry in Bars Table. If true then method ends, otherwise goto block 73E.

In block 73E, move to next bar. This is done by setting:

Bar=Bar+1

Timepoint=0

**End of Method**

Part 2: Transforming Songs

Transforming a song is a novel way to creates a new song from an input song. A novel approach in transforming a song (Method 760) includes receiving input notes and their notes properties, receiving new chords and scales, creating new notes using the inputs notes and their notes properties such that the new notes are harmonic with the new chords and scales. Transforming a song comprises transforming the song's notes.

Transforming a song is done by transforming notes of the tracks of the song, except for the drums track. Drum tracks are not analyzed nor transformed, their note events are copied unchanged to the output song.

Control events are not analyzed nor transformed, they are copied unchanged to the output song. The transformed song, which is the output of the present method, comprises the changed notes, together with the control events and the drum tracks, if extant.

Benefits of Transforming Songs

Benefits of Transforming a song include, among others:
It enables to automatically convert a song to any set of new chords and scales.
Users can check, in a fast manner, if modifying chords and/or scales improve their input song.
Users can experiment with different versions of their songs that have modified chords and/or scales.
It enables the creation of new music applications that utilizes the transform, such as creating new songs and adding tracks that accompany an input song. This is shown in Method 230 for example.
It enables re-use of existing songs for new purposes that can benefit both composer that created the songs and users that uses the songs.

Novelty in Transforming Songs

Examples of Novel features in the transform song method:

a. It provides a novel way to convert a song to new chords and/or new scales. It changes notes of a song to be harmonic to new chords and/or new scales.

b. It can transform notes to any chord, any scale, and any chord and scale combination.

c. It supports note properties that include one or more of the following:
1) one or more Note-Chord-Distances.
2) Note-Type.

d. It calculates distances for candidate notes.

e. It uses notes properties and/or notes values for doing distance calculations.

f. It supports a scenario where a song comprises more than one scale.

g. It supports a scenario where transforming is done to a scale with a different number of notes from the original scale of the song.

Method for Transforming Input Notes of a Musical Composition

A method for transforming one or more input notes of a musical composition into one or more new notes comprises, for each input note:
a. getting the input note and its note properties;
b. getting a new chord and a new scale for the input note;
c. generating a list of notes candidates;
d. computing distances between the input note and every note in the list, using input note's value, input note's note properties, candidate note's value and candidate note's note properties;
e. finding the candidate that has the minimal distance;
f. setting a new note value using a note value of the candidate with the minimal distance.

**End of method**

Comments Re the Above Method

1. The list of notes candidates may be generated by selecting all the notes whose values are within a range defined between the value of the input note minus a first offset, and the value of the input note plus a second offset.

2. The list of notes candidates may be generated by selecting all possible notes.

3. The note properties may include one or more of the following:
1) one or more note-chord distances, comprising a distance to the root note of the chord and optionally distances to the other notes of the chord;
2) note type, wherein the note type can be either shared with other notes or unique for the note, wherein the shared note type can be either harmonic, scale or non-scale, and wherein the unique note type can be either harmonic-0, harmonic-1, harmonic-2 or scale-0, scale-1, scale-2, scale-3, scale-4, scale-5, scale-6, scale-7, scale-8 or scale-9.

4. Getting the input note may further include:
a. if the input note is an ongoing note, then:
   1) stopping the ongoing note at the time when the change occurs by changing its length;
   2) creating a new note, of a value equal to that of the ongoing note, starting at the time when the change occurs and a length equal that of the ongoing note before change minus the length of time the ongoing note up to the time of occurrence of the new chord and scale;
   3) setting the new note as the input note for the transform.

5. For each note, compute properties of the note from the note's value, chord and scale. The note properties may include one or more of the following:
1) one or more note-chord distances, comprising a distance to the root note of the chord and optionally distances to the other notes of the chord;
2) note type, wherein the note type can be either shared with other notes or unique for the note, wherein the shared note type can be either harmonic, scale or non-scale, and wherein the unique note type can be either harmonic-0, harmonic-1, harmonic-2 or scale-0, scale-1, scale-2, scale-3, scale-4, scale-5, scale-6, scale-7, scale-8 or scale-9.

6. Computing distances comprises, for each candidate note, computing a distance between the input note and the candidate note is performed by computing either one of:
a. a sum of:
   1) sum of differences, wherein each difference comprises the absolute value of notes chord distances difference;
   2) absolute value of the difference of the notes values;
b. a sum of:
   1) square root of sum of differences squared, wherein each difference comprises the notes chord distances difference;
   2) absolute value of the difference of the notes values;
c. square root on the sum of:
   1) sum of differences squared, wherein each difference comprises the notes chord distances difference;
   2) absolute value of the difference of the notes values; or
d. a sum of:
   1) sum of differences, wherein each difference comprises a weight multiplied by the absolute value of notes chord distances difference;

2) a weight multiplied by the absolute value of the difference of the notes values.

7. Computing distances comprises, for each candidate note, computing a distance between the input note and the candidate note is performed by computing either one of:
a. a sum of:
   1) sum of differences, wherein each difference comprises the absolute value of notes chord distances difference;
   2) scale difference between the notes values, wherein the scale difference is computed by counting scale notes between the notes;
b. a sum of:
   1) square root of sum of differences squared, wherein each difference comprises the notes chord distances difference;
   2) absolute value of the difference of the notes values;
c. square root on the sum of:
   1) sum of differences squared, wherein each difference comprises the notes chord distances difference;
   2) scale difference between the notes values, wherein the scale difference is computed by counting scale notes between the notes; or
d. a sum of:
   1) sum of differences, wherein each difference comprises a weight multiplied by the absolute value of notes chord distances difference;
   2) a weight multiplied by scale difference between the notes values, wherein the scale difference is computed by counting scale notes between the notes.

8. If only part of the note chord distances are available, computing distances comprises, for each candidate note, computing a distance between the input note and the candidate note is performed by computing either one of:
a. absolute differences between the available notes chord distances and note values;
b. root on square of the available notes chord distances differences plus absolute note values difference; or
c. weighted sum on absolute the available notes chord distances differences and note values difference.

Method 750: Analyze and Transform Input Song

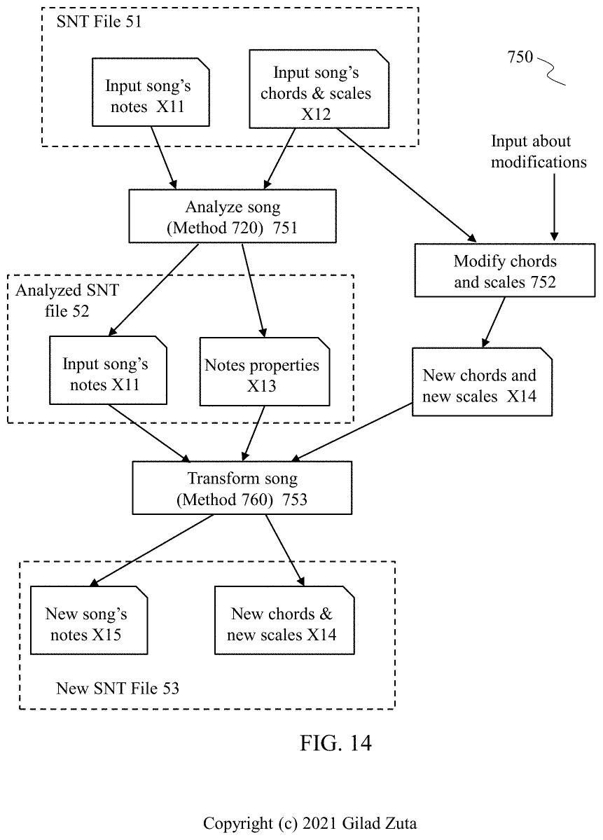

FIG. 14 is a high-level overview of a method for analyzing and transforming an input song.

In block 751, analyze song (details in Method 720), receives an input song, such as SNT File 51 that contains input song's notes (X11) and input song's chord and scales (X12). Analyze song compute notes properties, and outputs an analyzed song, such as Analyzed SNT file 52, that contains the input song's notes (X11) and the computed notes properties for the notes (X13). Analyzing a song uses Method 200 to analyze notes.

In block 752, receive input on how to modify input song's chords and scales. It outputs new chords and/or new scales (X14). Any new chords and scales (X14) can be created, they can be a modified version of the input song's chords and scales (X12) or can replace them altogether.

In block 753, transform song (Method 760) receives an analyzed song such as Analyzed SNT file 52, receives new chords and/or new scales (X14), and outputs a new song, such as SNT File 53. The new song contains new song's notes (X15) and new chords and/or new scales (X14). New song's notes (X15) are created by transforming input song's notes (X11), using notes properties (X13) according to the new chords and/or new scales (X14). Transforming a song uses Method 210 to transform the input song's notes (X11).

**End of Method**

Method 210: Transform a Note

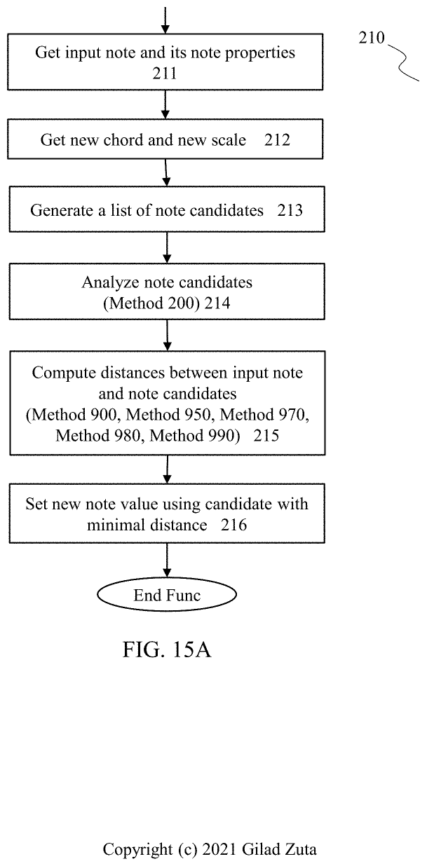

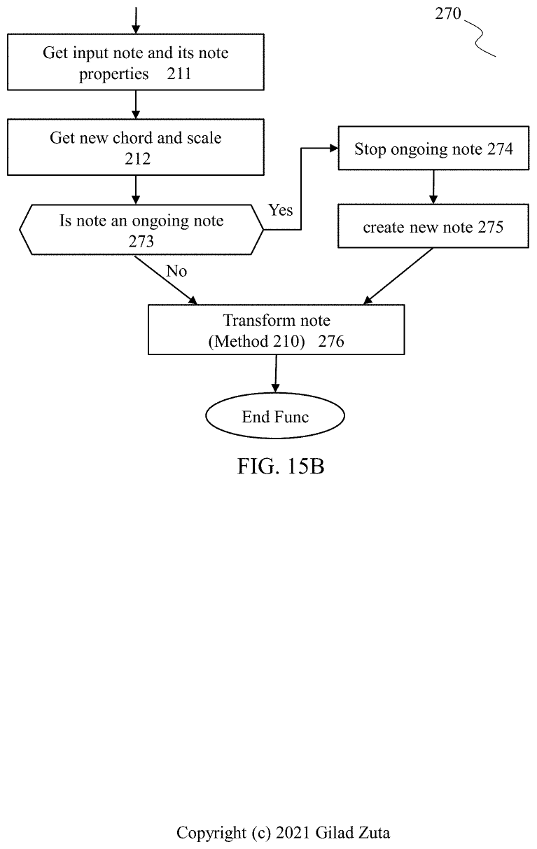

FIG. 15A is a flow chart of a method for transforming an input note to a new note value.

Transforming a note changes its value to be harmonic with new chord and new scale. New chord and scale can be any combination of chord and scale. Applying this method to tracks in songs enables changing the tracks to be harmonics with new chords and/or new scales.

Parameters for the method are: Input note, new chord and new scale.

In block 211, get an input note and its note properties. Note properties of the input note include one or more of the following:
1) one or more Note-Chord-Distances.
2) Note-Type.

Note properties are computed using the original chord and scale of the input note.

In one embodiment, an input note that has ‘Non-scale’ Note-Type is modified to have ‘Scale’ Note-Type, so that Non-scale notes are transformed to scale notes. Benefit of it for example is that scale notes are typically sound better than non-scale notes.

In another embodiment, input note that has ‘Non-scale’ Note-Type remains unchanged, so that non-scale notes are transformed to non-scale notes. Benefit of it for example is that it is keeps the original note's property and that it can give unexpected or surprising results.

In block 212, get new chord and new scale for the output note. New chord can be represented by the chord's name, such as “C major”. New scale can be represented by the scale's name, such as “A minor”. The output note is created from the input note using the new chord and scale.

New chord and new scale can be any chord and scale combination. They can be different or the same as the original input chord and scale of the input note.

In block 213, generate a list of note candidates. How to generate the list of note candidates is configured to the system.

One option is to generate the list of notes candidates by adding notes whose number is within range from the input note's number.

For example, using a range value of 12, given an input note ‘59 B3’, generating the list of note candidates is done by adding all notes whose number is between 47 (59-12) and 71 (59+12), these are the notes between note ‘47 B2’ and note ‘71 B4’.

Another option is to generate the list of note candidates by adding all possible notes, these are notes whose number is between 0 to 127. This means adding the notes between note ‘0 C−1’ and note ‘127 G9’.

In block 214, analyze note candidates, as detailed in Method 200. This computes note properties of the note candidates using the new chord and new scale. Computing note properties is done for every note candidate in the list, using the new chord and new scale.

In one embodiment, note properties of the candidate note includes Note-Chord-Distances and/or Note-Type in accordance with the note properties of the input note. This means that if the input note has Note-Type available, then Note-Type is computed for the note candidates. If the input note has Note-Chord-Distances available, then Note-Chord-Distances are computed for the note candidates.

In block 215, compute distances between the input note and each of the note candidates in the list.

Computing a distance is done using input note's note number and note properties, candidate note's note number and note properties and optionally the new scale's notes.

Distance is computed using difference between input note's note number and candidate note's note number, and/or differences between input note's note properties and candidate note's note properties. A small distance value means that the notes are more similar to one another, whereas a large distance value means the notes are more dissimilar. Best candidate note is the note that has the minimal distance to the input note.

Embodiments of computing distance between an input note and a candidate note are detailed in Method 900, Method 950, Method 970, Method 980 and Method 990.

In block 216, set the new note's value using the candidate that has the minimal distance. Find the candidate note that has minimal distance to the input note. Set the note value of the candidate note that has the minimal distance as the new note value. The new note value is the output of the method, it is the transformed value of the input note.

If there are more then one note that have the minimal distance, then a note is chosen according to system's configuration:
One option is to choose the first note with minimal distance.
Another option is to choose randomly between the notes with minimal distance.
Another option is to choose the note with minimal distance that has the same direction relating to the preceding transformed note as the input note had relating to its preceding input note, where a note and its preceding note belong to the same track. For example, a preceding input note is ‘4 E’, and current input note is ‘5 F’, the input note is ascending. Preceding transformed note, of input note ‘4 E’ was ‘9 A’, current candidate notes, for input note ‘5 F,’ are ‘7 G’ and ‘11 B’, both have the same minimal distance. Then candidate note ‘11 B’ will be chosen because it is also in ascending direction as was the input note.

**End of Method**

Method 270: Transform Note and/or Ongoing Note

FIG. 15B is a flow chart of a method for transforming an input note that also transforms ongoing notes.

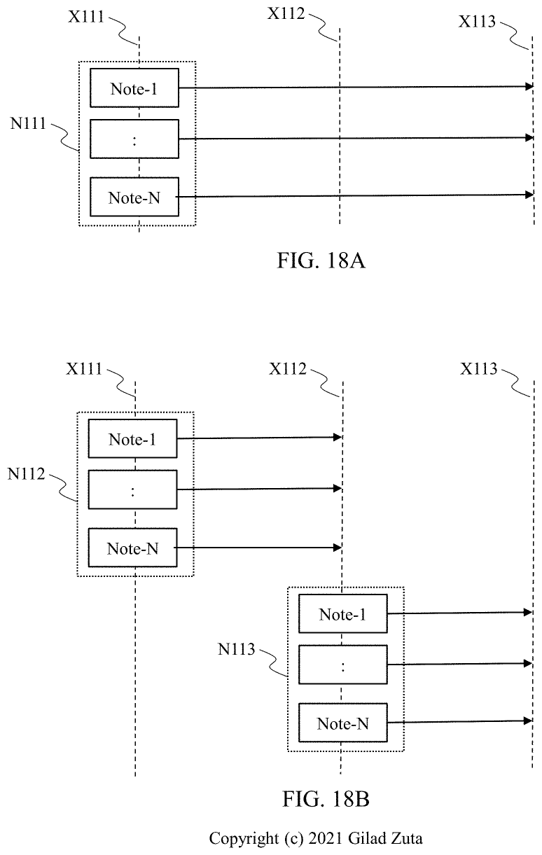

This method is another embodiment of transforming notes that also handles the case of a chord or scale change during an ongoing note. Ongoing notes in a given timepoint are notes that started before the given timepoint, but have not been stopped yet. In MIDI, this means that Note-Off event is received after the given timepoint and Note-On event is received before the given timepoint. Ongoing notes are illustrated in FIG. 18A.

To keep the ongoing note harmonized with the new chord and scale, a new note is created instead of the ongoing note, and transformed to the new chord and scale.

This method runs every time there is a chord change and/or scale change during an ongoing note.

In another embodiment, this method runs every time there is a chord change and/or scale change during an ongoing note, such that the new chord is different than the original input chord, and/or the new scale is different than the original input scale, at that specific time.

Blocks 211-212 are the same as in Method 210.

In block 273, check if the input note is an ongoing note. If it is an ongoing note, goto block 274. Otherwise goto block 276.

In block 274, stop the ongoing input note. This is done by changing the length of the note to end in current timepoint. After this change the input note stops in the current timepoint, therefore it is no longer an ongoing note in this current timepoint.

In block 275, create a new note that replaces the input note. The new note has the same value and properties as the input note, however its starting time is current time (unlike the input note that started before current time). The length of the new note equals that of the ongoing note before change minus the length of time the ongoing note up to the current timepoint. In other words, the new note ends at the time where the input note ended originally (before it was stopped in block 274).

In block 276, transform the input note, as detailed in Method 210.

If the input note was not an ongoing note, then the note to be transformed is the input note received in block 271, If the input note was an ongoing note, then the note to be transformed is the new note created in block 275.

**End of Method**

Method 900: Compute Transform's Distance Using Note-Type and NCDs—Version 1

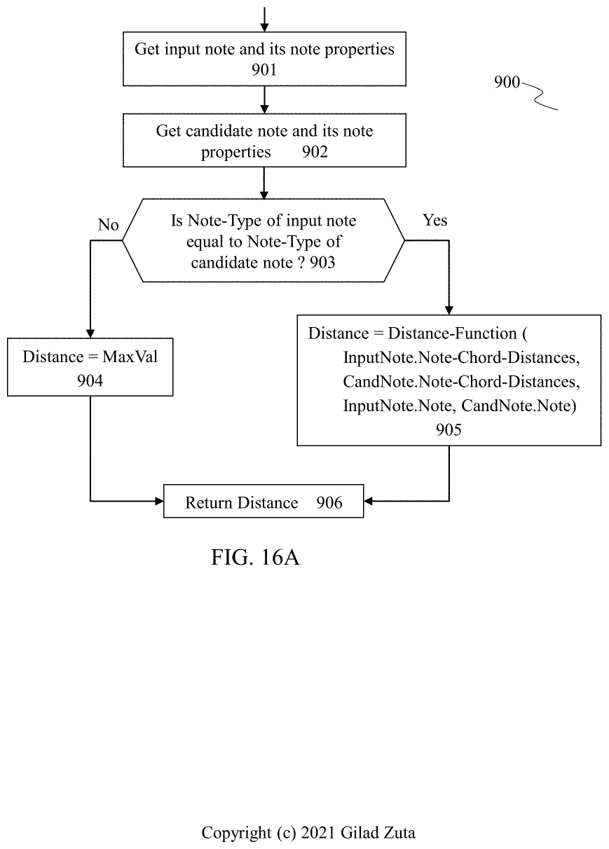

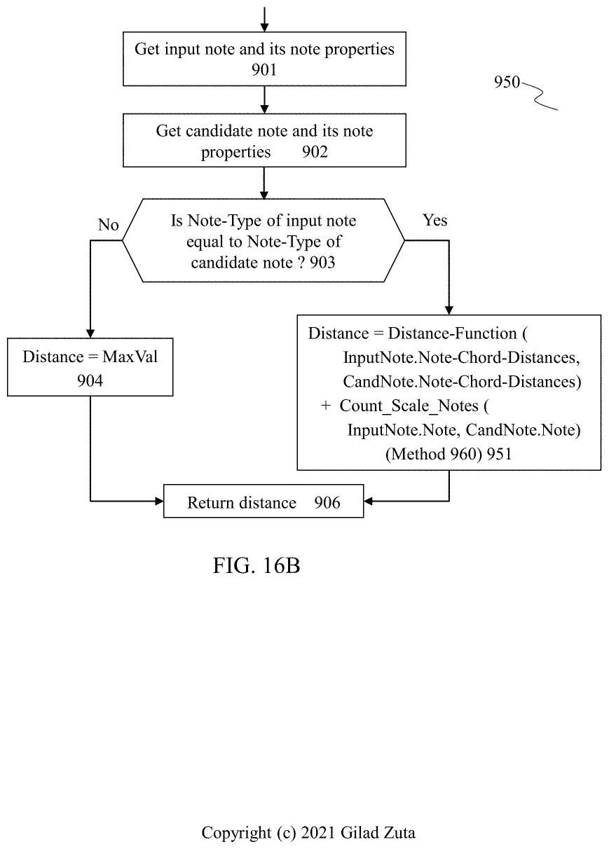

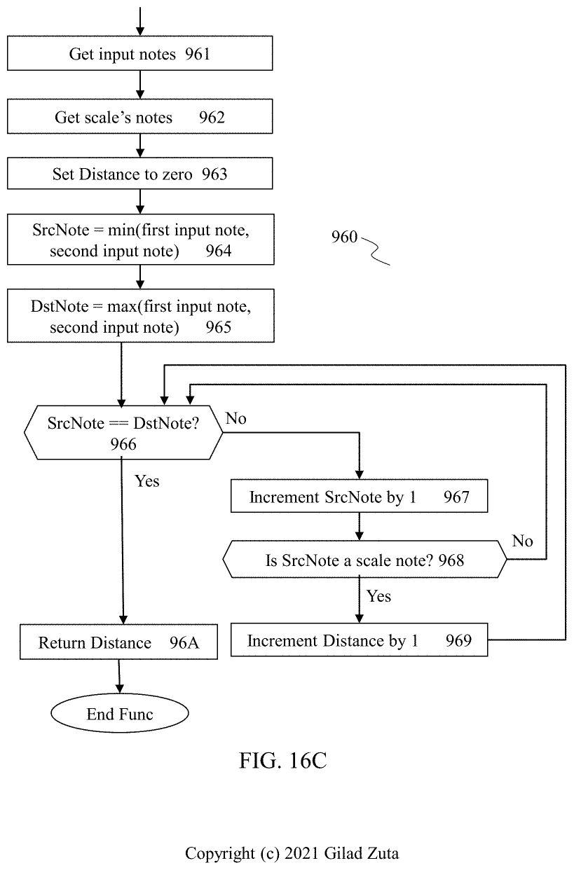

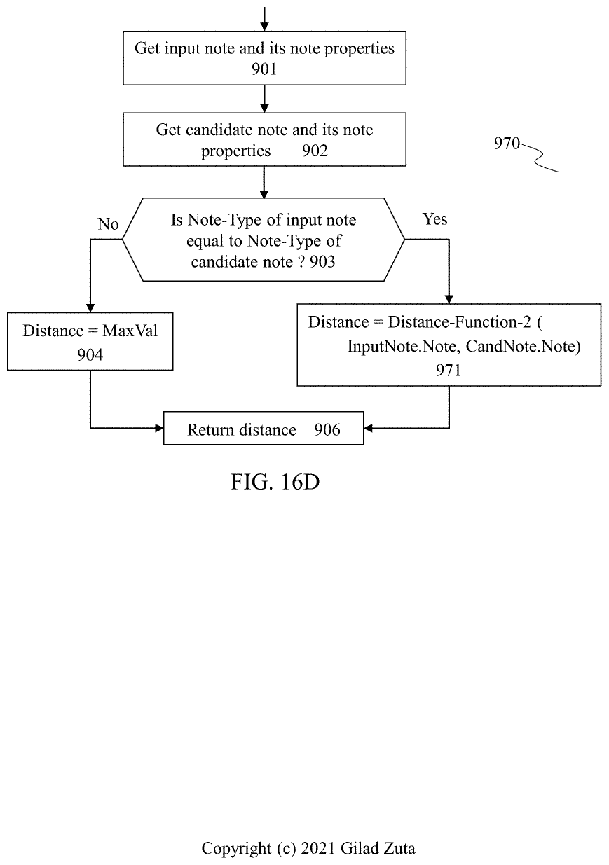

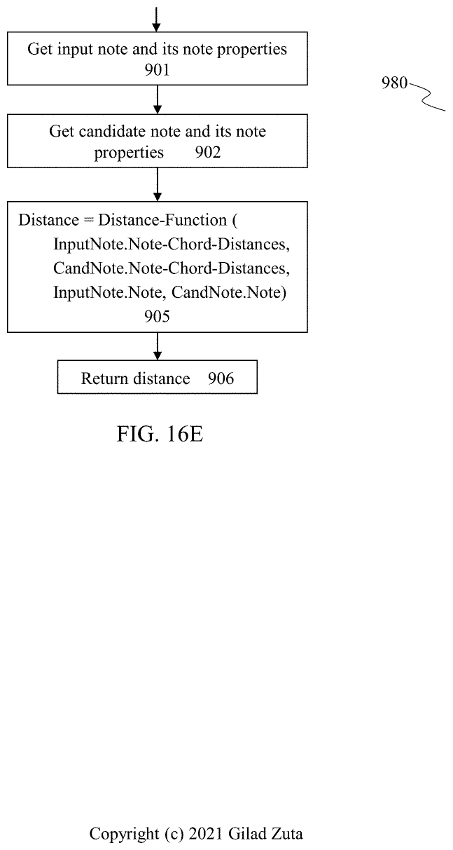

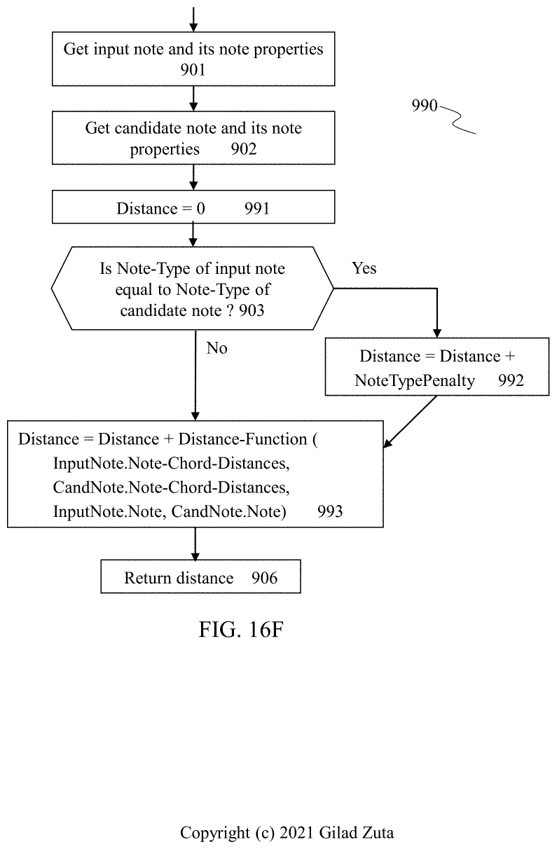

FIG. 16A is a flow chart of a method for computing transform's distance between an input note and a candidate note, using Note-Type and Note-Chord-Distances, version 1. Transform's distance is the distance between an input note and a candidate note that is used to evaluate candidate notes.

In one embodiment, this method runs when both Note-Type and Note-Chord-Distances of the input note are available,

In this embodiment, to have a valid distance, candidate note's Note-Type should be the same as input note's Note-Type. This means that a valid candidate to an input note with ‘Harmonic-0’ Note-Type is a candidate note that has ‘Harmonic-0’ Note-Type. A valid candidate to an input note with ‘Scale’ Note-Type is a candidate note that has ‘Scale’ Note-Type; and so on.

Candidates that have Note-Type that is different than input note's Note-Type are not considered valid candidates. This means that the system would not like to be valid candidates for best notes, therefore these candidates will get a maximal distance value.

The method includes:

In block 901, get input note and its note properties.

In one embodiment, ‘Non-scale’ Note-Type notes should not be considered as valid candidates. Therefore, input note that has ‘Non-scale’ Note-Type is modified to have ‘Scale’ Note-Type.

In block 902, get candidate note and its note properties.

In block 903, check if Note-Type of input note equal to Note-Type of candidate note. If yes goto block 905, otherwise goto block 904.

In block 904, set Distance variable to MaxVal. MaxVal is a large number that indicates that the candidate note is disqualified. This gives maximal distance value for notes that the system would not like to be valid candidates for best notes. Typically, this is a very large number, such as maximal integer value. However, any number that is unreasonably large than the maximal distance for a candidate note can be used. For example, if the distance for a candidate note is between 0 to 30, then MaxVal can be 32,000.

In block 905, calculate distance between input note and candidate note using a function, that is denoted as ‘Distance-Function’. Store the result in Distance variable.

In block 906, Return value of Distance variable and finish function.

**End of Method**

Explanation regarding computing distance in block 905. Distance is calculated using Distance-Function that gets the following equation:

Distance=Distance-Function(InputNote.Note-Chord-Distances, CandNote.Note-Chord-Distances, InputNote.Note,CandNote.Note)

Where:
InputNote is the input note.
InputNote.Note is the note number of the input note.
InputNote.Note-Chord-Distances are the Note-Chord-Distances of the input note.
CandNote is the candidate note.
CandNote.Note is the note number of the candidate note.
CandNote.Note-Chord-Distances are the Note-Chord-Distances of the candidate note.

Distance-Function can be any function that uses one or more of its parameters and returns a numerical value, which can be any number, real, integer etc.

For example, one embodiment of a Distance-Function uses absolute math function (“Abs”) on differences between Note-Chord-Distances and Note numbers:

Distance=Abs(InputNote.NCD-0−CandNote.NCD-0)+Abs(InputNote.NCD-1−CandNote.NCD-1)+Abs(InputNote.NCD-2−CandNote.NCD-2)+Abs(InputNote.Note−CandNote.Note)

Where:
InputNote.NCD-X is NCD-X of the input note.
CandNote.NCD-X is NCD-X of the candidate note.

Another embodiment uses square root to compute Distance, such as:

Distance=Root(Square(InputNote.NCD-0−CandNote.NCD-0)+Square(InputNote.NCD-1−CandNote.NCD-1)+Square(InputNote.NCD-2−CandNote.NCD-2)) Abs(InputNote.Note−CandNote.Note)

Another embodiment that uses square root to compute Distance is:

Distance=Root(Square(InputNote.NCD-0−CandNote.NCD-0)+Square(InputNote.NCD-1−CandNote.NCD-1)+Square(InputNote.NCD-2−CandNote.NCD-2)+Square(InputNote.Note−CandNote.Note))

Another embodiment uses weighted sum to compute Distance, where Alpha values are parameters:

Alpha-0*Abs(InputNote.NCD-0,CandNote.NCD-0)+Alpha-1*Abs(InputNote.NCD-1,CandNote.NCD-1)+Alpha-2*Abs(InputNote.NCD-2-,CandNote.NCD-2)+Alpha-3*Abs(InputNote.Note,CandNote.Note)

Where Alpha-0, 1, 2, 3 are parameters for the method.

In another embodiment, where Note-Type is available and of Note-Chord-Distances are partly available, Distance can be computed as described above, using the available Note-Chord-Distances.

For example, if NCD-0 is available:

One embodiment uses absolute math function:

Distance=Abs(InputNote.NCD-0−CandNote.NCD-0)+Abs(InputNote.Note−CandNote.Note)

Another embodiment uses square root, such as:

Distance=Root(Square(InputNote.NCD-0−CandNote.NCD-0)+Square(InputNote.Note−CandNote.Note))

Another embodiment uses weighted sum, where Alpha values are parameters, such as:

Alpha-0*Abs(InputNote.NCD-0,CandNote.NCD-0)+Alpha-1*Abs(InputNote.Note,CandNote.Note)

Where Alpha-0, 1 are parameters for the method.

Method 950: Compute Transform's Distance Using Note-Type and NCDs—Version 2

FIG. 16B is a flow chart of a method for computing transform's distance between an input note and a candidate note, using Note-Type and Note-Chord-Distances, version 2.

In one embodiment, this method runs when both Note-Type and Note-Chord-Distances of the input note are available,

Block 901-906 are the same as detailed in Method 900.

In block 951, calculate distance between input note and candidate note using Distance-Function, store the result in Distance variable.

**End of Method**

Explanation regarding computing the distance in block 951. Distance is calculated using the following:

Distance=Distance-Function(InputNote.Note-Chord-Distances,CandNote.Note-Chord-Distances)+Count_Scale_Notes (InputNote.Note,CandNote.Note)

Where:
Distance-Function is a function as detailed in Method 900.
Count_Scale_Notes is a method for counting scale notes between notes, as detailed in Method 960.

For example, one embodiment uses Absolute (‘Abs’) math function:

Abs(InputNote.NCD-0−CandNote.NCD-0)+Abs(InputNote.NCD-1−CandNote.NCD-1)+Abs(InputNote.NCD-2−CandNote.NCD-2)+Count_scale_notes(InputNote.Note,CandNote.Note)

Where Count_Scale_Notes is a method for counting scale notes between notes, detailed in Method 960, in FIG. 16C.

In another embodiment, where both Note-Type and part of Note-Chord-Distances are available, Distance can be computed as above, using the available Note-Chord-Distance in Distance-Function. For example, if NCD-0 is available:

Abs(InputNote.NCD-0−CandNote.NCD-0)+Count_scale_notes(InputNote.Note,CandNote.Note)

Method 960: Count Scale Notes Between Notes

FIG. 16C is a flow chart of method for counting scale notes between two input notes. The method gets as input two input notes and a scale. Scale can be represented for example by the scale's name.

In block 961, get the two input notes.

In block 962, get scale's notes. Scale is given as input for the method.

In block 963, set Distance variable to zero.

In block 964, set SrcNote variable as the minimum between first input note's number and second input note's number.

In block 965, set DstNote variable as the maximum between first input note's number and second input note's number.

In block 966, check if value of SrcNote is equal to value of DstNote. If yes goto block 96A, otherwise goto block 967.

In block 967, increment value of SrcNote by 1, as in the following equation:

SrcNote=SrcNote+1

In block 968, check if SrcNote value is one of the scale notes, if yes goto block 969. Otherwise goto block 966.

In block 969. increment value of Distance variable by 1, as in the following equation:

Distance=Distance+1

In block 96A, return the computed distance value that is stored in Distance variable. Function finishes.

**End of Method**

Another embodiment is implemented by modifying blocks 964, 965 and 967:

In block 964, set SrcNote as first input note.

In block 965, set DstNote as second input note.

In block 967, if SrcNote is smaller than DstNote then increment SrcNote by 1, otherwise decrement SrcNote by 1.

**End of Method**

Method 970: Compute a Transform's Distance Using Note-Type

FIG. 16D is a flow chart of a method for computing transform's distance between an input note and a candidate note, using Note-Type.

In one embodiment, this method runs when only Note-Type of the input note is available.

Block 901-906 are the same as detailed in Method 900.

In block 971, calculate distance between input note and candidate note using Distance-Function-2, store the result in Distance variable. Distance is calculated using the following:

Distance=Distance-Function-2(InputNote.Note,CandNote.Note)

Where:
Distance-Function-2 can be any function that uses its parameters and returns a numerical value, which can be any number, real, integer etc.

For example, one embodiment of a distance function uses math absolute function on differences between Note-Chord-Distances and Note numbers:

Distance=Abs(InputNote.Note−CandNote.Note)

Another embodiment uses Count_scale_notes function that count scale notes between InputNote.Note, CandNote.Note, such as:
Count_scale_notes(InputNote.Note, CandNote.Note)

Where Count_Scale_Notes is a method for counting scale notes between notes, as detailed in Method 960.

**End of Method**

Method 980: Compute Transform's Distance Using NCDs

FIG. 16E is a flow chart of a method for computing transform's distance between an input note and a candidate note, using Note-Chord-Distances.

In one embodiment, this method runs when only Note-Chord-Distances of the input note are available,

Block 901-906 are the same as detailed in Method 900.

Distance-Function is a function as detailed in Method 900.

The change from Method 900 is that in this embodiment Note-Type is not being used.

Another embodiment of Distance-Function is counting scale notes:

Abs(InputNote.NCD-0−CandNote.NCD-0)+Abs(InputNote.NCD-1−CandNote.NCD-1)+Abs(InputNote.NCD-2−CandNote.NCD-2)+Count_scale_notes(InputNote.Note,CandNote.Note)

Where Count_Scale_Notes is a method for counting scale notes between notes, detailed in Method 960.

In another embodiment, where part of Note-Chord-Distances are available, Distance can be computed as above, using the available Note-Chord-Distance in Distance-Function. For example, if NCD-0 is available:

Abs(InputNote.NCD-0−CandNote.NCD-0)+Count_scale_notes(InputNote.Note,CandNote.Note)

**End of Method**

Method 990: Compute Transform's Distance Using Note-Type and NCDs—Version 3

FIG. 16F is a flow chart of a method for computing transform's distance between an input note and a candidate note, using Note-Type and Note-Chord-Distances, version 3.

In this embodiment, candidates that have different Note-Type than input note's Note-Type are not disqualified. Instead, a penalty value is added to such candidates. “Penalty” is a numerical value that represents how much should be added to distance, between the note and the candidate note, when the Note-Types of the notes are different.

In one embodiment, this method runs when both Note-Type and Note-Chord-Distances of the input note are available,

Block 901-906 are the same as detailed in Method 900.

In block 991, set Distance variable to 0.

In block 992, add value of NoteTypePenalty to Distance variable. NoteTypePenalty value indicates how much to add to distance when Note-Types of input note and candidate note are different. Distance variable is updated using:

Distance=Distance+NoteTypePenalty

In block 993, calculate distance between input note and candidate note using Distance-Function, store the result in Distance variable. Distance is calculated using the following:

Distance=Distance+Distance-Function(InputNote.Note-Chord-Distances, CandNote.Note-Chord-Distances, InputNote.Note,CandNote.Note)

Where:
Distance-Function is a function as described in Method 900 or Method 950.

**End of Method**

Explanation regarding NoteTypePenalty is in block 992:

In one embodiment, NoteTypePenalty is a fixed configuration parameter of the system.

In another embodiment, value of NoteTypePenalty is determined using a table of allowed Note-Type to Note-Type transforms. If the values of input Note-Type and candidate Note-Type are not in the table, then NoteTypePenalty is set to MaxVal. Otherwise, it is set to the value in the table. For example, ‘Harmonic’ to ‘Harmonic’ Note-Types can have a penalty of 2, and ‘Harmonic’ to ‘Scale’ Note-Types can have a penalty of 4.

In another embodiment, a table of probability of Note-Type to Note-Type transforms. Drawing a random value, if it is below the probability in the table then NoteTypePenalty is set to MaxVal. Otherwise, it is set 0 or a fixed parameter. For example, table can define that for input Note-Type of ‘Harmonic’, transform Note-Type of ‘Harmonic’ is allowed in 100%, and to Note-Type ‘Scale’ is allowed in 40%. This means that on average, 40% of ‘Harmonic’ notes can also be transformed to ‘Scale’ notes.

Method 760: Transform a Song

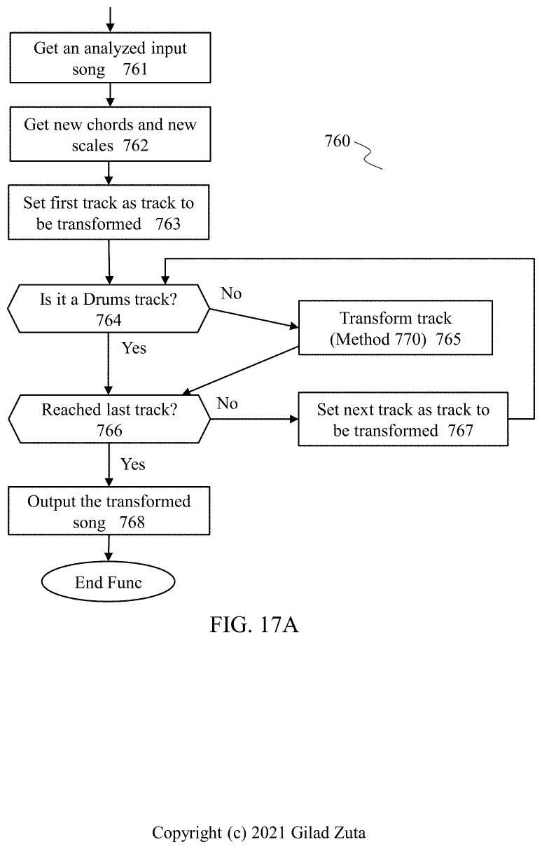

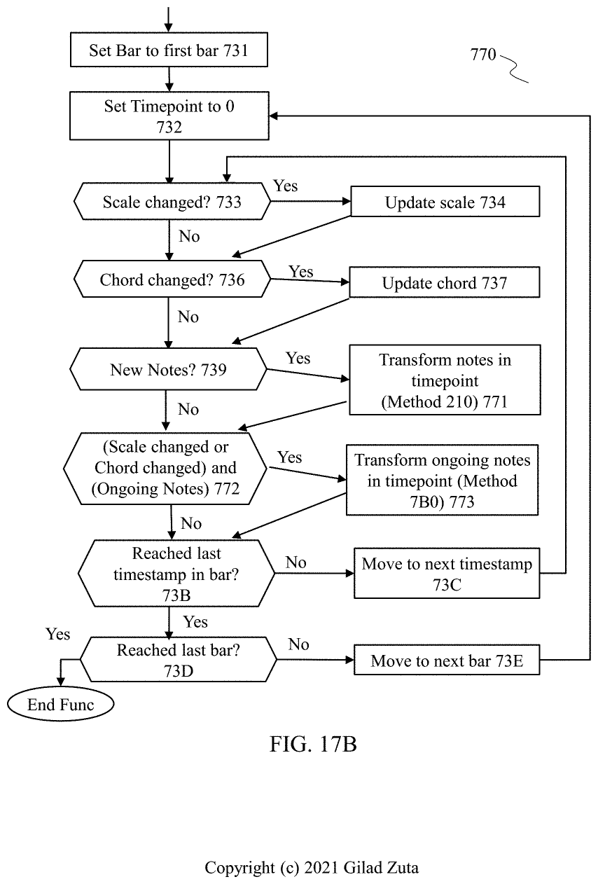

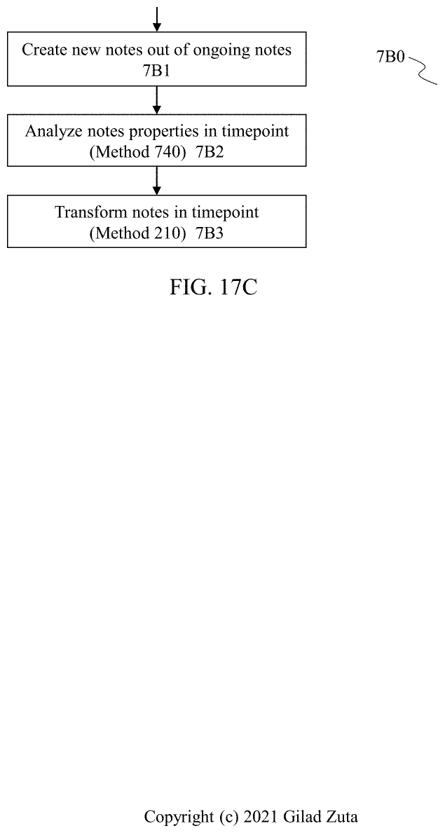

FIG. 17A is a flow chart of a method for transforming songs according to new chord and new scales. Transforming a song is done by transform notes of the tracks in the song, except for the drum tracks, according to the new chords and new scales. Drum tracks are copied unchanged.

Input: Analyzed song, new chords and scales.

Output: Transformed song according to new chords and scales.

In block 761, get an analyzed input song. An analyzed input song, such as Analyzed SNT file 52, contains the input song's notes (X11) and the computed notes properties for the notes (X13), as shown in FIG. 14.

In block 762, get new chords and new scales. New chords and new scales (X14) are received as shown in FIG. 14. X14 replace the original chords and scales of the analyzed input song that were received at block 761. X14 are set as the new Chords and Scales.

In block 763, Set first track of song as the track to be transformed.

In block 764, check if it is a drums track. If yes, then goto block 766. Otherwise, goto block 765.

In block 765, transform the track, as detailed in Method 770.

In block 766, check if reached last track of the song. If yes, goto block 768, otherwise goto block 767.

In block 767, set next track of the song as the track to be transformed.

In block 768, output the transformed song. This can be writing the new SNT File as shown in FIG. 14. This includes copying control events, and notes of the drum tracks unchanged, to the output song.

**End of Method**

Method 770: Transform a Track

FIG. 17B is a flow chart of method for transforming a track.

Blocks 731-73E of transforming a track are similar to Analyze track method 730.

Changes with respect to Method 730 are:

a. In this figure, block 739 is connected to block 771 if the answer is ‘yes’.

b. New blocks in this method are: 771, 772 and 773.

In block 771, Transform notes of current bar and timepoint, as detailed in Method 210.

This is done by running Method 210 for every note in the timepoint defined by Bar and Timepoint.

In block 772, check first condition: is scale changed or is chord changed in current timepoint (as defined by the Bar and Timepoint).

Check second condition: Are there ongoing notes in current timepoint (defined by Bar and Timepoint).

If both conditions are true, then goto block 773. Otherwise goto block 73B.

In block 773, transform ongoing notes in timepoint, as detailed in Method 7B0.

**End of Method**

Explanation Regarding Transform Notes in Block 771:

A configuration to the system determines whether overriding of transformed notes in same track, bar and timepoint are allowed.

If overriding is allowed, then Method 210 can transform two or more notes, that are in the same track, bar and timepoint, to the same note value.

If overriding is not allowed, then Method 210 transforms two or more notes, that are in the same track, bar and timepoint, to different note values. Since Method 210 computes distances between an input note and a set of notes candidates, this can be implemented in Method 210 by choosing a candidate that has second, or third etc, minimal distance,

Method 7b0: Transform Ongoing Notes

FIG. 17C is a flow chart of the transform ongoing notes method.

This shows an embodiment of Method 270.

In block 7B1, create new notes out of ongoing notes.

Creating new notes out of ongoing notes is done using the following steps:

a. Denote ongoing notes as ‘N1’.

b. Copy Note-Off-Timing values of ‘N1’ to a variable, denoted as ‘V1’.

c. Set Note-Off-Timing of ‘N1’ to current bar and timepoint.

d. Create new note events for current bar and timepoint, denoted as ‘N2’.

e. Copy note, velocities and notes properties of ‘N1’ into ‘N2’.

f. Set Note-Off-Timing of ‘N2’ to ‘V1’.

An example of these steps is illustrated in FIGS. 18A and 18B.

In block 7B2, analyze notes properties (Method 770). Run method 770 on the new notes created out of the ongoing notes in step 7B1.

In block 7B3, Transform the new notes in the timepoint, as detailed in Method 210.

Run the method 210 for every new note created out of the ongoing notes in step 7B1.

**End of Method**

### Example 1

FIGS. 18A and 18B illustrate an example of creating new notes out of ongoing notes, as described in block 7B1 of Method 7B0.

For simplicity of the illustration, N notes are shown that have the same starting bar and timepoint (X111), and the same ending bar and timepoint (X113). In real life scenarios, each ongoing note can have its own starting bar and timepoint values, and its own ending bar and timepoint values.

FIG. 18A is an example of ongoing notes that goes into block 7B1. In this example, there are N notes, denoted as ‘N111’, that start on same bar and timepoint (X111), and end at a later time, on same bar and timepoint (X113). At current bar and timepoint (X112) there is a chord or scale change.

Block 7B1 creates new notes out of the ongoing notes, as shown in FIG. 18B.

FIG. 18B is the continuation of the example of FIG. 18A. It shows the new notes created from the ongoing notes of FIG. 18A, by block 7B1. Block 7B1 creates new notes (N112) out of the ongoing notes (N111). It sets Note-Off-Timing of N112 notes to current bar and timepoint, (X112). It creates new notes (N113) that start on current bar and timepoint (X112), and end on the original end bar and timepoint (X113).

### Example 2

FIGS. 19A to 19S show an example of creating a new song by analyzing and transforming an input song, as detailed in Method 750.

FIGS. 19A to 19H show converting MIDI to SNT, Method 700

FIG. 19J shows notes properties after analyzing SNT, Method 720.

FIGS. 19K to 19S show new song after transforming, Method 760.

FIG. 19A shows music notation of the notes of an input song.

For simplicity, the input song has one track and one bar.

At bar 1, timepoint 0, there are three notes (N105): ‘59 B3’. ‘60 C4’ and ‘65 F4’. Notation ‘59 B3’ means note number 59, which is note ‘B’ in Octave-Number 3, as shown in FIG. 8.

At bar 1, timepoint 16, there are three notes (N106): ‘58 A #3’. ‘61 C #4’ and ‘65 F4’.

FIG. 19B shows chords table of the input song.

The song has two chords. At bar 1, timepoint 0, it has ‘F Major’ chord. At bar 1, timepoint 16, it has ‘F Augmented’ chord.

FIG. 19C shows the scales table of the input song.

The song has one scale. At bar 1, timepoint 0, it has ‘A Minor’ scale.

FIG. 19D shows the input MIDI events. There is one 4/4 Time Signature event, 6 Note-On events and 6 Note-Off events. MIDI Header Division is not shown in the figure, its value in this example is 480.

FIG. 19E shows calculating absolute times, Bars and Timepoints, as described in converting MIDI to SNT method 700. As described in block 702, adding first bar to Bars Table, it is bar 1 with the following default values:

Bar1.AbsTime=0

Bar1.Num=4

Bar1.Denom=4

Bar1.BarTime=4*480*4/4=1920

Bar1.Timepoints=32*4/4=32

Bar1.dTimepoint=480/8=60

Calculating absolute time of the events is done by summing Delta Timestamp. As described in block 703:

AbsTime=AbsTime+Event.DeltaTimestamp

Event.AbsTime=AbsTime

This song has one track, events are already sorted by absolute time.

Next, creating bars and and computing bar and timepoint for Time Signature events (block 705) and all other events (block 706):

Bar 1 end of bar time is:

EndOfBarTime=Bar1.AbsTime+Bar1.BarTime=0+1920=19

Events 1 to 10 are all contained in bar 1, because their Abs Time is 0, is smaller than 1920. Event 11 has absolute time 1920 which is larger than bar 1's end of bar time, therefore a new bar, bar 2, is created:

Bar2.AbsTime=1920

Bar2.Num=4

Bar2.Denom=4

Bar2.BarTime=1920

Bar2.Timepoints=32

Bar2.dTimepoint=60

Bar 2 end of bar time is:

EndOfBarTime=Bar2.AbsTime+Bar2.BarTime=1920+1920=3840

Events 11 to 13 are all contained in bar 2, because their Abs Time is 1920, is smaller than end of bar 2 time, 3840.

Next, calculate the relative time using the following equation:

RelTime=Event.AbsTime−Bar.AbsTime

For example, event 7 belongs to bar 1, therefore:

Event7.RelTime=Event7.AbsTime−Bar2.AbsTime=960−0=960

Next, calculate timepoint of each event using:

Event.Timepoint=(U16)(Event.RelTime/Bar.dTimepoint)

For example, event 7 belongs to bar 2, therefore:

Event7.Timepoint=(U16)(Event7.RelTime/Bar2.dTimepoint)=(U16)(960/60)=16

FIG. 19F shows associating Note-On Note-Off pairs, as described in block 708 of Method 700.

Event 5 is the Note-Off of event 2. Event 6 is the Note-Off of event 3; and so on, until event 13 which is the Note-Off of event 10.

Create one SNT event for each Note-On Note-Off pair (step 709). Event 1, the time signature event, remains unchanged. SNT Event 2 now represents MIDI events 2 and 5. MIDI Event 5's bar and timepoint copied into Note-Off Bar and Note-Off Timepoint values of SNT Event 2. SNT Event 3 now represents MIDI events 3 and 6. MIDI event 6's bar and timepoint copied into Note-Off Bar and Note-Off Timepoint values of SNT Event 3. And so on. The result is a total of 7 SNT events.

FIG. 19G shows the resulting SNT File events. Arranging the SNT events that are created in FIG. 19F by their bar and timepoint. Time Signature event is no longer needed, because its information is already stored in SNT File Bars Table.

This results in 3 SNT-Note events, on bar 1 timepoint 0, corresponding to N105 of FIG. 19A; and another 3 SNT-Note events, on bar 2 timepoint 0, corresponding to N106 of FIG. 19A. Notes Properties is null for all the events because they have not been analyzed yet.

FIG. 19H shows the resulting SNT File Bars Table. It shows the 2 bars calculated in FIG. 19E. All SNT events are located in bar 1, as shown in FIG. 19G. Bar 2 has no events in it and is only used for Note-Off Bar and Note-Off Timepoint fields as shown in FIG. 19G.

FIG. 19J shows Analyzed SNT File Events.

Running Method 930 to compute Note-Chord-Distances, using input song's Chords Table (FIG. 19B) and Scales Table (FIG. 19C). The results are the notes properties shown in the figure. For example, at bar 1 timepoint 0, note 59 has Note-Type of ‘Scale’, and has Note-Chord-Distances of 3, 1, and 6.

FIGS. 19K to 19S show an example of transforming the analyzed song that is shown in FIG. 19J.

This demonstrates Transform Song Method 760.

FIG. 19K shows new chords table for the input song to be transformed to. The new chords are: At bar 1, timepoint 0, is ‘C’ chord. Now there is one chord instead the two chords of the input song.

FIG. 19M shows new Scales Table. It has one scale, at bar 1 timepoint 0, which is ‘A Minor’. This is the same as the input song.

FIG. 19N shows notes candidates for transforming input note ‘59 B3’, at Bar 1, timepoint 0.

Transform note is performed as detailed in Method 210, in FIG. 15A

Distance is calculated as detailed in Method 900, in FIG. 16A.

For this example, an absolute math function is used for Distance-Function. Distance is calculated using the following equation:

Distance=Abs(InputNote.NCD-0−CandNote.NCD-0)+Abs(InputNote.NCD-1−CandNote.NCD-1)+Abs(InputNote.NCD-2−CandNote.NCD-2)+Abs(InputNote.Note−CandNote.Note)

At bar 1, timepoint 0, input note is ‘59 B3’, it has ‘Scale’ Note-Type and Note-Chord-Distances equal to [3, 1, 6].

Range for notes candidates is 10. Since input note is ‘59 B3’, notes between 49 (59−10) and 69 (59+10) are considered as candidates.

Calculating distance of candidate notes:
Non-scale note candidates have ‘MaxVal’ distance, are not shown in the figure.
Candidate notes ‘67 G4’, ‘64 E4’, ‘60 C3’, ‘55 G3’, and ‘52 E3’ have different Note-Type than input note's Note-Type, therefore their distance is set to MaxVal.
Since input note's Note-Type is ‘Scale’, distances are calculated for candidate notes with ‘Scale’ Note-Types:

Candidate note ‘65 F4’: Distance=|3−3|+|1−1|+|6−6|+|67−59|=6

Candidate note ‘62 D4’: Distance=|1−3|+|6−1|+|4−6|+|62−59|=12

Candidate note ‘59 B3’: Distance=|6−3|+|4−1|+|2−6|+|59−59|=10

Candidate note ‘57 A3’: Distance=|5−3|+|3−1|+|1−6|+|57−59|=11

Candidate note ‘53 F3’: Distance=|3−3|+|1−1|+|6−6|+|53−59|=6

Candidate note ‘50 D3’: Distance=|1−3|+|6−1|+|4−6|+|50−59|=18

The Minimal distance is 6. There are 2 candidates with the same minimal distance, note ‘65 F4’ and note ‘53 F3’. For this example, we use the embodiment that chooses randomly between them, the first note, ‘65 F4’, shown in bold in the figure, is chosen. Input note ‘59 B3’ is transformed to note ‘65 F4’.

FIG. 19P shows Transforming at Bar 1, timepoint 0, of the remaining two notes in this timepoint.

Input note ‘60 C4’, its Note-Type is ‘Harmonic-2’. Candidate note that has the minimal distance is ‘55 G3’. Input note is transformed to ‘55 G3’.

Input note ‘67 G4’, its Note-Type is ‘Harmonic-0’. Candidate note that has the minimal distance is ‘60 C4’. Input note is transformed to ‘60 C4’.

FIG. 19Q shows Transforming at Bar 1, timepoint 16.

Input note is ‘58 A3’, its Note-Type is ‘Scale’. In a similar manner as described in FIG. 19N, finding the minimal distance. The note candidate that has the minimal distance is ‘53 F3’. The Input note is transformed to ‘53 F3’.

FIG. 19R shows Transforming at Bar 1, timepoint 16, of the remaining two notes in this timepoint.

Input note ‘61 C #4’, its Note-Type is ‘Harmonic-2’. In a similar manner as described in FIG. 19P, finding the minimal distance. Two note candidates have the minimal distance, ‘67 G4’ and ‘55 G3’. Choosing randomly between them ‘67 G4’ is chosen. Input note is transformed to ‘67 G4’.

Input note ‘65 F4’, its Note-Type is ‘Harmonic-0’. In a similar manner as described in FIG. 19P, finding the minimal distance. The note candidate that has the minimal distance is ‘60 C4’. Input note is transformed to ‘60 C4’.

FIG. 19S shows the resulting transformed SNT Song.

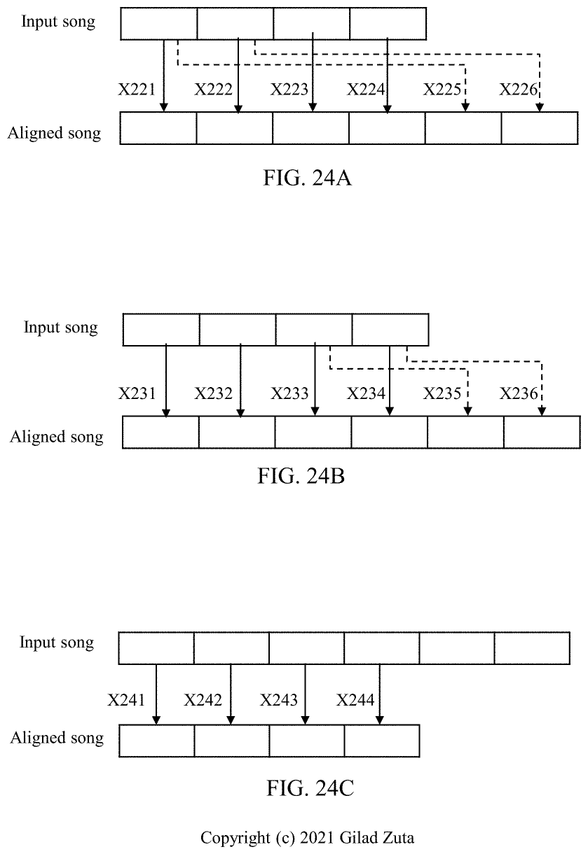

N107 are the transformed notes of Bar 1, timepoint 0, that were calculated in FIGS. 24N and 24P. The input notes were notes N105 of FIG. 19A.

N108 are the transformed notes of Bar 1, timepoint 16, that were calculated in FIGS. 24Q and 24R.

The input notes were notes N106 of FIG. 19A.

All the input notes and new notes keep the same Velocity of 90.

### Example 3

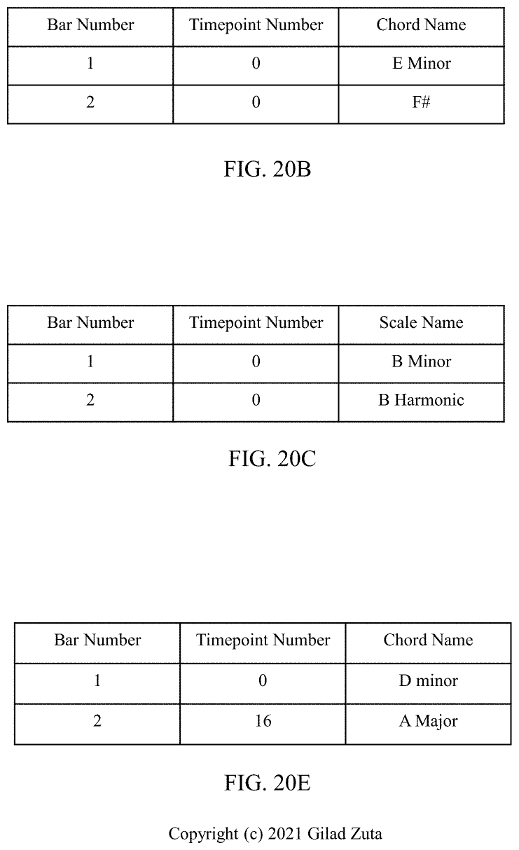

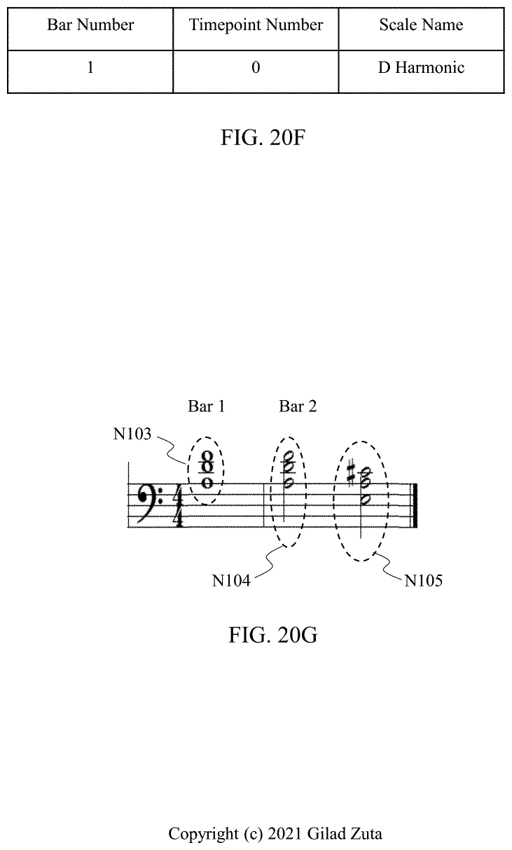

FIGS. 20A to 20G show another example of analyzing and transforming an input song, as detailed in Method 750. This example includes transforming of ongoing notes.

FIG. 20A shows a music notation of the notes of an input song.

For simplicity, the input song has one track and 2 bars.

At bar 1, timepoint 0, there are three notes (N101): ‘59 B3’, ‘64 E4’ and ‘67 G4’.

At bar 2, timepoint 0, there are three notes (N102): ‘61 C #4’, ‘66 F #4’ and ‘70 A #4’.

FIG. 20B shows chords table of the input song. The song has two chords. At bar 1, timepoint 0, it has ‘E Minor’ chord. At bar 2, timepoint 0, it has ‘F #’ chord.

FIG. 20C shows the scales table of the input song. The song has two scales. At bar 1, timepoint 0, it has ‘B Minor’ scale. At bar 2, timepoint 0, it has ‘B Harmonic’ scale.

FIG. 20E shows new chords table for the input song to be transformed to. The new chords are: At bar 1, timepoint 0, is ‘D minor’ chord. At bar 1, timepoint 16, it is ‘A Major’ chord.

FIG. 20F shows new Scales Table. It has one scale, at bar 1 timepoint 0, which is ‘D Harmonic’.

FIG. 20G shows the resulting transformed song.

In this example, there is a chord change at bar 2 timepoint 16, to chord ‘A’, while notes N102 are still ongoing. Therefore, ongoing notes are handled as detailed in Method 270. First, notes N102 are stopped at bar 2, timepoint 16, new notes are created by duplicating notes N102 to start at bar 2, timepoint 16, and transforming the new notes, N105. The resulting song contains:
N103 are the transformed notes of bar 1, timepoint 0. The input notes were notes N101 of FIG. 20A.
N104 are the transformed notes of bar 2, timepoint 0, The input notes were notes N102 of FIG. 20A.
N105 are the transformed notes of bar 2, timepoint 16, The input notes were the ongoing notes N102 at bar 2, timepoint 16.

New notes keep the same velocity as the input notes.

Part 3: Align a Song's Bars-Structure

One aspect of transforming songs deals with notes, changing the notes to be harmonic with new chords and scales. This is handled by transform notes (Method 210), transform song (Method 760) and transform track (Method 770).

A second aspect of transforming songs deals with changing the bars structure of a song (“Bars-Structure”). Bars-Structure describes the number of bars, and the number of beats in each bar, of a song. Bars-Structure is comprised of number of bars and bar's length array. Number of bars indicates the number of bars in the song. Bar's length array contains the length of each bar in the song. In this embodiment, the length of a bar is measured by the number of timepoints in that bar.

A novel approach in aligning musical sections of a song (Method 220), include changing the bars and notes of an input song such that it creates a new Bars-Structure that is identical to a desired output song's Bars-Structure.

Aligning musical sections of a song includes one or more of the following: duplicating bars, removing bars, duplicating timepoints in bars, extending length of notes in timepoints in bars and/or removing timepoints from bars.

As shown elsewhere in the present disclosure, creating a new song is performed by combining an input musical composition with a second musical composition.

The bars structure of the input and second musical compositions may differ, creating a need to align between the musical compositions.

If the second musical composition is not aligned, it can lead to doing transform on bars and timepoints of second musical composition that exist in the input song but do not exist in the second musical composition. For example, an input musical composition of 8 bars and a second musical composition of 4 bars. Bars 5-8 do not exist in the second musical composition.

Aligning second musical composition's Bars-Structure to a desired Bars-Structure allows for using the transform notes of a song (Method 210) unchanged when creating a new song.

Benefits

Aligning Bars-Structure has the following benefits, among others:
Aligning is the basis for creating new songs using songs that have different Bars-Structure than the input song, as shown in Method 7A0.
Changing bars structure creates a song with bars structure that is more akin to the original bars structure. For example, when duplicating bars, the original bars remain unchanged, the duplicated bars are similar to the original bars.

Using the original bar and timepoint of a song maintains the song's original characteristics, as the composer of the song intended.
Timescale of bars and timepoints has fewer options to change than timescale of real time. Timescale that uses real time is infinite, one can divide bars according to any time resolution, 5 msec (millisecond), 1 msec, 0.5 msec, etc. Tempo affects the real time length of bars. This makes implementation more efficient and faster.
Bars and timepoints have a finite number of values. When using a timescale of bars and timepoints, the number of bars is finite and relatively small, for example a song with 8 bars. The Number of timepoints of bar is also finite and relatively small, such as 32 timepoints per 4/4 bar. This is easier to process and manipulate, and faster to compute, and gives a more accurate result. In addition, when using a timescale of bars and timepoints, the tempo is irrelevant, there is no need to consider the tempo of the songs when processing songs. This makes implementation simpler and faster.

Novel Approach to Aligning Input Song's Bars-Structure

In the aligning musical sections of a song (Method 220) includes, among others:

a. It can change musical sections to match any desired number of bars.

b. It can change bars' lengths of musical sections to match any desired time signature.

c. It aligns Bars-Structure of a musical composition, instead of real time.

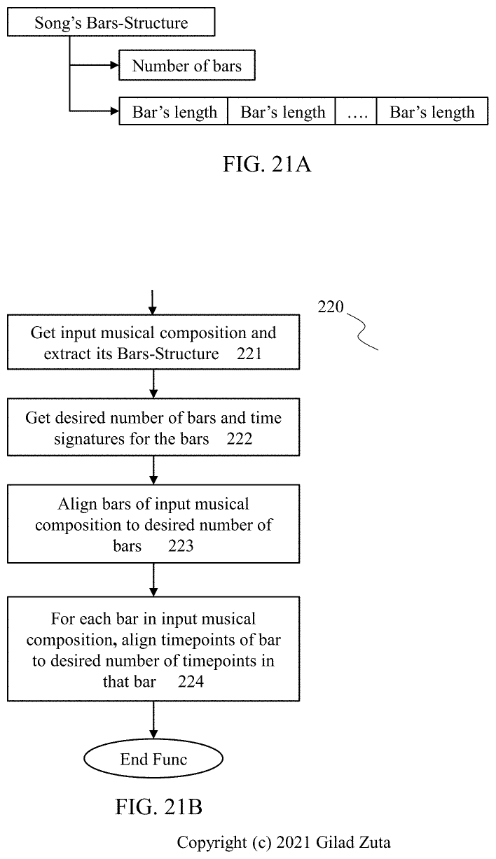

FIG. 21A illustrates Bars-Structure of a song. An example of a song is an SNT file.

Bars-Structure describes the number of bars, and the number of beats in each bar, of a song.

Bars-Structure may comprise:

a. Number of bars—indicates the number of bars in the song.

b. Bar's length array—Array that contains Bar's length of each bar in the song. In current embodiment, a Bar's length is measured using the number of timepoints in that bar.

Two songs are said to have the same Bars-Structure if all of the Bars-Structure's values are the same: Number of bars and bar's length array values. If one value is different, then the songs do not have the same Bars-Structure.

Method for Changing a Musical Composition to a Desired Number of Bars and Time Signatures

A method for changing a musical composition to a desired number of bars and time signatures for the bars, may comprise:
a. getting an input musical composition, wherein each note includes indications in bar and timepoint, where it starts and ends;
b. getting a desired number of bars and time signatures for the bars;
c. if the desired number of bars is larger than the number of bars in the musical composition, then duplicating bars from the input musical composition, until the numbers are equal.

**End of method**

Comments Re the Above Method

1. The method may further include:
d. if the desired number of bars is smaller than the number of bars in the musical composition, then removing bars until the numbers are equal.

2. The method may further include, for each bar:
1) if the desired number of timepoints is smaller than the number of timepoints in the bar, then removing timepoints until the numbers are equal;
2) if the desired number of timepoints is larger than the number of timepoints in the bar, then duplicating timepoints from the bar until the numbers are equal, or extending the length of notes in the original timepoint into the new timepoint.

Method 220: Align Bars-Structure of a Musical Composition

FIG. 21B is a flow chart of a method for aligning a musical composition to a new Bars-Structure.

In block 221, get an input musical composition and extract its Bars-Structure.

In block 222, get desired number of bars and time signatures for the bars. This is the desired, Bars-Structure for the output song.

In block 223, Align bars of input musical composition to the desired number of bars. This is done by duplicating and/or removing bars from the input musical composition, until the number of bars matches the desired number of bars.

In block 224, For each bar in input musical composition, align timepoints of bar to desired number of timepoints in that bar. This is done by duplicating timepoints in bars, and/or extending length of notes in timepoints in bars and/or removing timepoints from bars.

**End of Method**

Explanation Regarding Extracting Bars-Structure in Block 221:

In one embodiment, Bars-Structure can be explicitly defined in the input musical composition.

In another embodiment, Bars-Structure is received separately from the input musical composition.

In another embodiment, Bars-Structure can be extracted from the input musical composition. For example, when the input musical composition is an SNT file, Then the Bars-Structure can be extracted by performing:
Number of bars value is calculated by counting the number of entries in Bars Table (FIG. 5F).
Bar's length array is created by adding a cell to the array for each entry in Bars Table (FIG. 5F). Cell's value, Bar's length, is taken from ‘Timepoints’ field value of Bars Table (FIG. 5F).

Another example is when the input musical composition is a MIDI file, the MIDI file can be converted to an SNT file as shown in Method 700, and then Bars-Structure is extracted as described when input musical composition is an SNT file.

Method 7A0: Analyze, Align and Transform an Input Song

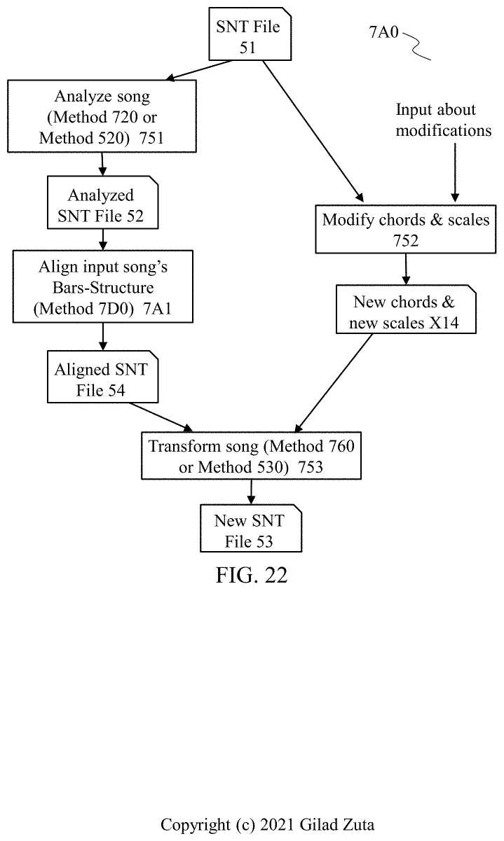

FIG. 22 is a high-level overview of a method for analyzing, aligning and transforming an input song. The method is similar to Method 750, in that it analyzes and transforms notes of an input song (SNT File 51) into a new song (New SNT File 53). New in this Method 7A0 is that it aligns the input song (SNT File 51) into an aligned song (Aligned SNT File 54), and transforms the aligned song (Aligned SNT File 54) into the new song (New SNT File 53).

Blocks 751, 752 and 753 are described in Method 750. The change in this method (7A0) compared to method 750 is a new block, 7A1, and its output, aligned SNT File 54.

In block 7A1, align input song's Bars-Structure (Method 7D0). Input song for this block is the analyzed SNT File 52.

Aligning input song's Bars-Structure means to modify the notes and bars of the input song of this block, analyzed SNT File 52. so that it will match the Bars-Structure of the desired output song. Output of Block 7A1 is an aligned song, Aligned SNT File 54.

Aligned SNT File 54 has the same Bars-Structure as the desired output song's Bars-Structure, which are written to new SNT File 53. This means that Aligned SNT File 54 has the same number of bars and Bar's Length array, as New SNT File 53.

In block 753, Transform song (Method 760) transforms input song, Aligned SNT File 54, to output song, New SNT File 53, according to new chords and/or new scales (I14). Block 753 is described in Method 750.

**End of Method**

In another embodiment, Block 7A1 can be swapped with block 751, to first perform alignment to SNT file 51, and afterwards doing analyze. This gives the same results. In this case, SNT File 51 is aligned to new Bars-Structure of New SNT File 53 using Method 7D0, output is written as Aligned SNT File 54. Then, Aligned SNT File 54 is analyzed using Method 720 to give Analyzed SNT File 52, that also has Bars-Structure as New SNT File 53. Analyzed SNT File 52 goes into transform song (Method 760) to produce New SNT File 53.

Method 7D0: Align an Input Song's Bars-Structure

This method shows an embodiment for method 220. It gets an input song, such as an SNT file, and a desired Bars-Structure, it modifies the notes and bars of the input song so that it will match the desired Bars-Structure, and it outputs an aligned song, which is a modified song with the desired Bars-Structure. Aligned song can be in a format such as SNT file.

The method modifies Bars-Structure by:
Duplicating or removing bars.
Duplicating or removing timepoints.
Extending length of notes in timepoints.

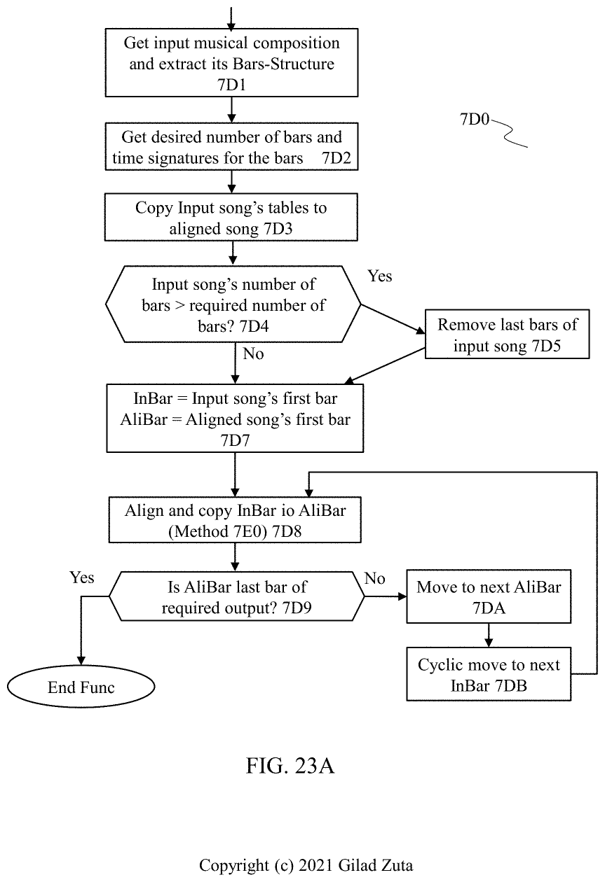

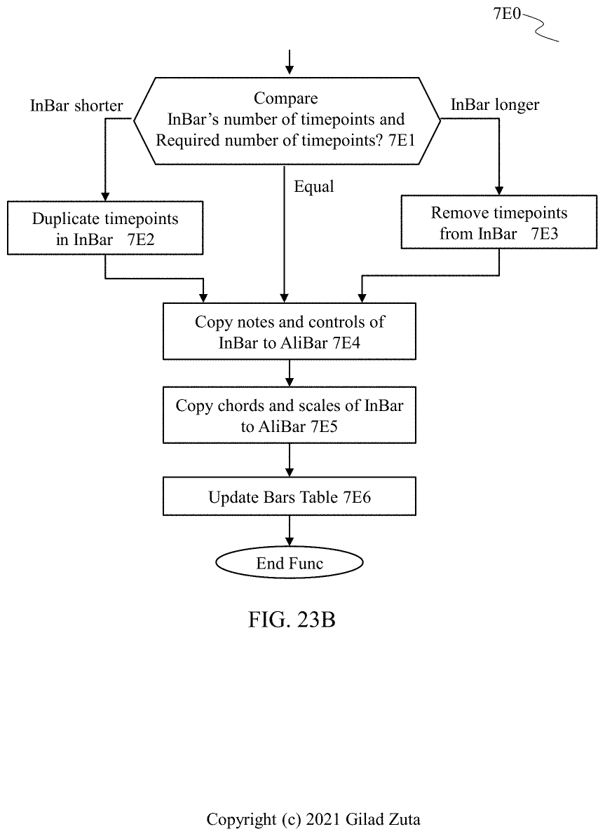

FIG. 23A is a flow chart of a method for aligning input song's Bars-Structure.

In block 7D1, get an input song and extract its Bars-Structure. Input song can be an SNT file or tracks of an SNT file. Input song has each note includes indications of its bar and timepoint, of where it starts and ends.

In block 7D2, get desired Bars-Structure. The desired Bars-Structure is the Bars-Structure of the new song (53), this is the Bars-Structure that the input song will be aligned to.

In block 7D3, copy input song's tables to aligned song. Aligned song is the output of the method, it is the input song after aligning it to the desired Bars-Structure. copying tables includes copying: Melody-Track-Number, Labels Table, Tracks Table and Header (FIG. 5B) of input song to aligned song.

In block 7D4, check if input song's number of bars is larger than required in output. Required number of bars at output is known from required Bars-Structure, that was received in block 7D2. If true, then goto block 7D5. Otherwise goto block 7D7.

In block 7D5, remove last bars of input song. This means that if input song has N bars, and the required number of bars is M bars, where N>M, then remove the last (N−M) bars of input song.

In another embodiment, remove the first (N−M) bars.

In another embodiment, randomly choose, or let the user pre-configure, whether to remove last (N−M) bars or first (N−M) bars of input song.

Removing the last bars means:

a. Deleting the notes in these bars, in all tracks and timepoints.

b. Deleting the bars from Bars Table.

In block 7D7, set InBar variable as first bar of input song, set AliBar variable as first bar of aligned song.

In block 7D8, align and copy InBar to AliBar, this is detailed in Method 7E0.

In block 7D9, check if AliBar is last bar of required output. Required number of bars at output is known from required Bars-Structure, that is received in block 7D2. If true then method finishes, otherwise goto block 7DA.

In block 7DA, set AliBar variable as next bar of aligned song.

In block 7DB, set InBar variable to next bar of input song, in a cyclic manner. Cyclic manner means that if reached last bar of input song, then next bar will be the first bar of input song.

For example: If input song has 4 bars, then, bar sequence would be: 1, 2, 3, 4, 1, 2, 3, 4, 1 . . . . This is also illustrated in FIG. 24A.

Another option for the cyclic implementation is to set a bar such that last bars are copied. This means that if input songhas N bars, and the required number of bars is M bars, where N<M, then in the last cycling bar, set the number, CyclicBar, to:

CyclicBar=((M−N)mod N)+FirstBar

For example, if InputSong has 4 bars, and required number of bars is 10, then:

CyclicBar=(6−4)mod 4+1=3

Bar sequence would be: 1, 2, 3, 4, 1, 2, 3, 4, 3 (CyclingBar), 4.

This is also illustrated in FIG. 24B.

**End of Method**

Method 7E0: Align and Copy an Input Bar to an Aligned Bar

This method aligns and copies an input bar (“InBar”), into an aligned bar (“AliBar”). InBar and AliBar are parameters for the method.

AliBar is a holds a new aligned bar, of the aligned song. Aligning the input bar means adding or removing timepoints and copying the resulted bar to the aligned bar.

When adding timepoints to a bar, notes are either duplicated or their length extended into the added timepoints. When removing timepoints from a bar, timepoints and their notes are removed. The aligned bar and its notes are copied into AliBar, and tables are updated.

FIG. 23B is a flow chart of the method for aligning InBar into AliBar

In block 7E1, compare number of timepoints in InBar and required number of timepoints. If InBar has less timepoints than required, then goto block 7E2. If InBar has more timepoints than required, then goto block 7E3. If InBar has same timepoints as required, then goto block 7E4.

In block 7E2, duplicate timepoints in InBar.

Duplicating a timepoint gets a source timepoint, and comprises the following steps:

1) Adding a timepoint at the end of a bar.

2) Copying the notes, note properties of the notes and controls from the source timepoint into the new timepoint.

3) Copying the chord and scale of the source timepoint to the new timepoint. This is done by updating Chords and Scales tables.

4) Adding 1 to the number of timepoints of that bar in the Bars Table (FIG. 5F).

Typically, this is done by duplicating the last timepoints of the bar. This means that if InBar has N timepoints, and the required number of timepoints is M bars, where N<M, then duplicate last N−M timepoints of InBar at the end of InBar. Duplicating timepoints means copying the timepoints to a new location in the bar.

Another option is to duplicate the first timepoints. If InBar has N timepoints, and the required number of timepoints is M bars, where N<M, then duplicate first N−M timepoints of InBar as new timepoints at the end of InBar.

Another option is to extend the length of the ongoing notes of the last timepoint, to the new timepoints length.

Another option is to duplicate random timepoints of InBar to the end of InBar.

The Implementation can either be hard-coded to one of the above detailed options, configured by the system or user, or chosen randomly.

Typically, this is done by duplicating quarters from InBar, where a quarter is 8 timepoints. For example: InBar is ¾ bar (24 timepoints). The Required number of timepoints is 4/4 bar (32 timepoints). Duplicating the last timepoints means to duplicate timepoints 16 to 23 (when counting from timepoint 0) to timepoints 24 to 31.

Duplicating the first timepoints means to duplicate timepoints 0 to 7, to timepoints 24 to 31.

In block 7E3, remove timepoints from InBar.

Removing a timepoint gets a timepoint, and comprise of the following steps:

1) Removing the notes, note properties of the notes and controls and the timepoint.

2) Shifting all timepoints and their content (notes and controls), that occur after the removed timepoint, 1 timepoint backward.

3) Updating timepoints in chords and scales tables.

4) Subtracting 1 from the number of timepoints of that bar in Bars Table (FIG. 5F).

Typically, this is done by removing timepoints at the end of the bar. This means that if InBar has N timepoints, and the required number of timepoints is M bars, where N<M, then remove last N−M timepoints of InBar.

Another option is to removing first timepoints of InBar, and shifting the remaining timepoints backwards.

Another option is to remove random timepoints of InBar.

Implementation can be hard-coded to one of the options, configured by the system or user, or chosen randomly.

Typically, this is done by removing quarters from InBar, where quarter is 8 timepoints. For example: InBar is 4/4 bar (32 timepoints). Required number of timepoints is ¾ bar (24 timepoints). Removing the last timepoints means to remove timepoints 24 to 31 (when counting from timepoint 0). Removing the first timepoints means to remove timepoints 0 to 7, and shifting timepoints 8 to 31 by 8 timepoints backwards (so that they become timepoints 0 to 23).

In block 7E4, copy notes of InBar to AliBar. This means that for every timepoint at InBar:

a. Create a timepoint value at AliBar.

b. Copy notes and controls from InBar's timepoint to AliBar's timepoint.

c. Copy note properties of the notes of InBar's timepoint to AliBar's timepoint.

In block 7E5, copy chords and scales of InBar to AliBar. This includes performing:

a. Copy the InBar's entry at Chords Table, denoted as c1.

b. Copy the InBar's entry at Scales Table, denoted as s1.

c. Update Bar Number of c1 to AliBar's Bar Number.

d. Update Bar Number of s1 to AliBar's Bar Number.

e. Append new entry at end of Chords Table.

f. Append new entry at end of Scales Table.

g. Copy c1 to new entry of Chords Table.

h. Copy s1 to new entry of Scales Table.

i. Update number of timepoints at AliBar to be the same as InBar.

In block 7E6, update Bars Table. Add new entry to Bars Table. Update the new entry with Bar Number and Timepoints of AliBar.

**End of Method**

FIGS. 24A-24C, FIGS. 25A-25B and FIG. 26A-26D illustrate examples of various alignment scenarios. In all of these examples, copying a bar means copying the entire contents of the bar, including the notes in all tracks, controls in all tracks, chords and scales of that bar.

FIGS. 24A-24C show examples of aligning an input song to a desired Bars-Structure with a different number of bars. These illustrations can be attributed to method 7D0.

FIG. 24A shows an example of an input song with 4 bars, and a desired Bars-Structure with 6 bars. In this example, when cyclic copy reached last bar of input song, it sets the next bar to be the first bar of the input song.
Bars 1 to 4 of input song are copied sequentially from the input song to the aligned song (X221, X222, X223, X224).
Since cyclic copy in the example restarts from the first bar, bar 1 of the input song is copied into bar 5 of the aligned song (X225), bar 2 of the input song is copied into bar 6 of the aligned song (X226).

FIG. 24B shows an example of an input song with 4 bars, and a desired Bars-Structure with 6 bars. In this example, when cyclic copy reaches the last bar of input song, it sets the next bar to be the last M−N bar, as described in block 7DB of method 7D0.

Bars 1 to 4 of the input song are copied sequentially from the input song to the aligned song (X231, X232, X233, X234).

Since cyclic copy in the example restarts from the last M−N bar, bar 3 of the input song is copied into bar 5 of the aligned song (X235), bar 4 of the input song is copied into bat 6 of the aligned song (X236).

FIG. 24C shows an example of an input song with 6 bars, and a desired Bars-Structure with 4 bars.

Bars 1 to 4 of the input song are copied sequentially from the input song to the aligned song (X241, X242, X243, X244). Bars 5 and 6 of the input song are ignored.

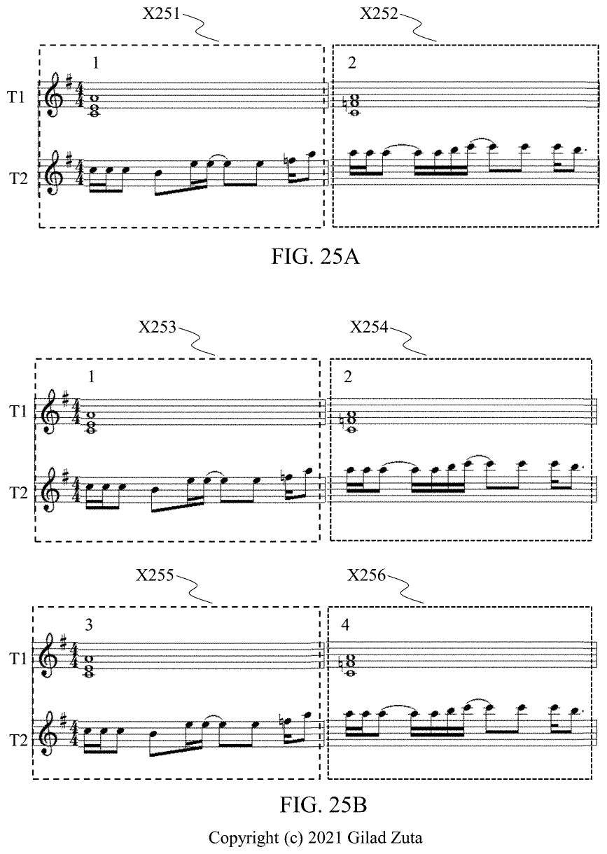

FIGS. 25A to 25B show an example using notes notation of aligning input song that has 2 bars, to a desired Bars-Structure of 4 bars. This example can be attributed to method 7D0.

FIG. 25A shows the input song. The Input song has 2 bars, each bar contains 2 tracks denoted as “T1” and “T2”. Notes of bar 1 are denoted as “X251”, notes of bar 2 are denoted as “X252”.

FIG. 25B shows the aligned song. The aligned song has 4 bars, which is the desired Bars-Structure in this example.

Bars 1 and 2 are copied from input song to aligned song:
Notes of bar 1 of the aligned song (X253) are copied from bar 1 of the input song (X251).
Notes of bar 2 of the aligned song (X254) are copied from bar 2 of the input song (X252).

Bars 3 and 4 of the aligned song are duplicated from bars 1 and 2 of the input song:
Notes of bar 1 of the aligned song (X255) are copied from bar 1 of the input song (X251).
Notes of bar 2 of the aligned song (X256) are copied from bar 2 of the input song (X252).

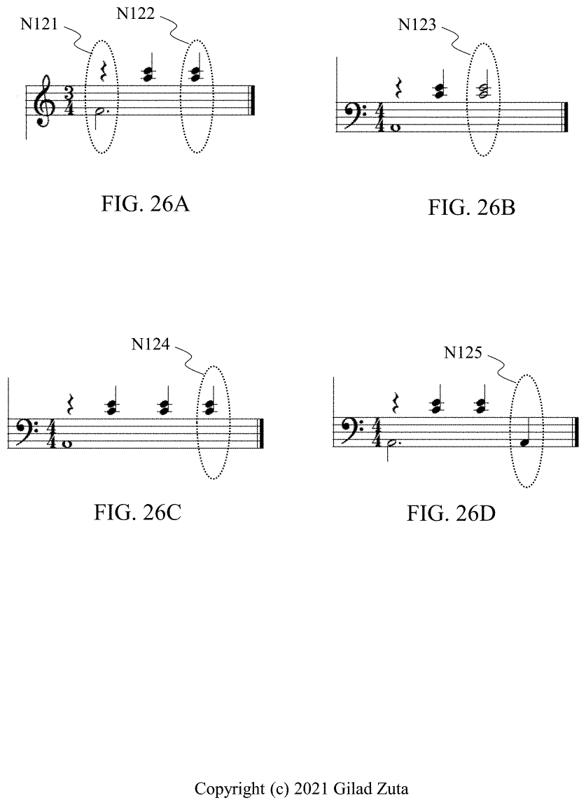

FIGS. 26A to 26D show an example of extending the number of timepoints of a bar. This illustrates the options as explained in block 7E2 of method 7E0.

FIG. 26A is an example an input bar with ¾ time signature. The input bar in this example has 24 timepoints.

N121 denotes note that starts the first quarter (timepoint 0) of the bar.

N122 denotes notes that start at last quarter (timepoint 16) of the bar.

FIG. 26B is an example of an output, aligned bar with a 4/4 time signature, by extending the last quarter notes option.

The Input bar is shown in FIG. 26A. The last quarter notes, N122 (FIG. 26A) are extended to the new bar length (32 timepoints), creating longer notes. N123 denote the notes replacing the previous N122 notes.

FIG. 26C is an example of an output, aligned bar with 4/4 time signature by duplicating the last quarter notes option.

The Input bar is shown in FIG. 26A. The last quarter notes, N122 (FIG. 26A) are duplicated to the new quarter of the aligned bar, creating new notes (N124). The aligned bar length is 32 timepoints.

FIG. 26D is an example of an output, aligned bar with 4/4 time signature by duplicating first quarter notes option.

The Input bar is shown in FIG. 26A. The first quarter note, N121 (FIG. 26A) is duplicated to the new quarter of the aligned bar, creating new notes (N125). The aligned bar length is 32 timepoints.

Analyze and Transform: Additional Implementations

Analyze song (Method 720) and transform song (Method 760), show a common implementation for creating a new song from an input song.

Additional embodiments are shown in this section.

### Embodiment #1: Transform a Note (Method 210)

Another embodiment for transforming a note is to add randomness when choosing a new note value. Adding randomness can be done for example by modifying block 216: Instead of always choosing the note with minimal distance, choose randomly among the notes that have the same note type and have a distance that is smaller than a threshold. Find a set of K notes that have the smallest distances, then choose randomly among them.

### Embodiment #2: Compute Distance Between Notes (Method 940)

Another embodiment is to calculate Note-Chord-Distance in a clockwise direction instead of counterclockwise direction. This is implemented by changing block 944 of Method 940 to increase Note12:

Increase Note12 by 1 mod 12

### Embodiment #4: Compute Distance Between Notes (Method 940)

Another embodiment is to calculate Note-Chord-Distance between note to chord note by doing modulo 12 only to the note, and not to the note chord. Then, when transforming a note, using Note-Type to calculate distance to candidates with similar Note-Type as the note to be transformed.

Then, for example, the distance of the transform can be calculated using:

If (OrigNote.NoteType==CandNote.NoteType) then

Distance=(Abs(OrigNote.NoteChordDistance[0]−CandNote.NoteChordDistance[0])+Abs(OrigNote.NoteChordDistance[1]−CandNote.NoteChordDistance[1])+Abs(OrigNote.NoteChordDistance[2]−CandNote.NoteChordDistance[2]))+Abs(CandNote.Note−OrigNote.Note)

Else

Distance=MaxInt

Using any Other Timescale Instead of Bars and Timepoints

Other embodiments can use any other timescale instead of Bars and Timepoint, such as computer clock ticks, milliseconds etc. The same timescale is preferably used in all tables and methods, such as Chords Table (FIG. 4F), Scales Table (FIG. 4G), Note events (FIG. 5D), Bars Table (FIG. 5F), Analyze Track method 730, Transform Track method 770, Align Bars-Structure method 220, etc.

For example, one embodiment for using a different timescale, when working with MIDI files or SNT files, is to use absolute times along a shared, common timeline instead of bar numbers and timepoints.

In this implementation, bars are not calculated. There is no Bars Table.

Events use Absolute Time values, stored in Event.AbsTime.

Chords Table and Scales Table have Absolute Time values instead of a Bar Number and a Timepoint Number.

SNT Events are organized per track by Absolute time.

In Analyze and Transform methods, instead of iterating over bars and timepoints, doing iteration on events, which are sorted by their Absolute times.

Use Other File Formats Instead of the SNT Format

Other embodiments can use other file formats directly, instead of creating SNT files.

For example, one embodiment when working with MIDI files, is to store information in MIDI files directly, without creating SNT files.

In this implementation, the Analyze song method stores additional information, such as chords table, scales table and notes properties by inserting ‘text’ events. The Transform song method parses these ‘text’ events.

Use a Separate File Instead of the SNT Format

Another embodiment is to store the additional information, such as chords table, scales table, bars and timepoints of notes in a separate file, in addition to the input song. Thus, continue to work with the input song without converting it to SNT file, and using the separate file as a supplement.

Transform Track without Chords and/or Scales Table

As shown in FIG. 13B, in block 733, the system keeps track of the current scale by searching for scale in Scales Table. Scales Table is typically provided by the user, in the User Config File 106, as shown in FIG. 4A.

Another embodiment to Method 770, is to address the problem when the user did not provide Scales Table.

One embodiment is to have the system configured to a default scale. The configured scale is expected to remain unchanged throughout the song. In block 733, instead of searching the Scales Table, the system uses the configured scale.

Part 4: Create a New Song

Part 2 shows methods to transform an input song according to new chords and/or new scales. This part shows a novel method to create a new song based on a user's input song (method 230). Some of the blocks in method 230 are the methods introduced in Part 2.

Benefits

Creating a new song has the following benefits, among others:
Enable users who are music creators to automate the music arrangement step of music production. This automation saves time and effort for the users.
Enrich music creativity by suggesting new notes and/or new chords and/or new scales.
Entertain and increase people's well being.
Diversify music creation. Creating new song versions diversify the use of notes and instruments in the songs, this assists the music creator in finding an optimal song version.
Diversify playback of given musical compositions. A musical composition can sound differently each time it is being played.
To diversify songs used in videos and games. Videos and games can use different versions of the song, that can improve the user experience.
To be used as a musical game for kids or people with no background in music.
To be used for hobbyists that like to play or wish to learn music.
To be used for musicians who wish to practice playing music.
Add instruments that will accompany professional or hobbyist musicians, while playing for practice, fun and so on.
To be used as a tool for professional music creators.
Increase engagement and listening to music.
Increase creativity of musicians who create music by suggesting new musical ideas for them.

People sometimes find it hard to create and to come up with creative new musical ideas. By creating new song versions, new musical ideas are added to the song.

Novel Approach to Create New Songs

Novelty in the create new song method includes, among others:

a. It creates new songs, that are different versions of an input song, and are harmonic to the chords and scales of the input song.

b. It uses other songs for creating the new song. It adds tracks from other songs.

c. It uses analyze, align and transform song novel methods.

d. It supports input song with any Bars-Structure (number of bars, timepoints in bar).

e. It supports any input song's chords and scales.

f. It can add randomness to generate different versions of songs.

h. It supports performing a sequence of predefined commands on the input song for creating the new song. Commands types for example are: ‘Add arrangement’, ‘Add track’, ‘Replace track’.

i. Any number of songs can be created.

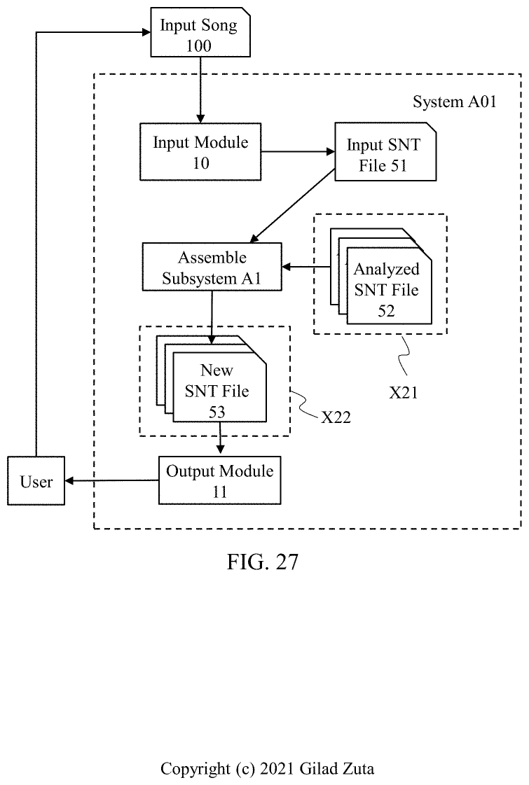

FIG. 27 Shows the Create New Songs System Overview (System A01).

A user provides an Input Song (100). The Input song (100) may contain a user's melody, chords and scales. Input Module 10 converts a user's Input Song (100), to Input SNT file (51). X21 denotes a set of analyzed songs. The system contains a set of analyzed songs (X21), each analyzed song may be in the format of an Analyzed SNT file (52). Assemble Subsystem A1 reads the Input SNT file (51), and uses tracks from analyzed songs (X21) to create multiple new songs (X22), each new song is in an SNT file (53). The new songs (X22) are new song versions of the input SNT file (51). The new songs (X22) have the same melody, and typically the same chords and scales as the input SNT file (51), but they have new tracks and notes that were transformed from analyzed songs (X21) to the input song's chords and scales.

The new songs (X22) are conveyed to the user through the Output Module 11; for example, they can be shown on screen, played on speakers, downloaded as MIDI, MP3, sent to DAW, etc.

The analyzed songs (X21) can be human made (i.e. artists, musicians, music fans, etc.), and/or machine generated (AI composers, algorithms, software, scripts, computer programs, etc.). They can be made manually or automatically.

Method for Generating a New Musical Composition in a Digital Format

A method for generating a new musical composition in a digital format, using a group of one or more existing musical compositions, comprising:
a. getting an input musical composition with its chords and scales;
b. setting chords and scales for the new musical composition;
c. selecting one or more musical sections from the existing musical compositions;
d. if the selected musical sections do not include note properties, then computing properties for all notes in the selected musical sections, according to the chords and scales of the selected musical compositions;
f. transforming the selected musical sections using the values and notes properties of the notes in the selected musical sections, according to the chords and scales of the new musical composition;
g. generating the new musical composition, wherein the new musical composition comprises the input musical composition and the transformed musical sections.

**End of method**

Comments Re the Above Method

1. Transforming the selected musical sections may further include aligning a number of bars and time signatures of each selected musical section to be equal to the number of bars and time signatures of the input musical composition.

2. Generating the new musical composition may further include removing one or more notes or tracks from the input musical composition.

3. Setting chords and scales for the new musical composition may comprise using chords and scales of the input musical composition which are modified using selected musical compositions from the group.

4. The method G3 may further include getting a list of commands; generating the new musical composition may be done by performing the list of commands.

5. The input musical composition and/or the new musical composition may be MIDI files.

6. Musical sections may be selected by selecting tracks from the input musical composition.

7. Transforming the selected musical sections may comprise, for each input note:
a. getting the input note and its note properties;
b. getting a new chord and a new scale for the input note;
c. generating a list of notes candidates;
d. computing distances between the input note and every note in the list, using input note's value, input note's note properties, candidate note's value and candidate note's note properties;
e. finding the candidate that has the minimal distance;
f. setting a new note value using a note value of the candidate with the minimal distance.

8. The note properties may include one or more of the following:
a. one or more note-chord distances, comprising a distance to the root note of the chord and optionally distances to the other notes of the chord;
b. note type, which can be either shared with other notes or unique for the note, wherein the shared note type can be either harmonic, scale or non-scale, and wherein the unique note type can be either harmonic-0, harmonic-1, harmonic-2 or scale-0, scale-1, scale-2, scale-3, scale-4, scale-5, scale-6, scale-7, scale-8 or scale-9.

Method 230: Create a New Musical Composition

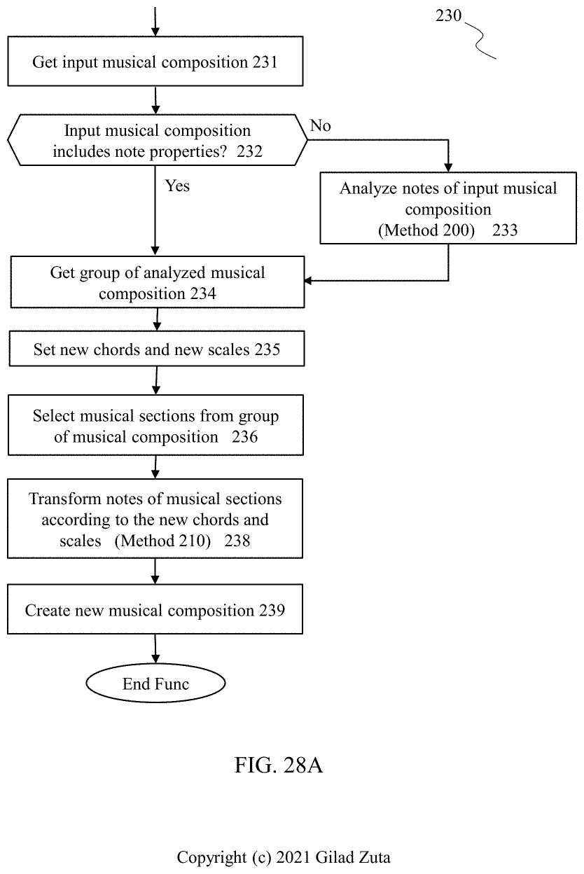

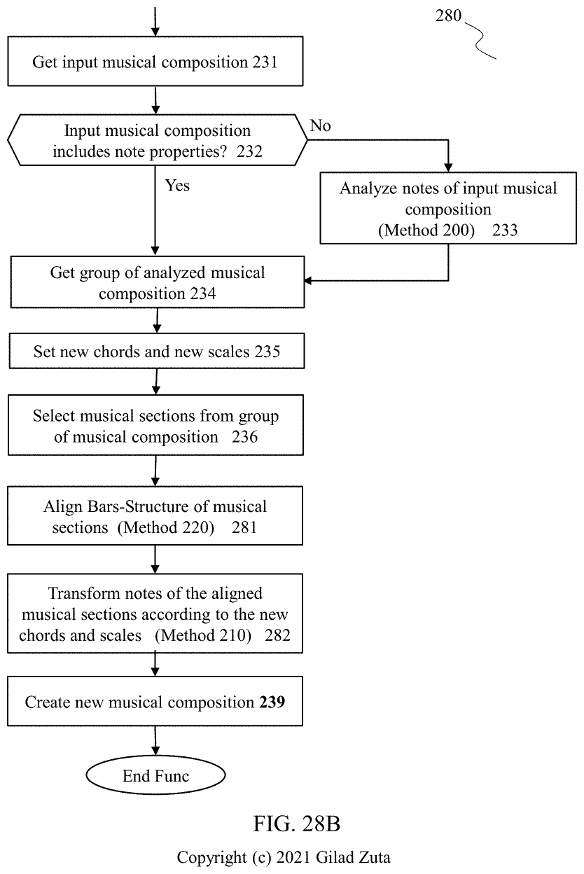

FIG. 28A is a flow chart of a method for creating new musical composition.

In block 231, get an input musical composition. For example, this can be an input song with its chords such as Input SNT File 51, as shown in FIG. 27.

An Input musical composition typically contains one or more tracks. Tracks can include notes and/or controls events, or be empty of events. An Input musical composition may include a melody track, or not have a melody track in it.

In block 232, check if the input musical composition includes note properties. If yes then goto block 234, otherwise goto block 233.

In block 233, analyze the notes of the input musical composition, as detailed in Method 200, This is done according to input musical composition's chords and scales.

In block 234, get a group of analyzed musical compositions. This can be a set of analyzed SNT files (X21), as shown in FIG. 27.

In another embodiment, a group of analyzed music compositions contains musical compositions that have similarity to the input musical composition, such as same genre, same song part type, etc.

In another embodiment, a group of analyzed music compositions contains musical compositions that have dissimilarity to the input musical composition, such as different genre, different song part type, etc.

In another embodiment, a group of analyzed music compositions contains musical compositions that are selected based on user preferences, such as a specific genre, song part type, music composition that were created by a specific artist etc.

In block 235, set new chords and new scales.

In one embodiment, the new chords and new scales are the chords and scales of the input musical composition.

In another embodiment, the new chords and new scales are the chords and scales of the input musical composition with modification that are done using chords and scales from the group of analyzed musical compositions. For example, by replacing chords and scales of a specific bar with chords and scales from an analyzed musical composition.

In another embodiment, store a history of the chords and scales that are modified from the input musical section, such that the new musical composition differs from the new musical compositions already generated.

In block 236, select musical sections from a group of musical compositions.

Musical sections can contain the bars of a track, or bars of multiple tracks, of a song,

In block 238, transform notes of the selected musical sections according to the new chords and scales, as detailed in Method 210.

In one embodiment, this is done by transforming the selected tracks of block 236.

In block 239, create a new musical composition. The new musical composition comprises the input musical composition and the transformed musical sections.

In another embodiment, the new musical composition comprises the input musical composition with some of its tracks removed, and the transformed musical sections.

In another embodiment, the new musical composition comprises the melody track of the input musical composition, and the transformed musical sections.

**End of Method**

Regarding selecting musical sections in block 236:

One embodiment of selecting musical section comprises of:

1. Randomly select a track is from the group of analyzed musical composition. Optional is to randomly select a track that is not a melody track.

2. Musical sections are the bars that the selected track contains.

Another embodiment of selecting musical section comprises of:

1. Randomly select a musical composition from the group of analyzed musical composition.

2. Musical sections are the bars of the tracks that the selected musical composition contains.

Optional is to select all the tracks of the musical composition excluding the melody track.

Another embodiment of selecting musical section is performed according to criteria given by the user or configured to the system. Example of criteria:
Selecting a drum track.
Selecting a non-drum track.
Selecting a track of a specific instrument.
Selecting a track of musical compositions of a specific genre.

Another embodiment of selecting musical section is done by the user. The user chooses the specific tracks that he wants to add.

An optional addition to select a musical section includes storing a history of selected musical sections, such that the new musical composition differs from the new musical compositions already generated. If the new musical composition is identical with a previous version, then create a new musical composition instead of the last created musical composition, and repeat these operations.

Method 280: Create a New Musical Composition with Alignment

FIG. 28B is a flow chart of another method for creating new musical composition.

Blocks 231-239 are the same as in Method 230, shown in FIG. 28A.

In block 281, align Bars-Structure of musical sections, as detailed in Method 220.

Musical sections are the selected in block 236.

In block 282, transform notes of the aligned musical sections according to the new chords and scales, as detailed in Method 210. Aligned musical sections are the created in block 281.

Song Creation Commands

The create a new song method (method 800) uses commands for describing the modifications being made for the new song being created. “Command-Sequence” is a sequence of commands that are being performed on an input song to create a new song. Example of commands are: Add-Track, Remove-Track, Replace-Track, Add-Arrangement and Add/Replace-Track.

Example of commands that can be applied when creating the new song:
a. Add-Track—adds a track from another song, that is not the melody track, to the new song. Example of this command is shown in FIGS. 47A-47J.
b. Remove-Track—removes an existing track from the new song.
c. Replace-Track—removes an existing track, that is not melody track, from the new song, then adds a new track from another song to the new song.
d. Add-Arrangement—add all tracks, except melody track, from another song to the new song. Example of this command is shown in FIGS. 42A-42G.
e. Add/Replace-Track—choosing between Add-Track command and Replace-Track command, by the system or user, and then performs the chosen on the new song.

Four commands that are typically used in creating new songs: Add-Track, Replace-Track, Add-Arrangement and Add/Replace-Track.

In another embodiment, the system is so configured that Add-Track can also add melody track, from another song to the new song.

In another embodiment, a special command can add the melody track, from another song to the new song.

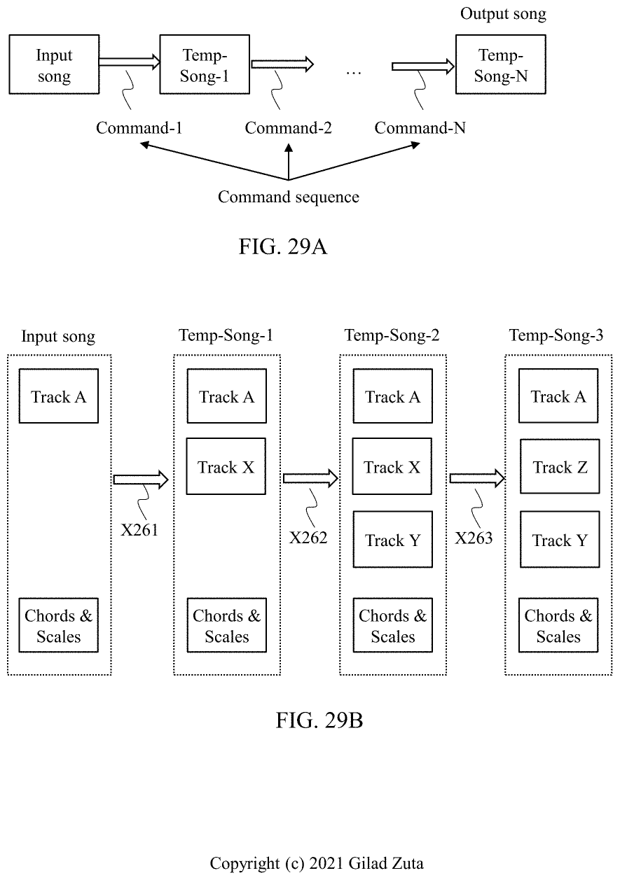

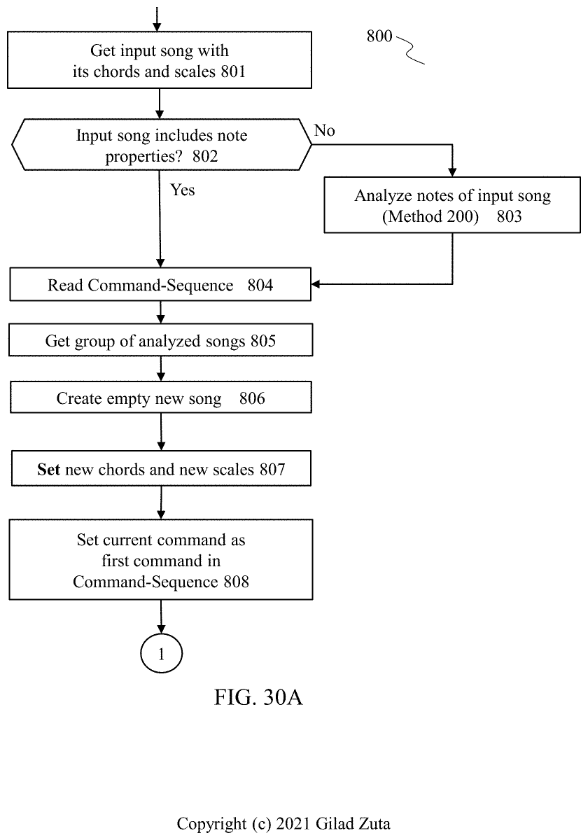

FIGS. 29A to 29B illustrate the commands being used by creating new songs method (method 800).

FIG. 29A shows Command-Sequence performed on an input song to create a new song.

Command-Sequence comprises the Command-1, Command-2, and so on, until Command-N.
Receiving an input song, such as input SNT File 51.
Performing a first command in Command-Sequence, Command-1, on the input song. The output is a temporarily song, Temp-Song-1.
Performing a second command in Command-Sequence, Command-2, on Temp-Song-1. The output is a temporarily song, Temp-Song-2.
And so on, until performing last command in Command-Sequence, Command-N. The output is Temp-Song-N, which is the output song, such as new SNT file 53.

Performing the commands in the Command-Sequence modifies the tracks of the input song until reaching the song's final version, Temp-Song-N, which is the new song. Command-Sequence can be customized or configured. Each time a command is being applied, it creates a new temporarily song version, until reaching the final version, which is written as the output, new SNT File 53.

Examples of command sequences:
{Add-Arrangement}—Adds all tracks except melody from another song.
{Add-Track, Add-Track, Add-Track}—adds 3 tracks from other songs.
{Add-Arrangement, Replace-Track, Add-Track} Adds all tracks except melody from another song, replaces existing track (that is not melody) with track from another song, adds track from another song.

To add a track, the track is first analyzed, aligned and transformed to input song's Bars-Structure, chords and scales, as shown in block 80A in method 810.

FIG. 29B is an example of Command-Sequence performed on an input song.

Command-Sequence contains 3 commands: {Add-Track, Add-Track, Replace-Track}.

Input song contains 1 track: A track denoted as “Track A”.

Performing the first command of Command-Sequence, Add-Track (X261), result in creating Temp-Song-1. Temp-Song-1 contains 2 tracks: “Track A” and “Track X”.

“Track A” is the track copied from the input song. “Track X” is a new track that Add-Track command (X261) added. Performing the second command of Command-Sequence, Add-Track (X262), result in creating Temp-Song-2. Temp-Song-2 contains 3 tracks: “Track A”, “Track X” and “Track Y”. “Track A” and “Track X” are the tracks copied from Temp-Song-1. “Track Y” is a new track that Add-Track command (X262) added.

Performing the third command of Command-Sequence, Replace-Track (X263), result in creating Temp-Song-3. Temp-Song-3 contains 3 tracks: “Track A”, “Track Z” and “Track Y”. “Track A” and “Track Y” are the tracks copied from Temp-Song-2. “Track Z” is a new track that replaces “Track X” by Replace-Track command (X263).

Method 800: Create a New Song

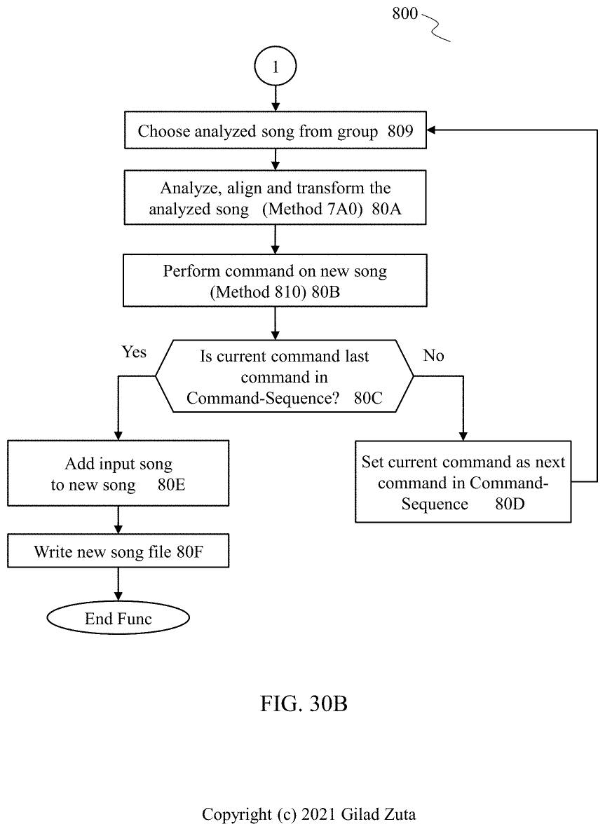

FIGS. 30A-30B are flow charts of a method for creating a new song.

This method is an embodiment for methods 280.

This method can be an embodiment for methods 230 by changing block 80A, to use Method 750 instead of using Method 7A0.

In block 801, get an input song with its chord and scales. Set it to New-song variable, this variable represents the output song, new song (53) in SNT format.

In block 802, check if input song includes note properties. If yes then goto block 804, otherwise goto block 803.

In block 803, analyze notes of input song, as detailed in Method 200, This is done according to input song's chords and scales.

In block 804, read the Command-Sequence. A User or a system can configure the Command-Sequence to be used for creating the songs. The Command-Sequence can also change per song created.

The Default Command-Sequence is {Add-Arrangement}.

In block 805, get a group of analyzed musical compositions. In this embodiment, there are analyzed SNT files (X21), as shown in FIG. 27.

In block 806, create an empty new song, store it in New-song variable. New-song variable represents the output song being created in this method. In a typical embodiment, a new song is in SNT format.

In block 807, set new chords and new scales. In this embodiment, the new chords and new scales are the chords and scales of the input song. This sets the Bars-Structure, chords and scales of the new song to be the same as the Bars-Structure, chords and scales of the input song.

In block 808, set the current command as first command in the Command-Sequence.

In block 809, choose a random analyzed song, Analyzed SNT file 52, from the set of analyzed songs (X21).

In block 80A, apply analyze, align and transform input method (Method 7A0) on the analyzed song that was chosen in block 809. This method aligns the analyzed song to have the same Bars-Structure, as the new song, and transforms the notes of the analyzed song according to the chords and scales of the input song that were set in block 807.

In block 80B, perform a command on new song, as detailed in Method 810.

Perform the current command, which is part of the Command-Sequence, on the new song. The Method gets as parameter the analyzed song that is chosen in block 809.

In block 80C, check if the Command is last command in the Command-Sequence. If yes, then goto block 80D. Otherwise, goto block 813.

In block 80D, Set the current command as next command in the Command-Sequence.

In block 80E, add the input song to new song. Update the Tracks Table of the new song.

One option is to add all tracks of the input song to the new song.

Another option is to add only a melody track of input song to the new song. The Input song's melody track is obtained using input song's Melody-Track-Number. Copy input song's melody track, with all of its notes and controls, into the new song. Update Melody-Track-Number to point to the added melody track in the new song. Add the melody track to new song's Tracks Table.

In block 80F, write the new song to file. Write the new SNT File (53), which is part of X22 (FIG. 27).

This also copies the Labels Table and the Header (FIG. 5B) from the input song into the new song.

The Bars-Structure of the new song is identical to the Bars-Structure of the input song.

**End of Method**

In Another embodiment, use history to prevent choosing the same song twice in block 809. This can be done for a specific input song and/or for a specific user. For example, if an analyzed song named ‘S100’ was chosen with the Add-Arrangement command when creating a previous new song for a particular user, then the song ‘S100’ can be prevented from being chosen again in block 809 for that specific input song and/or user.

In Another embodiment, perform the Analyze, align and transform method (Method 7A0), on chosen tracks instead of chosen songs. Instead of running Method 7A0 on the chosen song, as done in block 80A, run the method 7A0 on the selected tracks to be added, in blocks 812 and 816 of Method 810.

Method 810: Perform a Command on New Song

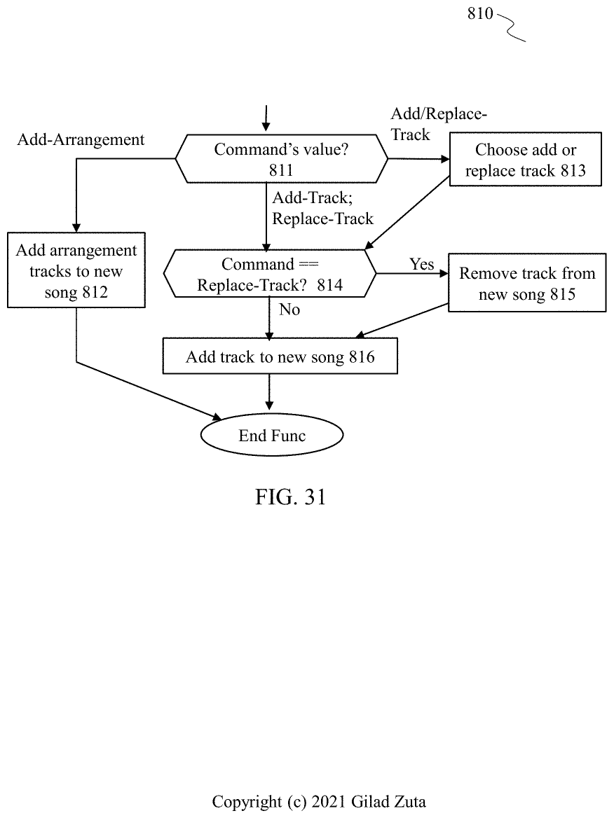

FIG. 31 is a flow chart of a method for performing a command on new song.

The method gets as input: An analyzed song, a command to perform using the analyzed song, and a new song on which the command is performed.

The method outputs: A New song, after performing the command on it.

In block 811, check command's value. If it is Add-Arrangement command, then goto block 812.

If it is Add-Track command or Replace-Track command, then goto block 814.

If it is Add/Replace-Track command, then goto block 813.

In block 812, add arrangement tracks of the analyzed song to the new song.

Copy all analyzed song's tracks, except the melody track, with all their notes and control events, into the new song. Update the new song's Tracks Table with the new tracks added.

If the tracks are drum tracks, then a drums channel is assigned to these tracks. If not a drums tracks, then channels that are not used by existing tracks are searched and allocated for these tracks.

In block 813, choose between the Add-Track command and Replace-Track command, store the result as the current command. This decides which command should be done: Add-Track command or Replace-Track command. The Configuration of the system determines how that decision is made.

Options for how to choose between Add-Track command and Replace-Track:

One option is it to count every new song created, and configure which songs will have Add-Track and which songs will have Replace-Track based on this counting. Such configuration can be done by the user or by the system's developer. For example, when creating 10 new songs using this method, configure that the first 4 songs will get Replace-Track command and the remaining 6 songs will get Add-Track.

Another option is to choose randomly between the Add-Track command and Replace-Track command. This can be done given a probability p for Add-Track command and 1−p for Replace-Track command.

Another option is to let the user decide at the time the song is being created, or at the time this block is reached.

In block 814, check if the command is Replace-Track command. If yes then goto block 815, otherwise goto block 816.

In block 815, choose randomly an existing track to remove, from the new song.

A Track is removed with all its note and control events. Update the new song's Tracks Table.

In block 816, randomly choose a track to be added from the analyzed song to the new song. It is optional to configure that the randomly selected track to be added from an analyzed song is not a melody track.

Adding a track comprises copying the track, with all of its notes and control events, from the analyzed song into the new song.

If the added track is a drums track, then a drums channel is assigned to the track. If it is not a drums track, then a channel that is not used by the existing track is searched and allocated for the added track.

Add the track to New-song's Tracks Table.

In Another embodiment, when replacing a track, blocks 815 and 816 can optionally be coordinated. Such coordination can be for example, to replace tracks that are more similar to one another. This can make the replacement smoother. For example, replace a drums track with another drums track.

In Another example, replace a track with a bass instrument with another track of a bass instrument. In Another example, replace a track with notes in specific octaves with a track in similar octaves.

In Another example, replace a track with many short length notes with a track that has many short notes.

Another type of coordination is to replace tracks that are less similar to one another. This can increase creativity and originality by breaking conventional patterns of thinking. For example, replace a non-drums track with a drums track. In Another example, replace a track that has many short length notes, with a track that has little long length notes.

This coordination is optional. If set, it can be pre-configured by the user, or decided by the user before the step is performed, or can be chosen randomly. If the chosen coordination is not possible, then a different coordination can be chosen, or this option can be disabled.

### Example

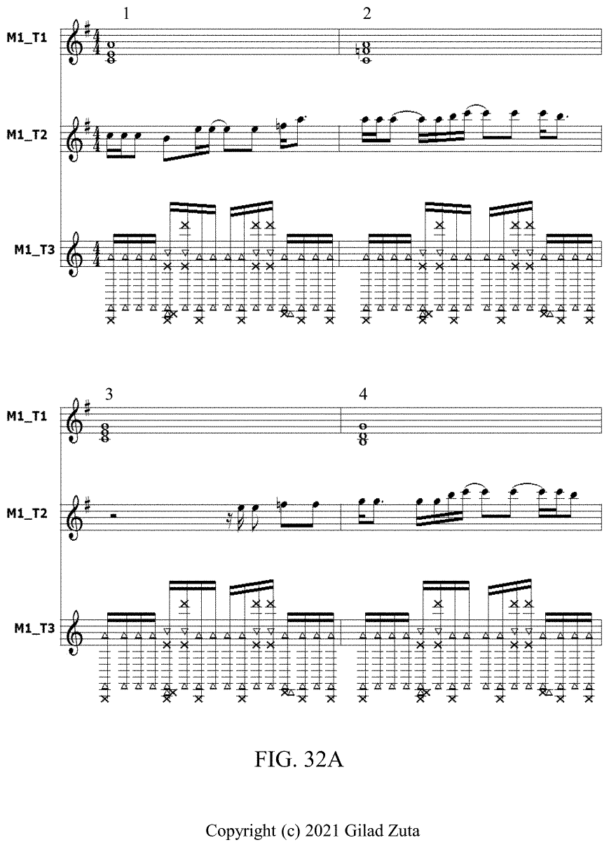

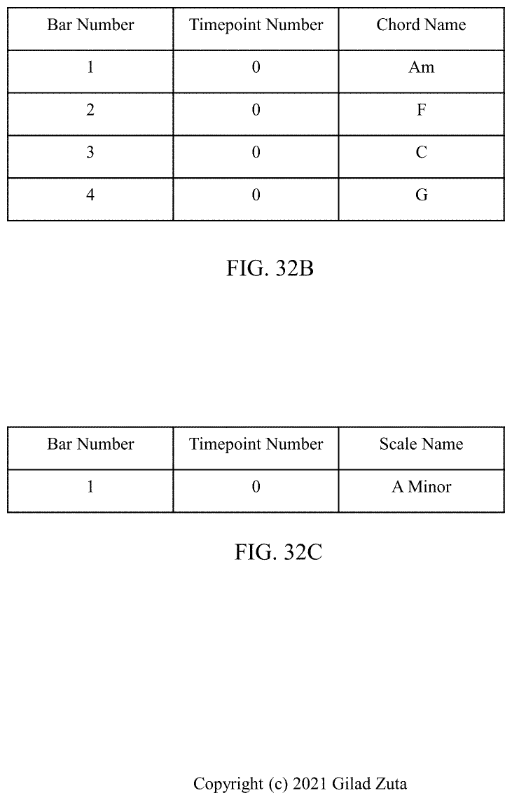

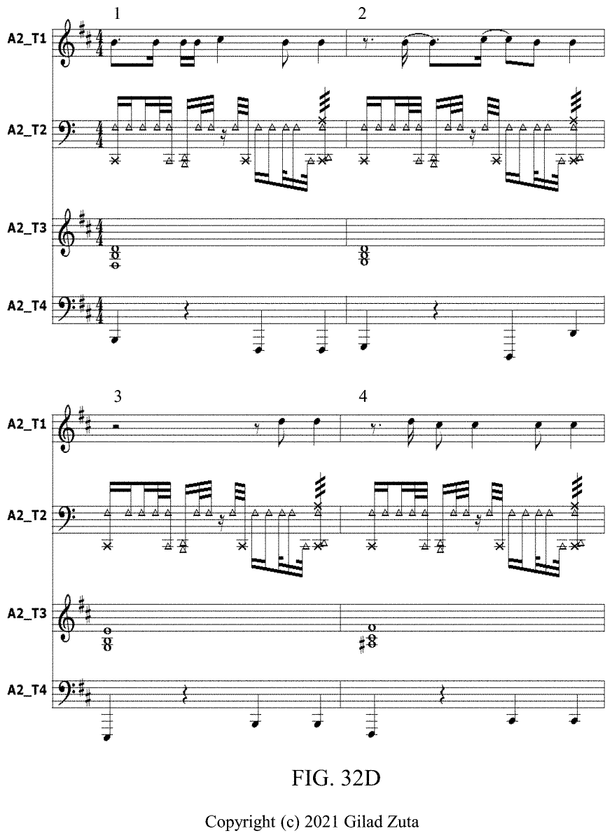

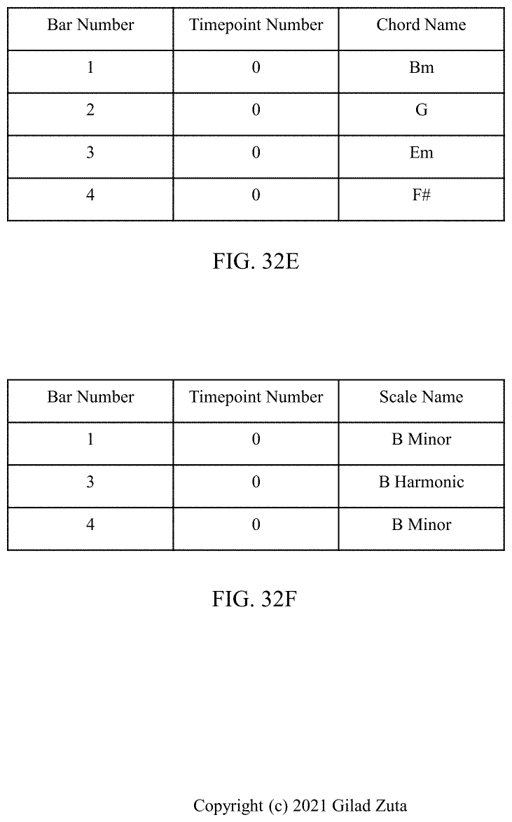

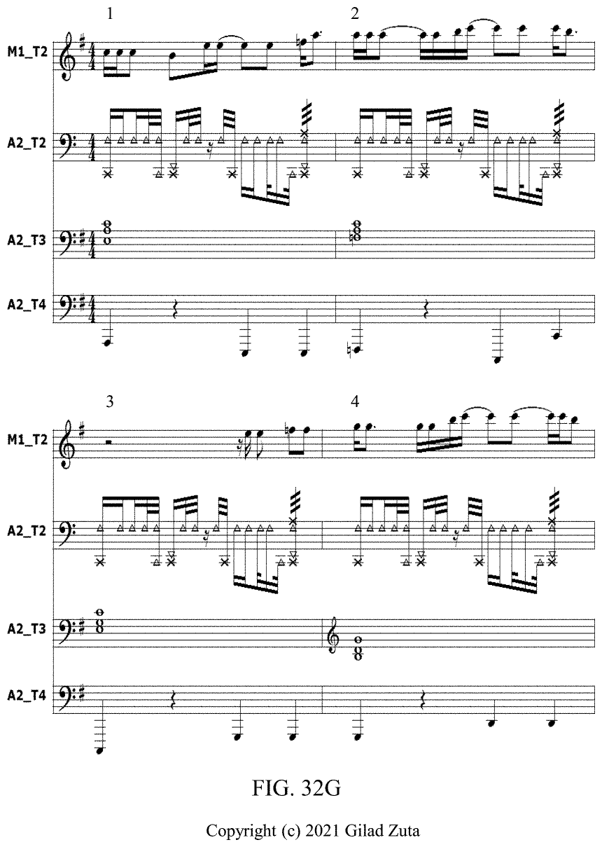

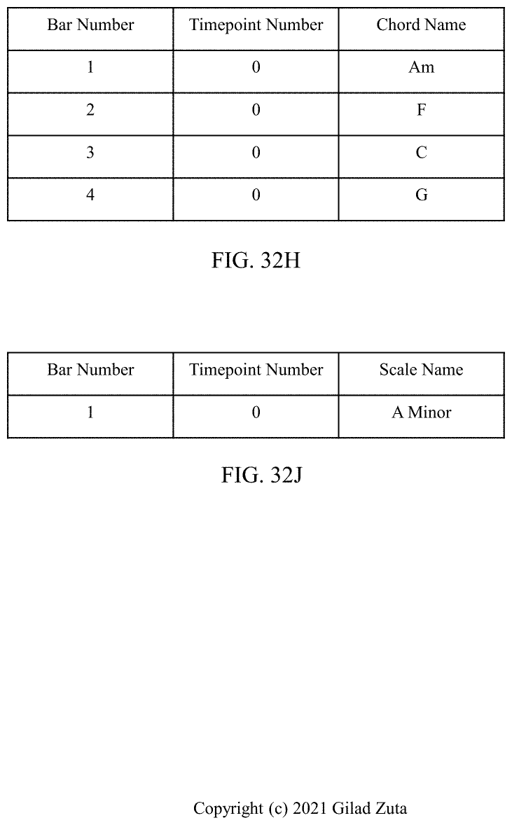

FIGS. 32A to 32J show an example of create new song method (Method 800).

The Command-Sequence used in this example comprises one command: {Add-Arrangement}

FIGS. 32A to 32C illustrate an input song. The Input song can be provided by the user.

FIGS. 32D to 32F illustrate an analyzed song, chosen to be used for creating the new song. The analyzed song is an example of an Analyzed SNT File 52, that is chosen from X22 (FIG. 27) by block 809 of method 800.

FIGS. 32G to 32J illustrate the new song that is created by Method 800.

FIG. 32A shows input song's notes. The input song has 4 bars, and contains 3 tracks: “M1_T1”, “M1_T2” and “M1_T3”. “M1_T2” track is the melody track. “M1_T3” track is a drums track.

FIG. 32B shows input song's Chords Table. There are 4 chords used in the input song, shown in FIG. 32A, which are: Am, F, C and G.

FIG. 32C shows input song's Scales Table. The entire song is in ‘A Minor’ scale.

FIG. 32D shows an analyzed song's notes. The analyzed song has 4 bars, and 4 tracks: “A2_T1”, “A2_T2”, “A2_T3” and “A2_T4”. “A2_T1” is its melody track. “A2_T2” is a drums track.

FIG. 32E shows an analyzed song's Chords Table. There are 4 chords in this song.

FIG. 32F shows an analyzed song's Scales Table. There are 3 scales in this song.

FIG. 32G shows a new song's notes. A new song is created by method 800 using input song (FIGS. 32A-32C) and analyzed song (FIGS. 32D-32F). The new song is created by taking input song's melody tracks, and adding tracks from an analyzed song. The input song is shown in FIGS. 32A to 32C. The chosen analyzed song is shown in FIGS. 32D to 32F.

Input song: Track “M1_T2” is added because it is the input song's melody track.

Analyzed song:

The Command-Sequence used for this example is configured as one command: Add-Arrangement.

The Add-Arrangement command adds all tracks, except the melody track, of the analyzed song.

The Melody track of the analyzed song is “A2_T1”.

The analyzed song's tracks, excluding the melody track of the analyzed song, are tracks “A2_T2”, “A2_T3” and “A2_T4”. Therefore, tracks “A2_T2”, “A2_T3” and “A2_T4” are added to the new song.

Running analyze, align and transform (method 7A0) on the analyzed song.

The Analyzed song has the same Bars-Structure as the input song, therefore alignment does not change the analyzed song's Bars-Structure. Transforming Analyzed-song changes its notes according to the chords and scales of the input song (shown in FIGS. 32B and 32C).

The “A2_T2” track is not changed by the transform because it is a drums track.

The Melody track of input song is “M1_T2”, it is added to the new song.

The resulting new song is shown in the figure. It comprises:
The input song's melody track, “M1_T2”.
The Analyzed-song's tracks: “A2_T2”, “A2_T3” and “A2_T4”. The Notes of “A2_T4” track are copied unchanged from the input song because it is drums track. The Notes of “A2_T3” and “A2_T4” tracks are transformed according to the input song's chords and scales, as detailed in method 7A0.

FIG. 32H shows a new song's Chords Table. They are the same as the input song's Chords Table. This is as expected, because they were copied from the input song (in block 807 of method 800).

FIG. 32J shows a new song's Scales Table. They are the same as the input song's Scales Table. This is as expected, because they were copied from the input song (in block 807 of method 800).

### Embodiments for Choosing a Song Using Criteria (Block 809 of Method 800)

FIG. 27 shows X21, a set of analyzed SNT files (52).

Block 809 of method 800, chooses an analyzed song, a random song from X21.

Another embodiment for choosing an analyzed song, is to choose a song from the set of songs in X21 using criteria or rules set by the user or system.

Examples of such criteria:

a. Choose a song that has a high similarity to the input song.

This can makes adding or replacing tracks smoother as the songs are similar.

For example:
Choose a song that has the same labels in the Labels Table as input song, such as same genre, same mood, same song part type (such as both are ‘verse’), or any combination of labels.
Choose a song that has a similar Bars-Structure.
Choose a song that has some chords or scales in common.
Choose a song that has the same bar and timepoint of chord or a scale change in common.

b. Choose a song that has low similarity to a user's input song to X21.

This can makes adding or replacing tracks give more surprising results and break conventions.

For example
Choose a song that has different labels in the Labels Table than the input song, such as a different genre, Different mood, different song part type (such as one is ‘chorus’ and the other is ‘verse’), or any combination of labels.
Choose a song that does not have chords or scales.
Choose a song that does not have the same bar and timepoint of chord or scale change.

c. Add songs that have a combination of low and high similarity to user's input song to X21.

For example:
Choose a song that has the same genre but a different part type.
Choose a song with a different genre but same Bars-Structure.

Part 5: Iterative Creation of Songs

Part 4 shows a method to create new songs based on a user's input song (method 800).

This part shows a novel method that searches for optimal version of a song (method 290). This method is performing iterations that are comprised of: creating multiple new songs from an input song (Method 240), get user's satisfaction feedback from a user and setting the song with the highest value of user's satisfaction as the input song for the next iteration. This method (Method 290) uses the user's subjective feedback to optimize the search for the optimal song version.

A benefit for the users is that it increases the probability of getting higher score songs. By iteratively making changes to highest scored songs to create new songs, the iterative process increases the probability of getting higher scored songs. A progressively improved song can be achieved.

Another benefit for the user is that the iterative process is unlimited number of iterations. The User can keep doing iterations for as long as he pleases, to further improve his song.

Another benefit for the user is that he influences the interactive process. The user decides on the score for the songs, wherein the system chooses input song for next iteration based on that score.

Another benefit for the user is that it increases the user's engagement with music. By interacting with the system, the users creates and/or listens to music. This can contribute to the well-being of the user as detailed elsewhere in the present disclosure.

Benefits

Same benefits of creating a new song, shown in part 4, also apply to this part.

Iterative creation of songs has the following additional benefits, among others:
Iteratively improve songs quality, using a subjective measurement by the user.
Increase songs diversification by generating a plurality of new songs, in one or more iterations.
Provide a new musical experience for music listeners, that increase of user engagement with music.
Provide a new musical experience for users that create new songs.
Music creators can improve their skills, gain insights, and get feedback for the songs created.
To affect emotions, improve moods and regulate moods. Listening to music can cause the brain to release dopamine which makes for a happier feeling and Reduces symptoms of depression.
To improve cognitive performance such as ability to study, creativity, memory and attention span.
To assist in making physical exercises, such as running or working out in a gym.
To help in managing pain. Research showed that listening to music makes patients less needy of pain medications.
To increase productivity and performance and reduce errors at work.
To Improve motivation.
To reduce stress.
To do meditation.
To help people sleep better.

Novel Approach to Create New Songs

Novelty in the iterative song creation method includes, among others:

a. It uses an iterative process of song creation.

b. It creates new different songs, in every iteration.

c. It uses highest score song of previous iteration as base for the next iteration.

d. It uses analyze, align and transform input song novel method (Method 7A0)

e. It uses create new song novel method (Method 800).

f. It uses user's subjective score feedback in the optimization.

g. It can optionally use global best song.

h. It can optionally use score pass threshold.

i. It uses session states table, with command sequence for each session state.

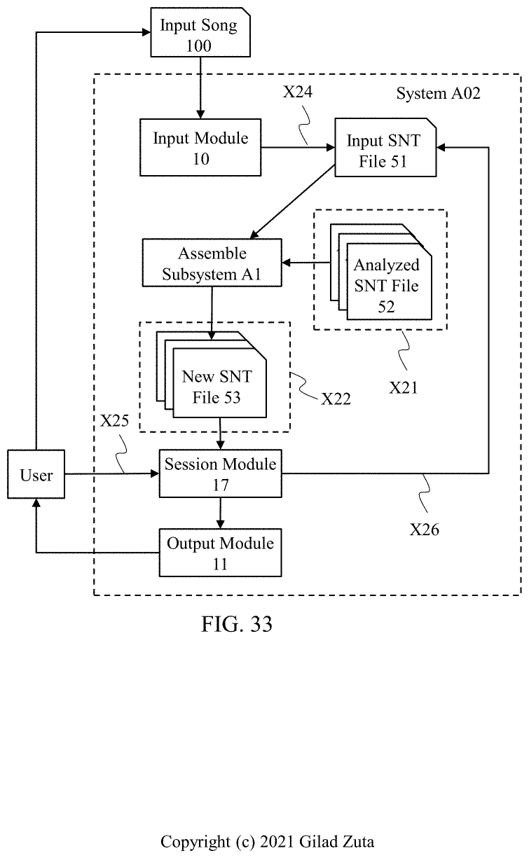

FIG. 33 shows iterative song creation system overview (System A02).

Comparing to System A01 (FIG. 27), new block and operations in this system are: Session

Module (17), getting user feedback (X25) and setting next iteration input song (X26).

The system contains a set of analyzed songs (X21), each analyzed song may be in the format of an Analyzed SNT file (52).

New songs (X22) are created by Assemble Subsystem A1. Each new song is a new SNT file (53). The new songs (X22) have the same melody, and typically the same chords and scales as the input SNT file (51), but they have new tracks and notes.

The system performs an iterative song creation process. Let us assume the system is configured to perform k iterations. A typical method of operation of the system is as follows:

In a first iteration:
Input Module 10 converts Input Song (100) into Input SNT File (51).
Assemble Subsystem A1 uses Input SNT File (51) and analyzed songs (X21) to create new songs (X22).
Output Module 11 conveys the new songs (X22) to the user.
Session Module 17 gets score feedback for the new songs (X22) songs from the user (X25).

Score feedback is a value that represents a user's satisfaction with each of the new songs (X22).
Session Module 17 sets the highest scored song as input for next iteration by overriding Input SNT File 51 (X26).

Every next iteration (up to iteration k):
Assemble Subsystem A1 uses Input SNT File (51) and analyzed songs (X21) to create new songs (X22).
Output Module 11 conveys the new songs (X22) songs to the user.
Session Module 17 gets score feedback for the new songs (X22) songs from the user (X25).
Session Module 17 sets highest scored song as input for next iteration by overriding Input SNT File 51 (X26).

Method for Generating a Plurality of New Musical Compositions

A method for generating a plurality of new musical compositions and selecting a preferred composition therefrom, comprises:
a. getting an input musical composition with its chords and scales;
b. generating a plurality of new musical compositions, derived from the input musical composition, in a digital format;
c. outputting each of the new musical compositions to a user;
d. for each of the new musical compositions, getting from the user a number indicative of the user's satisfaction with that new musical composition, wherein in case no indicative number is received, using a predefined default value;
e. determine whether to continue iterations, according to the input from the user and/or system settings;
f. if chosen to continue iterations, then:
   1) selecting the new musical composition with the highest indicative number to become the input musical composition for the next iteration;
   2) goto step (a).

**End of method**

Comments Re the Above Method

1. A plurality of new musical compositions may be generated by:
a. getting an input musical composition with its chords and scales;
b. getting a group of one or more existing musical compositions,
c. getting a first number K indicative of the number of new musical compositions to create;
d. generating K new musical compositions in digital format, wherein each new musical composition is generated by:
   1) selecting one or more musical sections from the existing musical compositions, and setting chords and scales for the new musical composition, wherein the selected musical sections and/or chords and scales settings differ from those in the new musical compositions already generated; and wherein a selected musical section includes one or more notes and/or control events;
   2) computing properties of notes in the selected musical sections according to the chords and scales of the selected musical compositions;
   3) transforming the selected musical sections using the values and notes properties of the selected musical sections according to the chords and scales of the new musical composition;
   4) generating the new musical composition, wherein the new musical composition comprises the input musical composition and the transformed musical sections.

2. A plurality of new musical compositions may be generated by using the same chords and scales for all the new musical compositions.

3. The method may further include getting a second number indicating a desired number of iterations, and wherein determining whether to continue iterations is done by comparing the number of iterations made to the second number.

Method 250: Iteratively Generating a Plurality of New Musical Compositions and Selecting a Preferred Musical Composition Therefrom

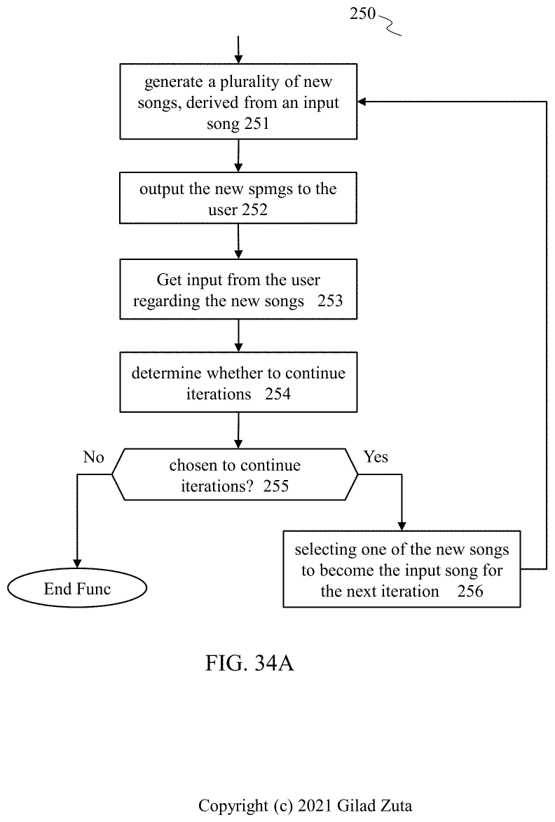

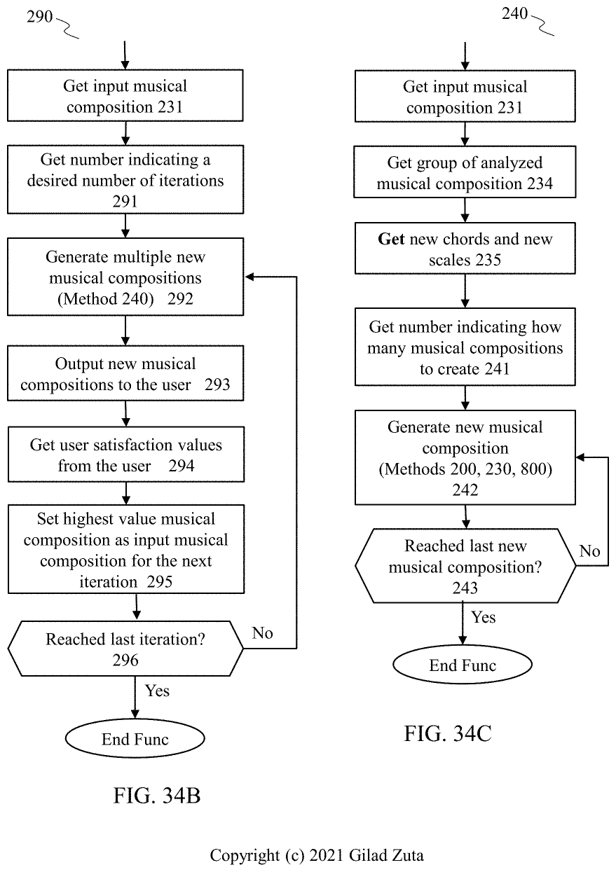

FIG. 34A is a flow chart of a method for iteratively generating a plurality of new musical compositions and selecting a preferred musical composition method.

In block 251, generate a plurality of new songs, derived from an input musical composition, in a digital format; This for example can be done by running Method. 240. Number of songs to be generated can be constant or vary in each iteration, it can be configured to the system or decided by the user.

In block 252, output the new songs to the user. The new musical compositions that were generated in block 251, can be conveyed to the user in various ways, such as playing to the speakers 112, downloaded as a MIDI file 111, sent to a DAW software 104, sent to a digital instrument 102, shown on a display 113 and so on, as shown in FIG. 3.

In block 253, getting an input from the user regarding the new songs. One option is to let the user rank the new songs, for example by giving them numbers, indicative of the user's subjective satisfaction for the new songs. Another option is to let the user choose the new song he liked best.

In block 254, determine whether to continue iterations, according to the input from the user and/or system settings. One option is to configure to the system the number of iterations to be done, for example doing 5 iterations. Another option is to let the user decide whether he would like to continue. Another option is to let the user decide whether he would like to continue, up to a maximal number of iterations configured in the system.

In block 255, check if chosen to continue iterations. The decision whether to continue the iteration is done in block 254. If chosen to continue iteration, goto block 256, otherwise function finishes.

In block 256, select one of the new songs to become the input song for the next iteration, according to the input from the user and/or system settings.

If in block 253 user set a user's subjective satisfaction number for the new song, then the new song with the highest number is selected as the input song for next iteration.

If in block 253, user chooses the new song then the chosen song is selected as the input song for next iteration.

**End of Method**

Method 290: Iteratively Creating New Musical Composition

FIG. 34B is a flow chart of a method for iteratively creating new musical composition using the input musical composition.

Blocks 231 is the same as detailed in Method 230, shown in FIG. 28A.

In block 291, get number indicating a desired number of iterations. This number represents the number of iterations that comprises the songs creation session. The number of iterations can be configured to the system or be chosen by the user.

In block 292, generate multiple new musical compositions, as detailed in Method 240, in FIG. 34C.

In block 293, output the new musical compositions to the user. The new musical compositions that were generated in block 242, can be conveyed to the user in various ways, such as playing to the speakers 112, downloaded as a MIDI file 111, sent to a DAW software 104, sent to a digital instrument 102, shown on a display 113 and so on, as shown in FIG. 3.

In block 294, get user satisfaction values (“User-Scores”) from the user for each created song. After the user reviews the created songs, get User-Score for each created song. User-Score is a subjective score feedback from the user, it is an indication of the user's satisfaction with a particular created song.

In block 295, set highest value musical composition (“Highest-Scored-Song”) as input musical composition for the next iteration.

Highest-Scored-Song is the new created song that has the highest User-Score of all new songs created in the iteration. Highest-Scored-Song is the song that received the highest user's satisfaction value in block 244, at the current iteration, is set as the input for the next iteration.

In another embodiment, Highest-Scored-Song is the song that received the highest user's satisfaction value in all previous iteration is set as the input for the next iteration.

In another embodiment, multiple songs can be set as the input for the next iteration, each will be set as input for generating new multiple songs.

In another embodiment, the user can choose which song will be set as the input for the next iteration.

In block 296, check if reached last iteration. If true then method ends, otherwise goto block 242.

**End of Method**

In another embodiment, user can choose to move to a previous iteration. This sets the input musical composition to the input musical composition used in that previous iteration, and sets the new songs that were created in that previous iteration. From this point, user can choose to create new songs from the input musical composition of that iteration. Another option for the user is to choose to review the songs that were created in that iteration, and choosing one of them for next iteration.

Method 240: Create Multiple New Musical Compositions

FIG. 34C is a flow chart of a method for creating multiple new musical compositions using the input musical composition.

Blocks 231, 234 and 235 are the same as detailed in Method 230, shown in FIG. 28A.

In block 241, get number indicating how many musical compositions to create.

In block 242, generate new musical composition, as detailed in Method 200, or Method 230, or Method 800.

In one embodiment, store history of the selected musical sections and/or chords and scales and uses it when generating the new musical composition, such that the new musical composition differ from the new musical compositions already generated.

In block 243, check if reached last new musical composition. If true then method ends, otherwise goto block 242.

**End of Method**

Session-States and Command-Sequence

In each iteration, the system is found in a state (“Session-State”). Session-State is a number that represents the state of the system when performing an iteration. Each Session-State is connected to a Command-Sequence to be performed in that iteration through a table (“Session-States Table”).

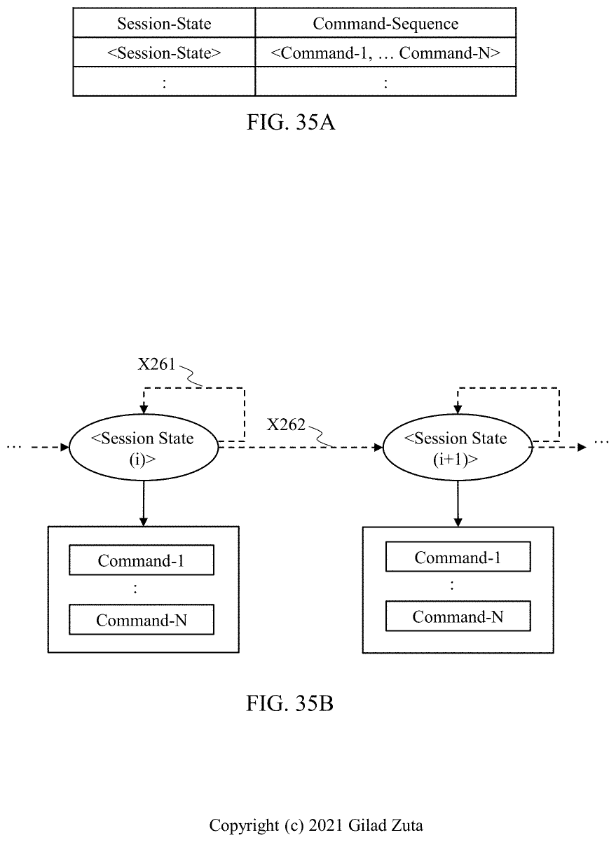

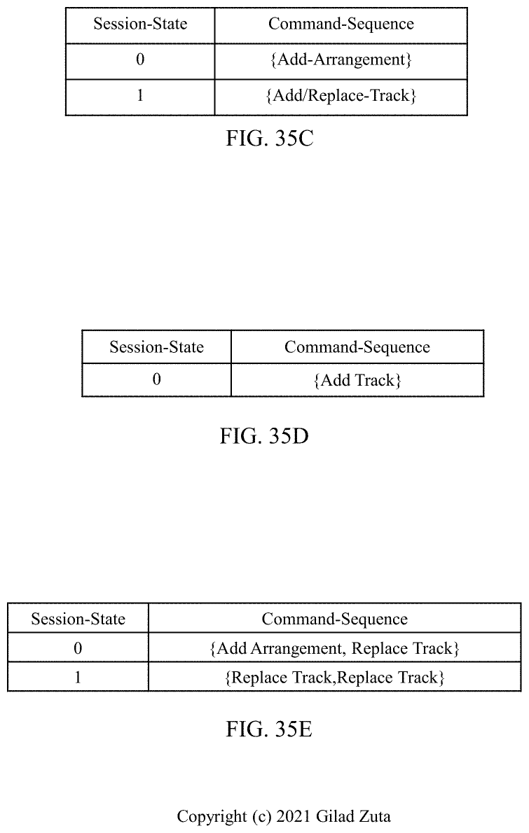

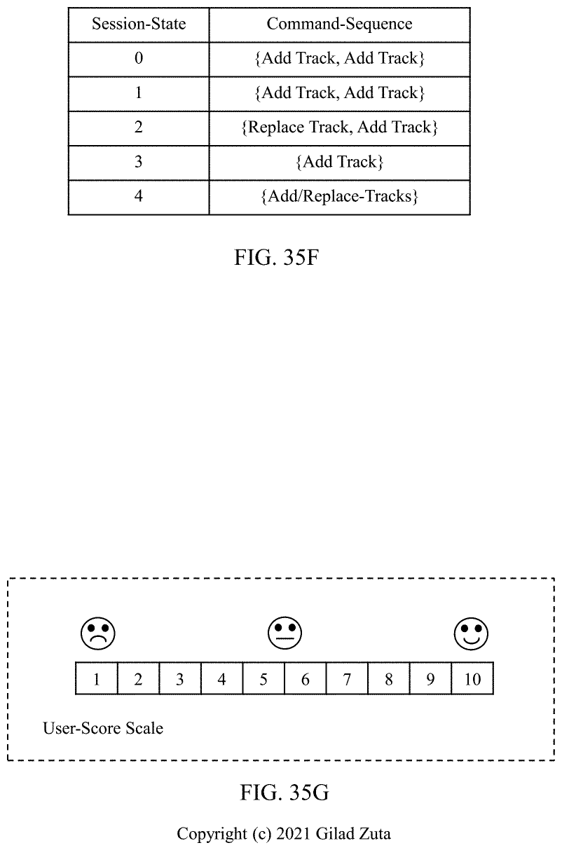

Session-State Table is a table that describes the possible Session-States and their Command-Sequences, it is described in FIG. 35A.

When iteration ends, the system can move to the next Session-State, or stay in the same Session-State. In each iteration, commands are being performed according to the Command-Sequence of the Session-State.

As mentioned in Method 810, there are four commands, disclosed in this document, typically used for creating new songs: Add-Track, Replace-Track Add-Arrangement and Add/Replace-Track.

Command-Sequence contains a sequence of any of the four commands.

The number of Session-States can differ from the number of iterations.

System can be customized to any number of Session-States. After reaching last Session-State, the next Session-State remains the last Session-State until the number of iterations is reached.

In another embodiment, after reaching last Session-State, the next Session-State moves to a previous Session-State, that is configured in the system or chosen by the user.

FIG. 35A shows a Session-States Table.

Each entry in the table describes possible session state and their Command-Sequence.
Session-State—is a number that represents the state of the iterative song creation session.
Command-Sequence—is a list of commands that are applied on the input song to create new songs.

In another embodiment, Session-States also include number of new songs to create in that iteration.

In another embodiment, Session-States also include user satisfaction threshold for that iteration. The threshold determines the threshold that highest user satisfaction number new song must pass to move to the next Session-State in the next iteration. If not passing the threshold, the system remains in the same Session-State in the next iteration.

FIG. 35B visualizes Session-States transitions and commands.

In one embodiment, Session-State starts at 0.

In another embodiment, Session-State can start at any number.

“Score-Threshold” is a number that determines the threshold that User-Score of the Highest-Scored-Song must be above, to move to the next Session-State in the next iteration. If User-Score of the Highest-Scored-Song is below the threshold, then system remains in the same Session-State in the next iteration.

At each iteration:
Command-Sequence is applied on the input song to create new songs.
Songs are output to the user.
The user reviews the songs and give them a number indicative of his satisfaction from the songs.
If User-Score of Highest-Scored-Song is greater or equal to Score-Threshold then (X262)
   System moves to next Session-State:

Session-State=Session-State+1
Otherwise, Session-State remain unchanged (X261).

FIG. 35C shows an example of a Session-States table.

In the first Session-State, Session-State 0, it applies Add-Arrangement command. If User-Score of the Highest-Scored-Song in the iteration is above Score-Threshold, then system moves to Session-State 1.

In Session-State 1, it applies Add/Replace-Track command. The session remains in this state until all iterations are performed. Add/Replace-Track can be configured, which songs will have Add-Track and which Replace-Track, as described in method 810.

FIG. 35D shows another example of a Session-States table.

It has one Session-State. Every iteration it always applies Add-Track command.

FIG. 35E is an example of a customized Session-States Table.

In Session-State 0, it applies Add-Arrangement command and Replace Track command immediately after

In Session-State 1, it applies Replace Track command twice.

FIG. 35F is another example of a customized Session-States Table.

In Session-State 0, it applies Add-Arrangement command and Replace Track command immediately after. In Session-State 1, it applies Replace Track command twice. Etc.

This example demonstrates the high customization that can be done to the commands being done, when creating songs iteratively.

FIG. 35G is an example of a User-Score Scale,

To review songs, the user is presented with a User-Score Scale, that contains the possible User-Score values for a song.

Typically, the User-Score scale has several possible grades, with positive score on one side and negative score on the other side.

This figure shows an example of a User-Score scale, with values ranging from 1 to 10 numbered. 5 and 6 represents a natural user's satisfaction value, 1 is the most negative user's satisfaction value, 10 is the most positive user's satisfaction value. The more positive the User-Score value is, the more the user liked, or is satisfied with the new song.

User-Score scale may also be comprised from descriptive value, where each string value represents a number.

It is optional for the user not to give a User-Score, then a natural User-Score is selected by default.

Method 820: Iterative Song Creation Session

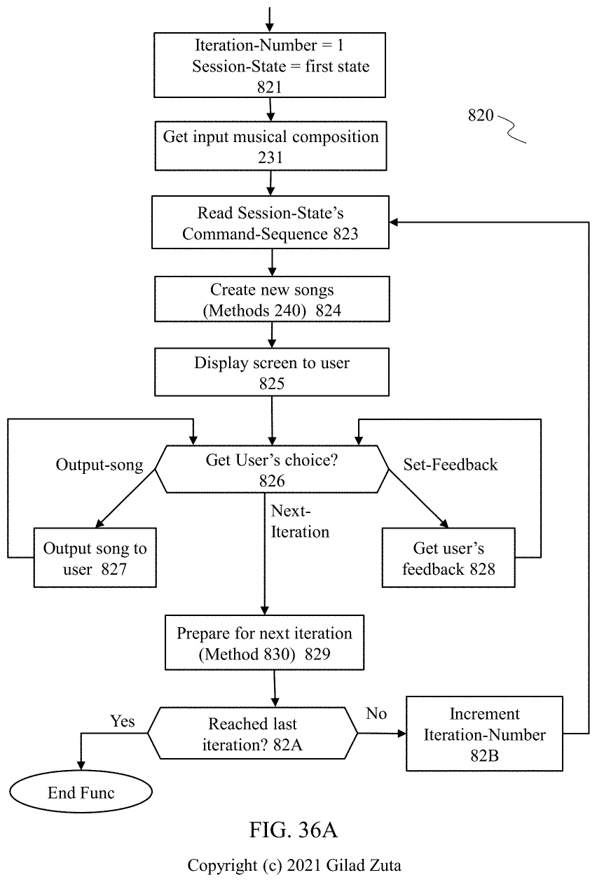

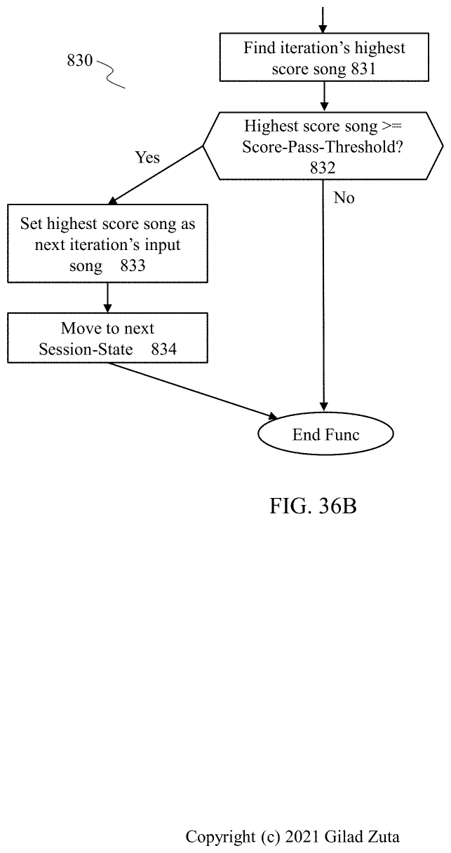

FIG. 36A is a flow chart of method for iterative song creation.

The method gets as input: The number of iterations to perform. Number of songs to create in each iteration.

This embodiment creates new songs using Method 240, and then interact with the user by displaying a screen, getting user's choices, or requests, and acting by them. Possible user's choices include:
“Output-Song”—request to output a specific new song to the user, such as playing it to speakers.
“Set-Feedback”—request to provide User-Score feedback for a specific new song.
“Next-Iteration”—request to move to next iteration.

Block 231 is the same as in method 230.

In block 821, initialize session's variables: Set Iteration-Number variable to 1. Iteration-Number is a variable that represents the session number. Set Session-State variable to first state in Session-States table, which is the first entry in the table.

In block 822, convert MIDI to SNT (Method 700). Input Module 10 converts Input Song 100 into Input SNT File 51, as shown in System A02 (FIG. 33).

In block 823, read Session-State's Command-Sequence.

This is done by reading the entry of Session-States Table at Session-State variable's value location.

In block 824, create new songs (Method 240). Set input song and Command-Sequence (of block 823) as inputs to the method.

In one embodiment, new song filenames include a number that represents their index and the input song they were based on, such as:

New song number=input song number*10+index in current iteration

Where input song number is set to 0 at start.

For example, assuming 3 songs are generated each iteration. In first iteration 1, new song names is: New_Song_1, New_Song_2, New_Song_3. Assuming New_song_1 gets the highest score, in second iteration new song names is: New_Song_11, New_Song_12, New_Song_13. Assuming New_song_13 gets the highest score, in second iteration new song names is: New_Song_131, New_Song_132, New_Song_133. And so on.

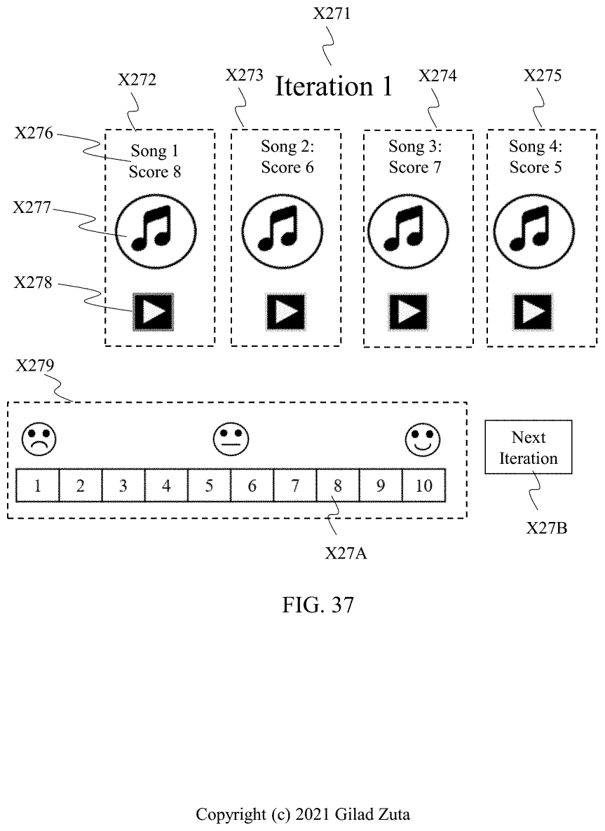

In block 825, display screen to user. A screen is shown to the user. Typically, the screen shows iteration number, icons of the songs being created with their filenames, buttons to enable the user to play them to the speaker or download them, buttons to enable the user to select a song, a score scale allowing the user to give score points for each song, and a button to move to next iteration etc. An example screen is shown in FIG. 37.

In block 826, get user's choice. Songs were created in block 824. Now Session Module 17 interacts with the user. It receives choices from the user to allow the user to review the songs and give score points for them. If the user chooses Output-Song goto block 827. If the user chooses Set-Feedback goto block 828. If the user chooses Next-Iteration goto block 829.

In one embodiment, Next-Iteration choice is enabled only after user gave score points for all the new songs. An example of getting these choices from user interface screen is shown in FIG. 37.

In another embodiment, Next-Iteration choice is also possible. Songs that were not given score points by the user get a default natural score. For example, on Score Scale shown in FIG. 35G, default nature score can be ‘5’.

In block 827, output song to user. A selected song is output to the user. Output Module 11 reads New SNT File 53, and can convey it to the user in various ways, such as playing to the speakers, displaying on the screen, convert it to MIDI, MP3 or WAV files, allow users to download the song as a file or in notes notation, send it to DAW, etc.

In block 828, get user's feedback. Get User-Score, user's subjective score points, for a song. This occurs after the user reviewed the new song. The score should be a number, that can represent positive, natural, or negative review, as shown in FIG. 35G.

In block 829, prepare for next iteration, as detailed in Method 830, described in FIG. 36B.

In block 82A, check if reached last iteration. Number of iterations in the session is input to the method, check if Iteration-Number value reached that number. If true then method ends, otherwise goto block 82B.

In block 82B, increment value of Iteration-Number by 1.

**End of Method**

Method 830: Prepare for Next Iteration

FIG. 36B is a flow chart of a method for preparing for next iteration.

Score-Threshold is a configured number. It is optional, it can be disabled by setting the threshold to 0. New songs that do not pass this threshold are not considered candidates as input song for next iteration. If all new songs get user score that is below the threshold, then none of them is considered candidate as input song for next iteration.

If not found Highest-Scored-Song with User-Score above Score-Threshold, then next iteration input song remains unchanged.

In block 831, find iteration's highest score song, Highest-Scored-Song. Finding the new song that has the highest User-Score from all the new songs created in the current iteration. If there is more than on song with the same maximal score song, then one option is to choose randomly between them, another option is to notify the user and let the user choose.

One option is to find Highest-Scored-Song anew every iteration. Choosing the highest score song from the new songs created in this iteration,

Another option is to use global Highest-Scored-Song. Keep Highest-Scored-Songs of all iterations until now. Checking if the scores of the new songs in the current iteration are higher than the global Highest-Scored-Song.

In block 832, check if Highest-Scored-Song equals or larger than configured Score-Threshold. If yes goto block 833. Otherwise function finishes, and input song for next iteration remains unchanged.

In block 833, set highest score song as next iteration's input song.

In block 834, move to next Session-State. This is done by increasing Session-State by 1,

**End of Method**

FIG. 37 shows an example of user interface screen.

This screen is shown to the user in block 825 as part of method 820.

Screen has a label with iteration number (X271). In this example 4 songs are created in the iteration. Each song is displayed in a region on the screen (X272-X275). Each song has a label (X276), icon (X277) and play button (X278). Song's label (X276) contains the song name and its User-Score, after being set by the user. Song's icon (X277) selects the song as current song. Song's play button (X278) plays the song to the speakers.

The User can review the songs by playing them using their play buttons.

User gives feedback using User-Score scale (X279). User-Score scale contains negative User-Scores 1-4, natural User-Scores 5-6, positive User-Scores 7-10. Each User-Score value has a button (X27A). After user reviews a song, he gives it a User-Score value by pressing the button of that User-Score value (X27A).

When user finish giving User-Score values to all the songs, he can move to next iteration by pressing ‘Next Iteration’ button (X27B).

In one embodiment, the button can be hidden until all new songs have been given User-Scores.

In another embodiment the button is always visible, user can skip giving User-Scores to songs and move to next iteration. Songs that are not given User-Scoresby the user gets a default User-Score, which is typically natural, such as 5 in this example of User-Score scale.

Recalling block 826 of method 820, user's choices are:
Output-Song—is done by pressing song's play button (X278).
Next-Iteration—is done by pressing ‘Next Iteration’ button (X27B).
Set-Feedback—is done by selecting a song using on of its icons (X276-X278) and pressing a User-Score value button (X27A).

In other screens more songs can be displayed, there can be option to manually to add/remove tracks, option to download songs, show information about the song, show bar and timepoint of song that is being played etc.

### Example

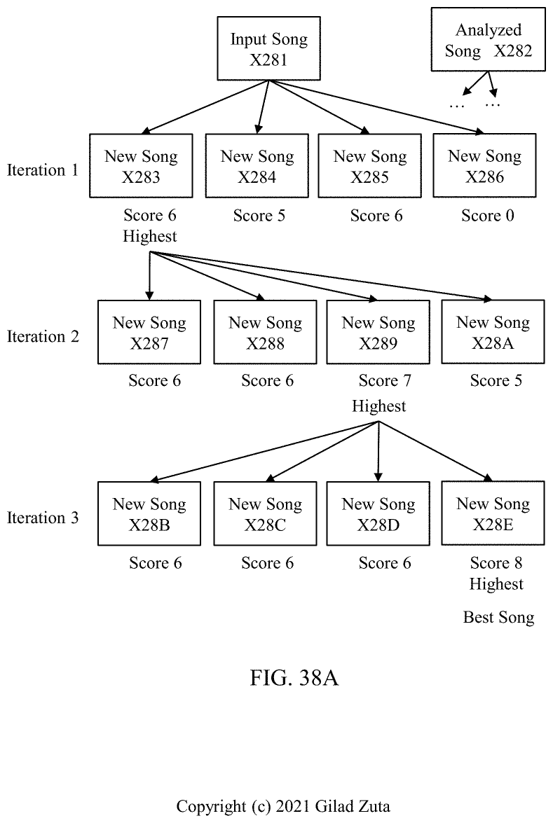

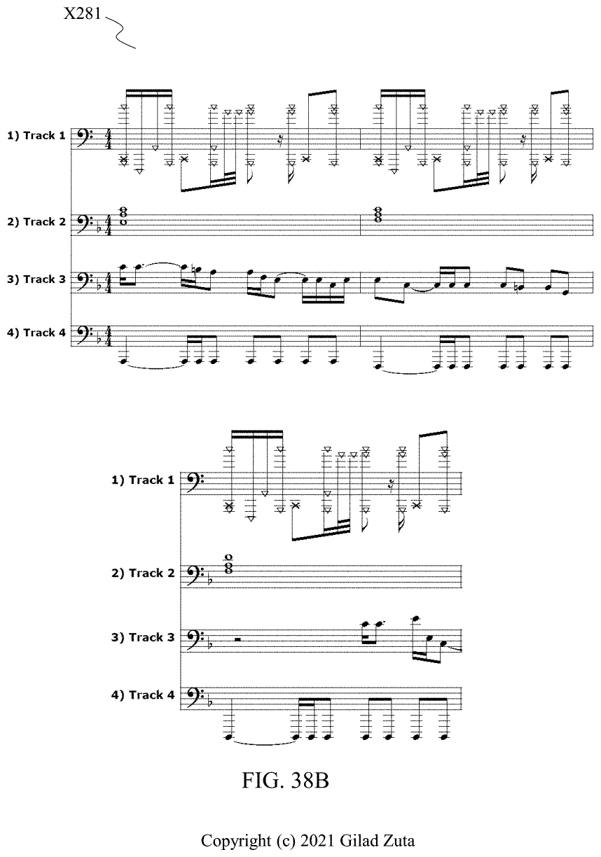

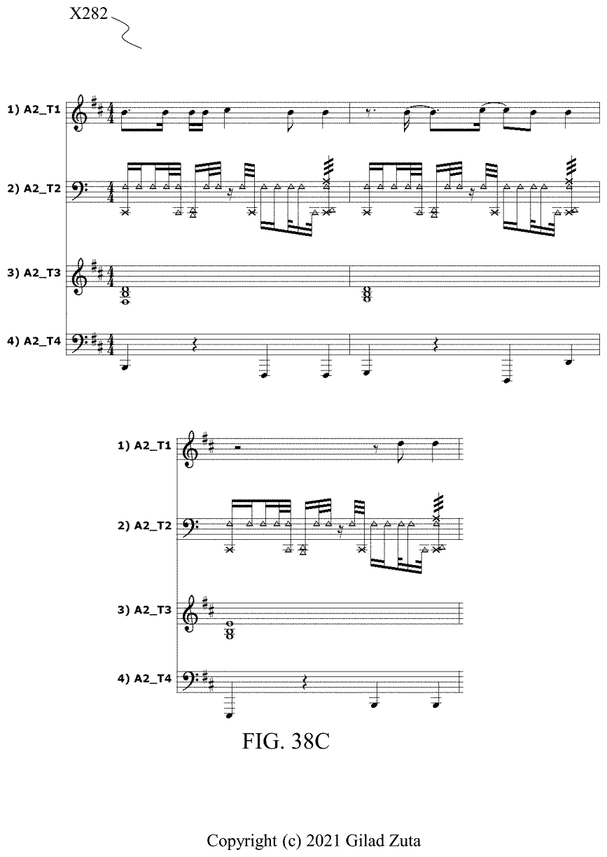

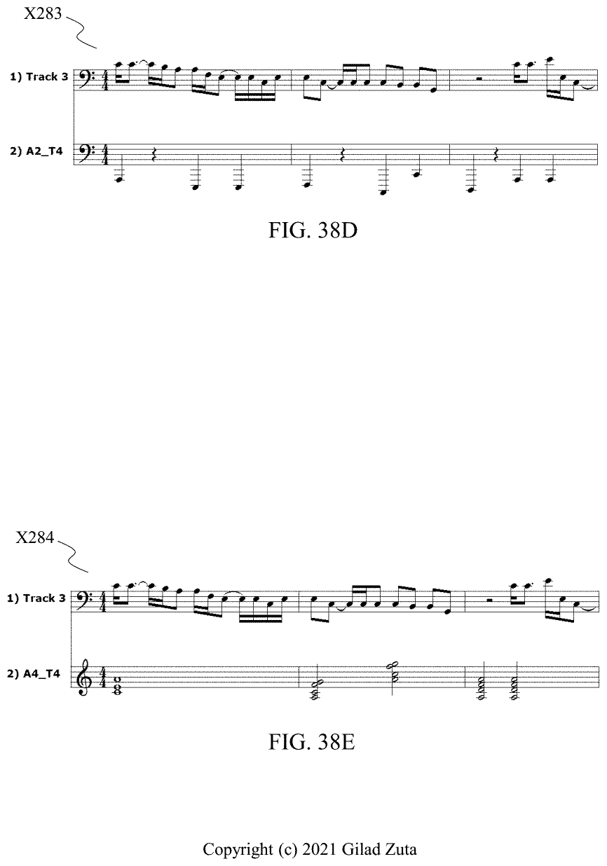

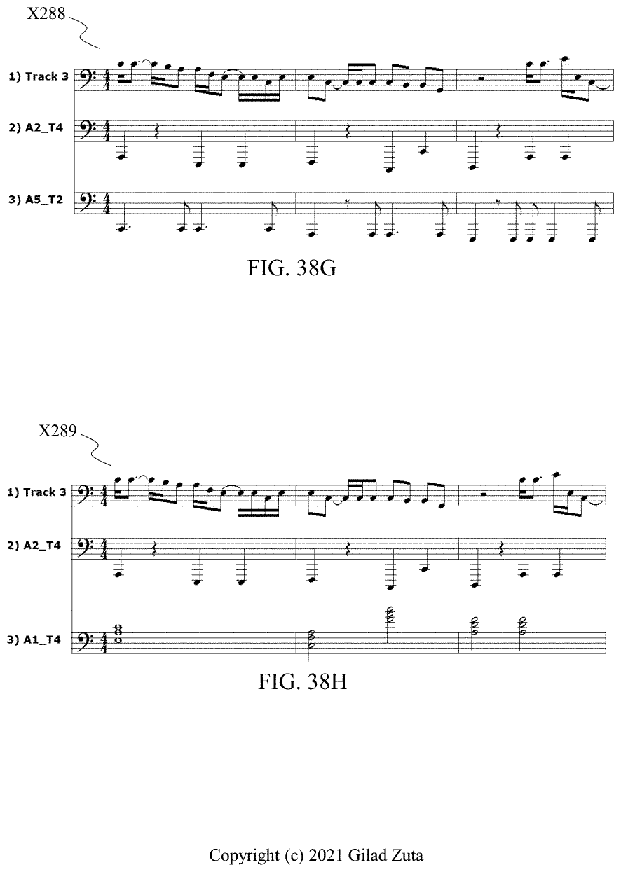

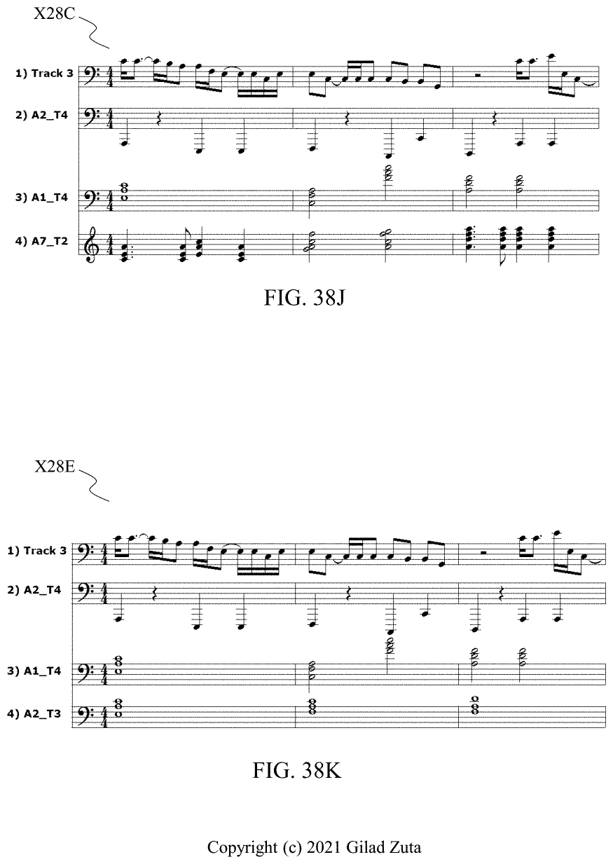

FIGS. 38A-38K show an example of iterative song creation session.

In this example, the configuration is:
Score-Threshold is configured to 6.
Number of iterations is 3.
Number of songs to create at each iteration is 4.
Session-States Table contains one state with Add-Track command, as shown in FIG. 35D.

FIG. 38A shows a high-level overview of the iterative song creation session example.

Analyzed songs, songs in X21 (FIG. 33) are being used for creating the new songs. One of the analyzed songs, an analyzed song named “A2” (X282) is shown in this figure.

In iteration 1, user's input song (X281) is given as the base for creating 4 new songs, new song X 283, X284, X285 and X286, using Method 240. User reviews the songs, and gives them User-Scores: 6 for new song X283, 5 for new song X284, 6 for new song X285 and 0 for new song 6. The highest User-Score in iteration 1 is 6, there are two new songs with this User Score, new song X283 and new song X285, they are the Highest-Scored-Songs of iteration 1. Their User-Score is 6, which is above or equal to Score-Threshold, therefore they can replace current input song as the base for the next iteration. New song X283 is selected as the base for next iteration because it is the first with the highest User-Score. Other options are to choose randomly between them or let the user choose which song he prefers to be the base for next iteration.

In iteration 2, new songs X287 to X28A are created. User reviews them and give User-Scores: 6, 6, 7, 5. New song X289 is the Highest-Scored-Song that becomes the base for next iteration.

In iteration 3, new songs X28B to X28E are created. User reviews them and give User-Scores: 6, 6, 6, 8. Song 134 is the Highest-Scored-Song, that becomes the best song of the session. Example of the new songs, in notes notations, of this session are shown in FIGS. 47B to 47J.

FIG. 38B shows notes notation of the input song (X281). For simplicity, it has 4 tracks and 3 bars. Track 3 is the melody track. Track 1 is a drums track.

FIG. 38C shows an example of the notes of the analyzed song (X282). This analyzed song is one of the analyzed songs in X21 (FIG. 33) that are being used for creating the new songs in each iteration, that are part of X22 (FIG. 33). Analyzed song X282 has 4 tracks. Track 1 (“A2_T1”) is its melody track, track 2 (“A2_T2”) is a drums track.

FIG. 38D shows new song X283 created at Iteration 1. New song X283 contains 2 tracks: “Track 3” and “A2_T4”. “Track 3” is the melody track of the input song (X281) (shown in FIG. 38B). “A2_T4” is a new track, taken from analyzed song (282), that was transformed and added to this new song X283.

FIG. 38E shows new song X284 created at Iteration 1. New song X284 contains 2 tracks: “Track 3” and “A4_T4”. “Track 3” is the melody track of the input song (X281) (shown in FIG. 38B). “A4_T4” is a new track, taken from an analyzed song in X21 (FIG. 33), that was transformed and added to this new song 284.

FIG. 38G shows new new song X288 created at Iteration 2. New song X288 contains 3 tracks: “Track 3”, “A2_T4” and “A5_T2”. “Track 3” and “A2_T4” are taken from new song X283 (shown in FIG. 38D), that is the basis for iteration 2. “A5_T2” is a new track, taken from an analyzed song in X21 (FIG. 33), that was transformed and added to this new song.

FIG. 38H shows new song X289 created at Iteration 2. new song X289 contains 3 tracks: “Track 3”, “A2_T4” and “A1_T4”. “Track 3” and “A2_T4” are taken from new song X283 (shown in FIG. 38D), that is the basis for iteration 2. “A1_T4” is a new track transformed and taken from an analyzed song in X21 (FIG. 33), that was transformed and added to this new song.

FIG. 38J shows new new song X28C created at Iteration 3. New song 28C contains 4 tracks: “Track 3”, “A2_T4” “A1_T4” and “A7_T2”. “Track 3”, “A2_T4” and “A1_T4” are taken from new song 289 (shown in FIG. 38H), that is the basis for iteration 3. “A7_T2” is a new track transformed and added from an analyzed song in X21 (FIG. 33).

FIG. 38K shows new Song 134 created at Iteration 3. Song 134 contains 4 tracks: “Track 3”, “A2_T4” “A1_T4” and “A2_T3”. “Track 3”, “A2_T4” and “A1_T4” are taken from new song X289 (shown in FIG. 38H), that is the basis for iteration 3. “A2_T3” is a new track transformed and added from analyzed song (X282), of X21 (FIG. 33).

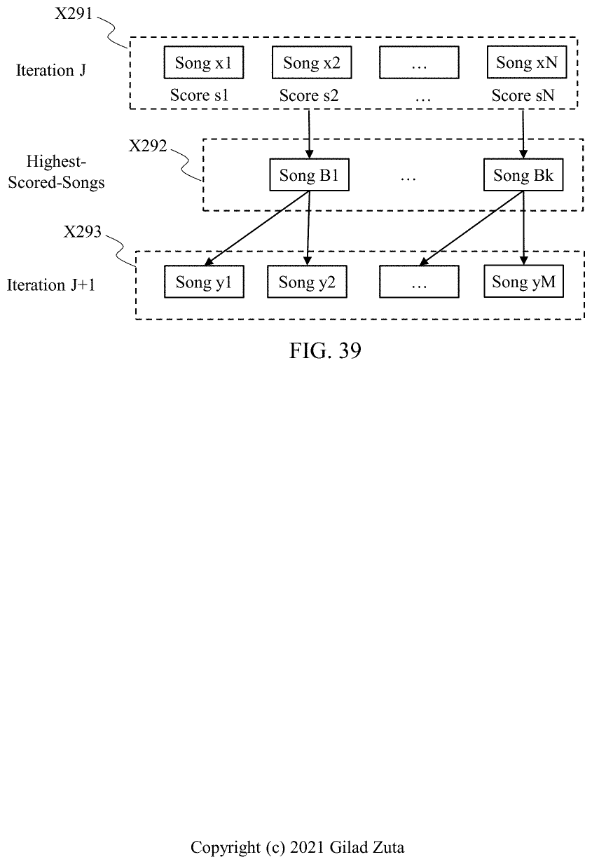

FIG. 39 shows another embodiment using multiple input songs.

In this embodiment, there are multiple input songs (X292) that act as the base for new songs in next iteration (X293).

N songs created at an iteration J (X291). Highest-Scored-Song contains the K Highest-Scored-Songs (X292), each song becomes the input for multiple new songs in iteration J+1 (293).

One embodiment for X292 is to use a constant number of Highest-Scored-Songs in X292 as input for next iteration.

Another embodiment is to use multiple input songs only when there are few songs that have the same highest score.

Another embodiment is to split the new songs into subgroups, each subgroup always has an input song as the base.

Therefore, the present invention relates to a method for automatically analyzing, composing and generating of new musical songs.

A new song is created by implementing a method that utilizes Input Module, Analysis Engine and Assemble Engine. The Input Module gets musical song data from the user. The musical song is typically in the format of MIDI input data, comprising of musical instruments notes and control effects. Analysis Engine analyzes notes from a set of other songs, giving properties for each note. The Assemble Engine gets input song from the user, analyzed notes from the Analysis Engine, as well as requirements for the new song such as new chords and scales. Assemble Engine then creates a new song by making a new type of transform to the analyzed notes according to the desired chords and scales.

The analysis, as well as the transform, are based on a new metric that the inventor call “Note-Chord Distance”. The analysis, transform and metric introduce a new approach on how to view notes in a musical piece.

Another key part of this invention is the iterative song creation method. The iterative song creation method iteratively improves the output songs by interacting with the user. This is done by creating a plurality of new songs, which are modified versions of the user's song, conveying the new songs for the user using the Output module, getting subjective user's satisfaction values for the new songs using the Session module and setting the new song with the highest user's satisfaction value as the input for next iteration.

It will be recognized that the foregoing is but one example of a method and system within the scope and spirit of the present invention and that various modifications will occur to those skilled in the art upon reading the disclosure set forth hereinbefore.

The various embodiments presented in this disclosure may be combined and modified, without departing from the scope and spirit of the present invention.

1. A method for generating a new musical composition in a digital format, using a group of one or more existing musical compositions, comprising:
a. getting an input musical composition with its chords and scales;
b. setting chords and scales for the new musical composition;
c. selecting one or more musical sections from the existing musical compositions;
d. if the selected musical sections do not include note properties, then computing properties for all notes in the selected musical sections, according to the chords and scales of the selected musical compositions;
f. transforming the selected musical sections using the values and notes properties of the notes in the selected musical sections, according to the chords and scales of the new musical composition;
g. generating the new musical composition, wherein the new musical composition comprises the input musical composition and the transformed musical sections.

2. The method of claim 1, wherein transforming the selected musical sections further includes aligning a number of bars and time signatures of each selected musical section to be equal to the number of bars and time signatures of the input musical composition.

3. The method of claim 1, wherein generating the new musical composition further includes removing one or more notes or tracks from the input musical composition.

4. The method of claim 1, wherein setting chords and scales for the new musical composition comprise using chords and scales of the input musical composition which are modified using selected musical compositions from the group.

5. The method of claim 1, further including getting a list of commands, and wherein generating the new musical composition is done by performing the list of commands.

6. The method of claim 1, wherein the input musical composition and/or the new musical composition are MIDI files.

7. The method of claim 1, wherein selecting musical sections comprises selecting tracks from the input musical composition.

8. The method of claim 1, wherein transforming the selected musical sections comprises, for each input note:
a. getting the input note and its note properties;
b. getting a new chord and a new scale for the input note;
c. generating a list of notes candidates;
d. computing distances between the input note and every note in the list, using input note's value, input note's note properties, candidate note's value and candidate note's note properties;
e. finding the candidate that has the minimal distance;
f. setting a new note value using a note value of the candidate with the minimal distance.

9. The method of claim 1, wherein the note properties include one or more of the following:
a. one or more note-chord distances, comprising a distance to the root note of the chord and optionally distances to the other notes of the chord;
b. note type, wherein the note type can be either shared with other notes or unique for the note, wherein the shared note type can be either harmonic, scale or non-scale, and wherein the unique note type can be either harmonic-0, harmonic-1, harmonic-2 or scale-0, scale-1, scale-2, scale-3, scale-4, scale-5, scale-6, scale-7, scale-8 or scale-9.

10. A method for analyzing one or more notes in a musical composition, comprising for each note:
a. getting a note's value, chord and scale; and
b. computing note properties using the note's value, chord and scale;
wherein the note properties include one or more of the following:
1) one or more note-chord distances, comprising a distance to the root note of the chord and, optionally, distances to the other notes of the chord;
2) note type, wherein the note type can be either shared with other notes or unique for the note, wherein the shared note type can be either harmonic, scale or non-scale, and wherein the unique note type can be either harmonic-0, harmonic-1, harmonic-2 or scale-0, scale-1, scale-2, scale-3, scale-4, scale-5, scale-6, scale-7, scale-8 or scale-9.

11. A method for transforming one or more input notes of a musical composition into one or more new notes, comprising for each input note:
a. getting the input note and its note properties;
b. getting a new chord and a new scale for the input note;
c. generating a list of notes candidates;
d. computing distances between the input note and every note in the list, using input note's value, input note's note properties, candidate note's value and candidate note's note properties;
e. finding the candidate that has the minimal distance;
f. setting a new note value using a note value of the candidate with the minimal distance.

12. The method of claim 11, wherein generating a list of notes candidates comprises selecting all notes whose values are within a range defined between the value of the input note minus a first offset, and the value of the input note plus a second offset.

13. The method of claim 11, wherein generating a list of notes candidates comprises selecting all possible notes.

14. The method of claim 11, wherein the note properties include one or more of the following:
1) one or more note-chord distances, comprising a distance to the root note of the chord and optionally distances to the other notes of the chord;
2) note type, wherein the note type can be either shared with other notes or unique for the note, wherein the shared note type can be either harmonic, scale or non-scale, and wherein the unique note type can be either harmonic-0, harmonic-1, harmonic-2 or scale-0, scale-1, scale-2, scale-3, scale-4, scale-5, scale-6, scale-7, scale-8 or scale-9.

15. The method of claim 11, wherein the getting the input note further includes:
a. if the input note is an ongoing note, then:
1) stopping the ongoing note at the time when the change occurs by changing its length;
2) creating a new note, of a value equal to that of the ongoing note, starting at the time when the change occurs and a length equal that of the ongoing note before change minus the length of time the ongoing note up to the time of occurrence of the new chord and scale;
3) setting the new note as the input note for the transform.

16. The method of claim 11 wherein, for each note, computing properties of the note from the note's value, chord and scale, and wherein the note properties include one or more of the following:
1) one or more note-chord distances, comprising a distance to the root note of the chord and optionally distances to the other notes of the chord;
2) note type, wherein the note type can be either shared with other notes or unique for the note, wherein the shared note type can be either harmonic, scale or non-scale, and wherein the unique note type can be either harmonic-0, harmonic-1, harmonic-2 or scale-0, scale-1, scale-2, scale-3, scale-4, scale-5, scale-6, scale-7, scale-8 or scale-9.

17. The method of claim 11, wherein computing distances comprises, for each candidate note, computing a distance between the input note and the candidate note is performed by computing either one of:
a. a sum of:
1) sum of differences, wherein each difference comprises the absolute value of notes chord distances difference;
2) absolute value of the difference of the notes values;
b. a sum of:
1) square root of sum of differences squared, wherein each difference comprises the notes chord distances difference;
2) absolute value of the difference of the notes values;
c. square root on the sum of:
1) sum of differences squared, wherein each difference comprises the notes chord distances difference;
2) absolute value of the difference of the notes values; or
d. a sum of:
1) sum of differences, wherein each difference comprises a weight multiplied by the absolute value of notes chord distances difference;
2) a weight multiplied by the absolute value of the difference of the notes values.

18. The method of claim 11, wherein computing distances comprises, for each candidate note, computing a distance between the input note and the candidate note is performed by computing either one of:
a. a sum of:
1) sum of differences, wherein each difference comprises the absolute value of notes chord distances difference;
2) scale difference between the notes values, wherein the scale difference is computed by counting scale notes between the notes;
b. a sum of:
1) square root of sum of differences squared, wherein each difference comprises the notes chord distances difference;
2) absolute value of the difference of the notes values;
c. square root on the sum of:
1) sum of differences squared, wherein each difference comprises the notes chord distances difference;
2) scale difference between the notes values, wherein the scale difference is computed by counting scale notes between the notes; or
d. a sum of:
1) sum of differences, wherein each difference comprises a weight multiplied by the absolute value of notes chord distances difference;
2) a weight multiplied by scale difference between the notes values, wherein the scale difference is computed by counting scale notes between the notes.

19. The method of claim 11, wherein only part of the note chord distances are available, and wherein computing distances comprises, for each candidate note, computing a distance between the input note and the candidate note is performed by computing either one of:
a. absolute differences between the available notes chord distances and note values;
b. root on square of the available notes chord distances differences plus absolute note values difference; or
c. weighted sum on absolute the available notes chord distances differences and note values difference.

20. A method for generating a plurality of new musical compositions and selecting a preferred composition therefrom, comprising:
a. getting an input musical composition with its chords and scales;
b. generating a plurality of new musical compositions, derived from the input musical composition, in a digital format;
c. outputting each of the new musical compositions to a user;
d. for each of the new musical compositions, getting from the user a number indicative of the user's satisfaction with that new musical composition, wherein in case no indicative number is received, using a predefined default value;
e. determining whether to continue iterations, according to the input from the user and/or system settings;
f. if chosen to continue iterations, then:
1) selecting the new musical composition with the highest indicative number to become the input musical composition for the next iteration;
2) goto step (a).

21. The method of claim 20 wherein generating a plurality of new musical compositions comprises:
a. getting an input musical composition with its chords and scales;
b. getting a group of one or more existing musical compositions,
c. getting a first number K indicative of the number of new musical compositions to create;
d. generating K new musical compositions in digital format, wherein each new musical composition is generated by:
1) selecting one or more musical sections from the existing musical compositions, and setting chords and scales for the new musical composition, wherein the selected musical sections and/or chords and scales settings differ from those in the new musical compositions already generated; and wherein a selected musical section includes one or more notes and/or control events;
2) computing properties of notes in the selected musical sections according to the chords and scales of the selected musical compositions;
3) transforming the selected musical sections using the values and notes properties of the selected musical sections according to the chords and scales of the new musical composition;
4) generating the new musical composition, wherein the new musical composition comprises the input musical composition and the transformed musical sections.

22. The method of claim 20, wherein generating a plurality of new musical compositions comprises using same chords and scales for all the new musical compositions.

23. The method of claim 20, further including getting a second number indicating a desired number of iterations, and wherein determining whether to continue iterations is done by comparing the number of iterations made to the second number.

24. A method for changing a musical composition to a desired number of bars and time signatures for the bars, comprising:
a. getting an input musical composition, wherein each note includes indications in bar and timepoint, where it starts and ends;
b. getting a desired number of bars and time signatures for the bars;
c. if the desired number of bars is larger than the number of bars in the musical composition, then duplicating bars from the input musical composition, until the numbers are equal.

25. The method of claim 24, further including:
d. if the desired number of bars is smaller than the number of bars in the musical composition, then removing bars until the numbers are equal.

26. The method of claim 24, further including, for each bar:
1) if the desired number of timepoints is smaller than the number of timepoints in the bar, then removing timepoints until the numbers are equal;
2) if the desired number of timepoints is larger than the number of timepoints in the bar, then duplicating timepoints from the bar until the numbers are equal, or extending the length of notes in the original timepoint into the new timepoint.
